(19) United States
(12) Patent Application Publication
(10) Pub. No.: US 2022/0414705 A1
(43) Pub. Date: Dec. 29, 2022

(54) METHOD AND SYSTEM FOR ASSESSING EFFECTIVENESS OF MARKETING CAMPAIGNS USING RFM MATRIX IN REAL-TIME

(71) Applicant: WizRocket Inc., Mountain View, CA (US)

(72) Inventors: Ankush JAIN, Mumbai (IN); Jacob JOSEPH, Mumbai (IN)

(73) Assignee: WizRocket Inc., Mountain View, CA (US)

(21) Appl. No.: 17/304,633

(22) Filed: Jun. 23, 2021

(51) Int. Cl. G06Q 30/02; G06N 20/00

(52) U.S. Cl. CPC G06Q 30/0243; G06Q 30/0277; G06N 20/00

(57) ABSTRACT

The present disclosure provides a computer-implemented method and system for assessing an effectiveness of one or more marketing campaigns using RFM matrix in real-time. The computer-implemented method and system corresponds to a marketing campaign evaluation system. The marketing campaign evaluation system receives a first set of data. The marketing campaign evaluation system fetches a second set of data. The marketing campaign evaluation system obtains a third set of data. The marketing campaign evaluation system analyzes the first set of data, the second set of data and the third set of data. The marketing campaign evaluation system enables segmentation of a plurality of users in one or more segments. The marketing campaign evaluation system initiates the one or more marketing campaigns through a RFM grid. The marketing campaign evaluation system creates a transition representation. The marketing campaign evaluation system evaluates the effectiveness of each of the one or more marketing campaigns.

### TECHNICAL FIELD

The present invention relates to the field of marketing and, in particular, relates to a method and system for assessing effectiveness of marketing campaigns using RFM matrix in real-time.

### INTRODUCTION

Over the past few years, online platforms have become a popular way for individuals and consumers to interact online. The online platforms have been used to provide range of services to the individuals on the Internet. The range of services are such as marketplaces, search engines, social media, consumer business, financial services, industrial products, home services, legal services, creative services, e-learning services, and the like. In addition, the online platforms facilitate interactions between at least two or more distinct individuals (whether firms or consumers) through the range of services via the Internet. We have seen an increasing demand in the usage of the online platforms. The increasing demand of the online platforms leads to a competitive environment within online platform providers. The online platform providers have to make segments for the individuals accessing the online platforms for running marketing campaigns in this competitive environment. The online platform providers are seeking effective ways to run the marketing campaigns. In addition, the online platform providers seek to have a high successful rate of the marketing campaigns for the segments. However, the present systems and methods for the segmentation of the individuals accessing the online platforms is not at granular level. In addition, the present systems and methods do not allow the online platform providers to measure the effectiveness of the marketing campaigns using RFM matrix on granular level. Further, the present systems and methods do not allow the online platform providers to customize the marketing campaigns according to the granularity of the segments of the individuals. Furthermore, the present systems and methods do not allow the online platform providers to analyze the performance of the marketing campaigns for segments in real-time. Moreover, the present systems and methods do not allow the online platform providers to predict the performance of the marketing campaigns.

In light of the above stated discussion, there is a need for a method and system which overcomes the above stated disadvantages.

### SUMMARY

In a first example, a computer-implemented method is provided. The computer-implemented method for assessing an effectiveness of one or more marketing campaigns using RFM matrix in real-time. The computer implemented method corresponds to a marketing campaign evaluation system with a processor. The computer-implemented method includes a first step to receive a first set of data associated with a plurality of users. In addition, the computer-implemented method includes a second step to fetch a second set of data associated with a plurality of past events of the plurality of users on one or more online platforms. Further, the computer-implemented method includes a third step to obtain a third set of data associated with a plurality of live events of the plurality of users on the one or more online platforms through one or more communication devices. Furthermore, the computer-implemented method includes a fourth step to analyze the first set of data, the second set of data, and the third set of data using one or more machine learning algorithms. Moreover, the computer-implemented method includes a fifth step to enable segmentation of the plurality of users in one or more segments based on a customer value using a plurality of RFM filters. Also, the computer-implemented method includes a sixth step to initiate the one or more marketing campaigns through a RFM grid for each of the one or more segments to achieve one or more segment goals. Also, the computer-implemented method includes a seventh step to create a transition representation for each of the one or more segments through the one or more marketing campaigns based on a Recency-Frequency-Monetary value matrix model. Also, the computer-implemented method includes an eighth step to evaluate the effectiveness of each of the one or more marketing campaigns initiated for the one or more segments using the Recency-Frequency-Monetary value matrix model. The plurality of users is associated with the one or more communication devices. The first set of data is received in real-time. The third set of data is obtained in real time. The analysis is performed based on training of a machine learning model. The analysis is performed to identify one or more patterns. The analysis is performed in real-time. The plurality of RFM filters is based on one or more parameters. The segmentation of the plurality of users is enabled in real-time. The one or more marketing campaigns are initiated based on the one or more patterns of the one or more segments using the plurality of RFM filters, the one or more marketing campaigns are initiated are initiated in real-time. The transition representation signifies transition of ach of the plurality of users within the one or more segments. The transition representation for each of the one or more segments is created in real-time. The effectiveness of each of the one or more marketing campaigns is evaluated in real-time.

In an embodiment of the present disclosure, the first set of data corresponds to personal information of the plurality of users. The first set of data includes name data, age data, e-mail identity data, contact number data, gender data, geographic location data, angiographic data, and demographic data. In addition, the first set of data includes payment cards data, banking partners data, and relationship status data. The first set of data is received from one or more online platform database, one or more communication device database, and third party database.

In an embodiment of the present disclosure, the second set of data corresponds to the plurality of past events of the plurality of users. The plurality of past events includes past uniform resource locater visits, past number of visits, past number of pages accessed, past webpage visited, past accessed content, past started content, and past paused content. In addition, the plurality of past events includes past application installed, past number of times application installed, past application launched, past number of times application launched, and past application uninstalled. Further, the plurality of past events includes past resumed content, past searched content, past notification clicks, past notification views, past products surfed, past products added to cart, and past reviews for products. Furthermore, the plurality of past events includes past favorite product category, past inactivity for products, past accounts opened, past credit card requests, past credit cards issued, and past loan requests. Moreover, the plurality of past events includes past net-banking requests, past multimedia content surfed, past multimedia content watched, past texts exchanged, past business blogs, and past live media streamed. Also, the plurality of past events includes past audio-video callings, past medicines searched, past medicines bought, past medical test kit bought, past medical tests scheduled, and past bill payments. Also, the plurality of past events includes past doctor consultation scheduled, past hospital visit planned, past dietary plan requested, past personal trainer hired, and past fitness center searched. Also, the plurality of past events includes past educational video searched, past educational video watched, past projects submitted, past mock tests subscribed, and past educational counselling requested. Also, the plurality of past events includes past problem solving session requested, past international masters interests, past properties searched, past properties watched, and past properties bought. Also, the plurality of past events includes past rented properties searched, past maintenance services requested, past hotel searched, past hotels added to watch-list, past hotel bookings, and past holiday plans searched. Also, the plurality of past events includes past holiday plans booked, past stock exchange investments, past money donated, past inactivity for product category, and past account created. Also, the plurality of past events includes past products bought, past repeated products, past subscriptions, past subscription renewals, past subscription skipped, and past initiated transactions. Also, the plurality of past events includes past failed transactions, past content added to cart, past completed transactions, and past most visited category. Also, the plurality of past events includes past content details watched, past video on demand accessed, past video on demand initiated, and past video on demand searched. The one or more online platforms include an over-the top media platform, an e-commerce platform, a fintech platform, and a social media platform. The one or more online platforms include a health platform, an educational platform, a real estate and housing platform, and a travel platform.

In an embodiment of the present disclosure, the third set of data corresponds the plurality of live events of the plurality of users. The plurality of live events includes real-time uniform resource locater visits, real-time number of webpage visits, real-time number of webpages accessed, real-time webpage visit, and real-time accessed content. In addition, the plurality of live events includes real-time application installed, real-time application launch, and real-time application uninstalled. Further, the plurality of live events includes real-time started content, real-time paused content, real-time resumed content, real-time searched content, real-time notification clicks, and real-time notification views. Furthermore, the plurality of live events includes real-time products surfed, real-time products added to cart, real-time reviews for products, real-time favorite product category, and real-time inactivity for products. Moreover, the plurality of live events includes real-time accounts opened, real-time credit card requests, real-time credit cards issued, real-time loan requests, and real-time net-banking requests. Also, the plurality of live events includes real-time multimedia content surfed, real-time multimedia content watched, real-time texts exchanged, real-time business blogs, and real-time live media streamed. Also, the plurality of live events includes real-time audio-video callings, real-time medicines searched, real-time medicines bought, real-time medical test kit bought, and real-time medical tests scheduled. Also, the plurality of live events includes real-time bill payments, real-time doctor consultation scheduled, real-time hospital visit planned, real-time dietary plan requested, and real-time personal trainer hired. Also, the plurality of live events includes real-time fitness center searched, real-time educational video searched, real-time educational video watched, real-time projects submitted, and real-time mock tests subscribed. Also, the plurality of live events includes real-time educational counselling requested, real-time problem solving session requested, real-time international masters interests, and real-time properties searched. Also, the plurality of live events includes real-time properties watched, real-time properties bought, real-time rented properties searched, real-time maintenance services requested, and real-time hotel searched. Also, the plurality of live events includes real-time hotels added to watch-list, real-time hotel bookings, real-time holiday plans searched, real-time holiday plans booked, and real-time stock exchange investments. Also, the plurality of live events includes real-time money donated, real-time inactivity for product category, real-time account created, real-time products bought, and real-time repeated products. Also, the plurality of live events includes real-time subscriptions, real-time subscription renewals, real-time subscription skipped, and real-time initiated transactions. Also, the plurality of live events includes real-time failed transactions, real-time content added to cart, real-time completed transactions, real-time most visited category, and real-time content details watched. Also, the plurality of live events includes real-time video on demand accessed, real-time video on demand initiated, and real-time video on demand searched.

In an embodiment of the present disclosure, the computer-implemented method further creates the machine learning model to perform analysis of the first set of data, the second set of data, and the third set of data at the marketing campaign evaluation system with the processor. The machine learning model is trained to identify the one or more patterns of the first set of data, the second set of data, and the third set of data for one or more categories. The one or more categories include a past behavior category and a live behavior category. The past behavior category allows the segmentation of the plurality of users based on the plurality of past events. The live behavior category allows the segmentation of the plurality of users based on the plurality of live events. The one or more categories are pre-defined by an administrator.

In an embodiment of the present disclosure, the computer-implemented method further assigns the customer value for each of the plurality of users based on the analysis of the first set of data, the second set of data, and the third set of data at the marketing campaign evaluation system with the processor. The customer value of each of the plurality of users is based on the Recency-Frequency-Monetary value matrix model. The customer value is assigned for the segmentation of the plurality of users. The customer value is assigned in real-time.

In an embodiment of the present disclosure, the plurality of RFM filters includes recency based filters, frequency based filters, monetary based filters, time based filters, days based filters, age based filters, and location based filters. In addition, the plurality of RFM filters includes events based filters, inactivity based filters, and user properties filters. In addition, the plurality of RFM filters includes categories based filters, demographic filters, geographic filters, technographic filters, and application field filters. The one or more parameters include day, time, language, location, events, inactivity, recency, frequency, monetary and online platform. The Recency-Frequency-Monetary matrix model includes a recency value matrix model, a frequency value matrix model, and a monetary value matrix model.

In an embodiment of the present disclosure, the computer-implemented method further generates the RFM grid for the one or more segments of the plurality of users at the marketing campaign evaluation system with the processor. The RFM grid highlights reachability and average monetary value for each of the plurality of users of the one or more segments. The RFM grid is generated in real-time.

In an embodiment of the present disclosure, the one or more segment goals include maximizing uniform resource locater visits, maximizing number of visits, and maximizing number of pages accessed. In addition, the one or more segment goals include maximizing webpage visits, maximizing recency value, maximizing frequency value and maximizing monetary value, and maximizing application installations. Further, the one or more segment goals include maximizing application launches, minimizing application uninstallations, maximizing accessed content, and maximizing started content. Furthermore, the one or more segment goals include minimizing paused content, maximizing searched content, maximizing notification clicks, maximizing notification views, maximizing products surfed, and maximizing products added to cart. Moreover, the one or more segment goals include maximizing reviews for products, minimizing inactivity for products, maximizing accounts opening, maximizing credit card requests, and maximizing credit cards issued. Also, the one or more segment goals include maximizing loan requests, maximizing net-banking requests, maximizing multimedia content surfed, and maximizing multimedia content watched. Also, the one or more segment goals include maximizing texts exchange, maximizing live media streaming, maximizing audio-video callings, maximizing medicines searched, and maximizing medicines bought. Also, the one or more segment goals include maximizing medical test kit bought, maximizing dietary plan requests, maximizing personal trainer hiring, and maximizing fitness center searches. Also, the one or more segment goals include maximizing educational video searches, maximizing educational video watched, maximizing projects submission, and maximizing mock tests subscription. Also, the one or more segment goals include maximizing properties searches, maximizing properties watched, maximizing rented properties searches, and maximizing maintenance services requests. Also, the one or more segment goals include maximizing hotel searches, maximizing hotel bookings, maximizing holiday plans searches, maximizing holiday plans bookings, and maximizing stock exchange investments. Also, the one or more segment goals include maximizing money donations, maximizing account creations, maximizing subscription renewals, minimizing subscription skipped, and maximizing initiated transactions. Also, the one or more segment goals include minimizing failed transactions, maximizing completed transactions, and minimizing transaction cancellations.

In an embodiment of the present disclosure, the computer-implemented method further displays one or more advertisements associated with the one or more marketing campaigns for the one or more segments at the marketing campaign evaluation system with the processor. The one or more advertisements are displayed to each of the plurality of users on the one or more communication devices based on the one or more patterns. The one or more advertisements are displayed in the real-time on the one or more communication devices.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method for assessing an effectiveness of one or more marketing campaigns using RFM matrix in real-time. The method corresponds to a marketing campaign evaluation system. The method includes a first step to receive a first set of data associated with a plurality of users. In addition, the method includes a second step to fetch a second set of data associated with a plurality of past events of the plurality of users on one or more online platforms. Further, the method includes a third step to obtain a third set of data associated with a plurality of live events of the plurality of users on the one or more online platforms through one or more communication devices. Furthermore, the method includes a fourth step to analyze the first set of data, the second set of data, and the third set of data using one or more machine learning algorithms. Moreover, the method includes a fifth step to enable segmentation of the plurality of users in one or more segments based on a customer value using a plurality of RFM filters. Also, the method includes a sixth step to initiate the one or more marketing campaigns through a RFM grid for each of the one or more segments to achieve one or more segment goals. Also, the method includes a seventh step to create a transition representation for each of the one or more segments through the one or more marketing campaigns based on a Recency-Frequency-Monetary value matrix model. Also, the method includes an eighth step to evaluate the effectiveness of each of the one or more marketing campaigns initiated for the one or more segments using the Recency-Frequency-Monetary value matrix model. The plurality of users is associated with the one or more communication devices. The first set of data is received in real-time. The third set of data is obtained in real time. The analysis is performed based on training of a machine learning model. The analysis is performed to identify one or more patterns. The analysis is performed in real-time. The plurality of RFM filters is based on one or more parameters. The segmentation of the plurality of users is enabled in real-time. The one or more marketing campaigns are initiated based on the one or more patterns of the one or more segments using the plurality of RFM filters, the one or more marketing campaigns are initiated are initiated in real-time. The transition representation signifies transition of ach of the plurality of users within the one or more segments. The transition representation for each of the one or more segments is created in real-time. The effectiveness of each of the one or more marketing campaigns is evaluated in real-time.

In a third example, a non-transitory computer-readable storage medium is provided. The non-transitory computer-readable storage medium encodes computer executable instructions that, when executed by at least one processor, performs a method for assessing an effectiveness of one or more marketing campaigns using RFM matrix in real-time. The method corresponds to a marketing campaign evaluation system. The method includes a first step to receive a first set of data associated with a plurality of users. In addition, the method includes a second step to fetch a second set of data associated with a plurality of past events of the plurality of users on one or more online platforms. Further, the method includes a third step to obtain a third set of data associated with a plurality of live events of the plurality of users on the one or more online platforms through the one or more communication devices. Furthermore, the method includes a fourth step to analyze the first set of data, the second set of data, and the third set of data using one or more machine learning algorithms. Moreover, the method includes a fifth step to enable segmentation of the plurality of users in one or more segments based on a customer value using a plurality of RFM filters. Also, the method includes a sixth step to initiate the one or more marketing campaigns through a RFM grid for each of the one or more segments to achieve one or more segment goals. Also, the method includes a seventh step to create a transition representation for each of the one or more segments through the one or more marketing campaigns based on a Recency-Frequency-Monetary value matrix model. Also, the method includes an eighth step to evaluate the effectiveness of each of the one or more marketing campaigns initiated for the one or more segments using the Recency-Frequency-Monetary value matrix model. The plurality of users is associated with the one or more communication devices. The first set of data is received in real-time. The third set of data is obtained in real time. The analysis is performed based on training of a machine learning model. The analysis is performed to identify one or more patterns. The analysis is performed in real-time. The plurality of RFM filters is based on one or more parameters. The segmentation of the plurality of users is enabled in real-time. The one or more marketing campaigns are initiated based on the one or more patterns of the one or more segments using the plurality of RFM filters, the one or more marketing campaigns are initiated are initiated in real-time. The transition representation signifies transition of ach of the plurality of users within the one or more segments. The transition representation for each of the one or more segments is created in real-time. The effectiveness of each of the one or more marketing campaigns is evaluated in real-time.

### BRIEF DESCRIPTION OF THE DRAWINGS

Having thus described the invention in general terms, reference will now be made to the accompanying drawings, which are not necessarily drawn to scale, and wherein:

FIG. 1 illustrates a block diagram of one or more online platforms, in accordance with various embodiments of the present disclosure;

FIG. 2 illustrates a general overview of an interactive system enabling interaction of a plurality of users on the one or more online platforms in real-time, in accordance with various embodiments of the present disclosure;

FIG. 3 illustrates an interactive computing environment for assessing an effectiveness of one or more marketing campaigns using RFM matrix in real-time, in accordance with various embodiments of the present disclosure;

FIG. 4 illustrates an example for initiating RFM analysis on the plurality of users based on the RFM matrix using various a plurality of RFM filters, in accordance with various embodiments of the present disclosure;

FIG. 5 illustrates an example of a “RFM plot” for the plurality of users, in accordance with various embodiments of the present disclosure;

FIG. 6 illustrates an example for assigning one or more segment goals, in accordance with various embodiments of the present disclosure;

FIG. 7 illustrates an example for selecting the plurality of channels for initiating a marketing campaign, in accordance with various embodiments of the present disclosure;

FIG. 8 illustrates an example for engaging the marketing campaign using a “mobile push” channel, in accordance with various embodiments of the present disclosure;

FIG. 9 illustrates an example of a campaign delivery and a campaign reach, in accordance with various embodiments of the present disclosure;

FIG. 10 illustrates an example for sending message for the marketing campaign, in accordance with various embodiments of the present disclosure;

FIG. 11 illustrates an example of a “single message” for the marketing campaign, in accordance with various embodiments of the present disclosure;

FIG. 12 illustrates an example of an “A/B test” for the marketing campaign, in accordance with various embodiments of the present disclosure;

FIG. 13 illustrates an example of a “setup” for the marketing campaign, in accordance with various embodiments of the present disclosure;

FIG. 14 illustrates an example of an “overview” for engagement of the marketing campaign, in accordance with various embodiments of the present disclosure;

FIG. 15 illustrates an example of a “doughnut chart” for “transitions” analysis of the plurality of users based on the RFM matrix in a segment, in accordance with various embodiments of the present disclosure;

FIG. 16 illustrates an example of a “transitions” for a “hibernating” segment, in accordance with various embodiments of the present disclosure;

FIG. 17 illustrates an example of a “transitions” for a “champions” segment, in accordance with various embodiments of the present disclosure;

FIG. 18 illustrates an example of a “transitions” for a “at risk” segment, in accordance with various embodiments of the present disclosure;

FIG. 19 illustrates an example of a “transitions” for an “inactive” segment, in accordance with various embodiments of the present disclosure;

FIG. 20 illustrates an example of a “transitions” for a “cannot lose them” segment, in accordance with various embodiments of the present disclosure;

FIG. 21 illustrates an example of a “distribution” for “recency” in the form of “bar graph” for the plurality of users, in accordance with various embodiments of the present disclosure;

FIG. 22 illustrates an example of a “distribution” for “frequency” in the form of the “bar graph” for the plurality of users, in accordance with various embodiments of the present disclosure;

FIG. 23 illustrates an example of a “distribution” for “monetary” in the form of the “bar graph” for the plurality of users, in accordance with various embodiments of the present disclosure;

FIG. 24 illustrates an example of a change in size of the one or more segments based on the RFM analysis for the “date & time”, in accordance with various embodiments of the present disclosure;

FIG. 25 illustrates an example of a detail of the “cannot lose them” segment of the one or more segments on the “RFM plot”, in accordance with various embodiments of the present disclosure;

FIGS. 26A, 26B and 26C illustrate a flow chart of the method for assessing the effectiveness of the one or more marketing campaigns using the RFM matrix in real-time, in accordance with various embodiments of the present disclosure; and

FIG. 27 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

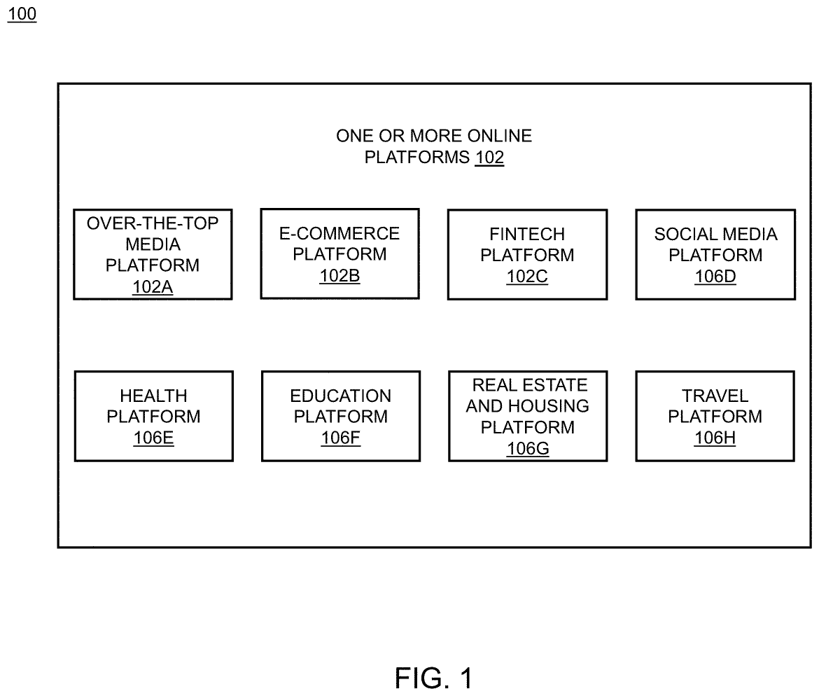

FIG. 1 illustrates a block diagram 100 of one or more online platforms 102, in accordance with various embodiments of the present disclosure. In general, each of online platforms is a computing platform which enables various individuals to obtain, upload and access valuable resources or services. In addition, the one or more platforms 102 include a plurality of contents. In an embodiment of the present disclosure, the plurality of contents includes but may not be limited to a plurality of OTT media contents, a plurality of products, a plurality of financial services, and one or more social media contents. In another embodiment of the present disclosure, the plurality of contents includes but may not be limited to a plurality of health services, a plurality of educational services, a plurality of real estate services, and a plurality of travel services. However, the plurality of contents is not limited to the above-mentioned contents.

In an embodiment of the present disclosure, the one or more online platforms 102 correspond to android operating system compatible application. In another embodiment of the present disclosure, the one or more online platforms 102 correspond to windows operating system compatible applications. In yet another embodiment of the present disclosure, the one or more online platforms 102 correspond to iPhone operating system compatible applications. In yet another embodiment of the present disclosure, the one or more online platforms 102 correspond to mac operating system compatible applications. In yet another embodiment of the present disclosure, the one or more online platforms 102 correspond to webpages. However, the one or more online platforms 102 are not limited to the above-mentioned online platforms.

In addition, the one or more online platforms 102 include an over-the top media platform 102A, an e-commerce platform 102B, a fintech platform 102C, a social media platform 102D, and a health platform 102E. Further, the one or more online platforms 102 include an educational platform 102F, a real estate and housing platform 102G, and a travel platform 102H. However, the one or more online platforms 102 are not limited to the above-mentioned online platforms.

In an embodiment of the present disclosure, the one or more online platforms 102 include the over-the-top media platform 102A. In general, the over-the-top media platform provides a streaming media service to the various individuals over internet. In addition, the over-the-top media platform 102A has the plurality of OTT media contents. The plurality of OTT media contents includes but may not be limited to drama series, documentaries, anime, comedy series, science based series, kid series, movies, and stand-up comedy shows. The plurality of OTT media contents is searched using a plurality of genre codes on the over-the-top media platform 102A. The plurality of genre codes includes but may not be limited to action and adventure, action comedies, action sci-fi and fantasy, action thrillers, anime action, region based action content, crime action, and classic action. In an example, an individual I opens an over-the-top media platform O1 on a web browser W1 to watch live baseball match on a communication device D1 (let's say a smartphone) using internet connection.

In an embodiment of the present disclosure, the one or more online platforms 102 include the e-commerce platform 102B. In general, the e-commerce platform provides an online service of buying or selling of various products over the Internet. In addition, the e-commerce platform 102B has the plurality of products. The plurality of products includes but may not be limited to laptops, tablets, mobiles, clocks, decorative accessories, books, home appliances, shoes, bags, jewelry, clothes, stationery, golf kit, and baseball bat. The plurality of products is searched using a plurality of sections on the e-commerce platform 102B. The plurality of sections includes but may not be limited to books and audible, movies and games, electronics, toys, clothes, sports, health and beauty, business, industry, science, and handmade. In an example, an Individual I launches an e-commerce application E1 on a communication device D1 (let's say a desktop) to surf various shoes brands.

In an embodiment of the present disclosure, the one or more online platforms 102 include the fintech platform 102C. In general, the fintech platform provides an online financial services to the various individuals over the Internet. In addition, the fintech platform 102C includes the plurality of financial services. The plurality of financial services includes but may not be limited to car buying loans, house buying loans, credit cards, net banking, commercial banking, opening saving accounts, home equity, and stock exchange investment. However, the plurality of financial services is not limited to the above-mentioned financial services. In an example, an individual I searches for best education loan plan for higher studies on a fintech platform F1 using a communication device D1 (let's say a laptop).

In an embodiment of the present disclosure, the one or more online platforms 102 include the social media platform 102D. In general, the social media platform facilitates creating and sharing of contents for various individuals over the internet. In addition, the social media platform 102D has the one or more social media contents. The one or more social media contents includes but may not be limited to online games, business blogs, retail products, live video streams, text messages, multimedia contents, educational content, current affairs, and real-time activity updates. However, the one or more social media contents are not limited to the above-mentioned contents. In an example, an individual I promotes electronic product P1 on a social media platform S1 using a business page B1 on a communication device D1 (let's say a desktop).

In an embodiment of the present disclosure, the one or more online platforms 102 include the heath platform 102E. In general, the health platform enables the various individuals to access personalized digital healthcare, diet and medicines to enhance the efficiency of healthcare delivery. In addition, the health platform 102E provides the plurality of health services. The plurality of health services includes but may not be limited to diet plans, medicines, physician clinics, nearest hospital, nearest fitness clubs, exercises, yoga classes, aerobics, healthy food orders, and medical tests. However, the plurality of health services is not limited to the above-mentioned services. In an example, a patient P1 searches for bronchial asthma medicine M1 on a fintech platform F1 through a communication device D1 (let's say a tablet).

In an embodiment of the present disclosure, the one or more online platforms 102 include the education platform 102F. In general, the education platform enables students and parents to access personalized digital educational information, tools and resources to enhance the efficiency of educational development. In addition, the education platform 102F provides the plurality of educational services. The plurality of educational services includes but may not be limited to live teacher-student interaction, online subject wise informative media contents, entrance examination preparatory matters, and technical support for educational projects. However, the plurality of educational services is not limited to the above-mentioned services. In an example, a student S1 finds difficult to solve an integration problem I1. The student S1 searches for online lecture for integrations on an education platform E1 through a communication device D1 (let's say a smartphone).

In an embodiment of the present disclosure, the one or more online platforms 102 include the real estate and housing platform 102G. In general, the real estate and housing platform enables the various individuals to access personalized digital real estate and housing information and minimizes efforts of the corresponding individual. In addition, the real estate and housing platform 102G provides the plurality of real estate services. The plurality of real estate services includes but may not be limited to houses on rent, properties on sale, house cleaning, garbage disposal, home repair, maintenance, and interior designing. However, the plurality of real estate services is not limited to the above-mentioned services. In an example, an individual I surfs for an apartment A1 in New York on a real estate platform through a communication device D2 (let's say a laptop).

In an embodiment of the present disclosure, the one or more online platforms 102 include the travel platform 102H. In general, the travel platform enables the various individuals to access personalized digital travel and hospitality information. In addition, the travel platform 102H provides the plurality of travel services. The plurality of travel services includes but may not be limited to flight booking, train booking, taxi hiring, vacation deals, hotel booking, travel destination information, couch-surfing travel, and hot restaurant deals. However, the plurality of travel services is not limited to the above-mentioned services. In an example, an individual I wants to book a hotel room R1 in Miami. The individual I surfs on a travel platform T1 through a communication device D1 (let's say a workstation).

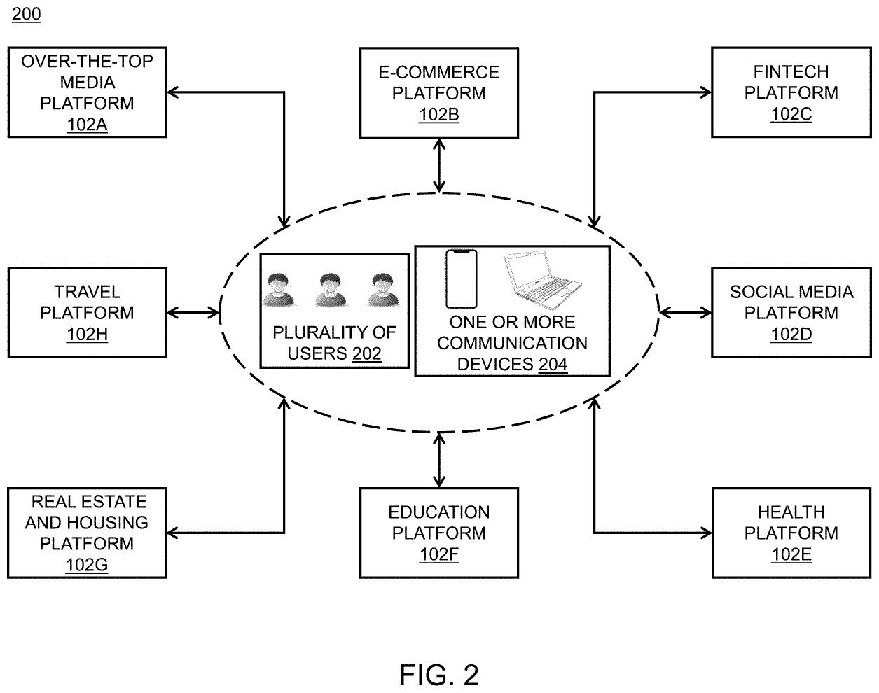

FIG. 2 illustrates a general overview of an interactive system 200 enabling interaction of a plurality of users 202 on the one or more online platforms 102 in real-time, in accordance with various embodiments of the present disclosure. The interactive system 200 is any environment facilitating interaction of the plurality of users 202 with the one or more online platforms 102. In addition, the interactive system 200 includes the plurality of users 202, one or more communication devices 204, and the one or more online platforms 102.

The interactive system 200 includes the plurality of users 202. In addition, the plurality of users 202 may be any person or individual accessing the one or more communication devices 204. In an embodiment of the present disclosure, the plurality of users 202 is an owner of the one or more communication devices 204. In another embodiment of the present disclosure, the plurality of users 202 is not the owner of the one or more communication devices 204. In an embodiment of the present disclosure, the plurality of users 202 accesses the one or more communication devices 204 at home. In another embodiment of the present disclosure, the plurality of users 202 accesses the one or more communication devices 204 at a cafe. In yet another embodiment of the present disclosure, the plurality of users 202 accesses the one or more communication devices 204 in an office. In an example, a user U1 accesses a smartphone S1 while sitting in a living room. In another example, a user U2 accesses a laptop L1 while travelling from one place to another. In yet another example, a user U3 accesses a desktop computer D1 while working in the office.

The interactive system 200 includes the one or more communication devices 204. The plurality of users 202 is connected with the interactive system 200 through the one or more communication devices 204. In an embodiment of the present disclosure, the one or more communication devices 204 facilitate access to the one or more online platforms 102. In an embodiment of the present disclosure, each of the one or more communication devices 204 is a portable communication device. The portable communication device includes but may not be limited to a laptop, a smartphone, a tablet, and a smart watch. In an example, the smartphone may be an iOS-based smartphone, an android-based smartphone, a windows-based smartphone and the like. In another embodiment of the present disclosure, each of the one or more communication devices 204 is a fixed communication device. The fixed communication device includes but may not be limited to a desktop, a workstation, a smart TV and a mainframe computer. In an embodiment of the present disclosure, the one or more communication devices 204 are currently in the switched-on state. The one or more communication devices 204 are any type of devices having an active internet. In addition, each of the plurality of users 202 accesses corresponding communication device of the one or more communication devices 204 in real-time.

In an embodiment of the present disclosure, the one or more communication devices 204 perform computing operations based on a suitable operating system installed inside the one or more communication devices 204. In general, the operating system is system software that manages computer hardware and software resources and provide common services for computer programs. In addition, the operating system acts as an interface for software installed inside the one or more communication devices 204 to interact with hardware components of the one or more communication devices 204. In an embodiment of the present disclosure, each of the one or more communication devices 204 perform computing operations based on any suitable operating system designed for the portable communication device. In an example, the operating system installed inside the one or more communication devices 204 is a mobile operating system. Further, the mobile operating system includes but may not be limited to windows operating system, android operating system, iOS operating system, Symbian operating system, BADA operating system from Samsung Electronics and BlackBerry operating system, and Sailfish. However, the operating system is not limited to above mentioned operating systems. In an embodiment of the present disclosure, the one or more communication devices 204 operate on any version of particular operating system corresponding to above mentioned operating systems.

In another embodiment of the present disclosure, the one or more communication devices 204 perform computing operations based on any suitable operating system designed for fixed communication device. In an example, the operating system installed inside the one or more communication devices 204 is windows. In another example, the operating system installed inside the one or more communication devices 204 is Mac. In yet another example, the operating system installed inside the one or more communication devices 204 is Linux based operating system. In yet another example, the operating system installed inside the one or more communication devices 204 is Chrome OS. In yet another example, the operating system installed inside the one or more communication devices 204 may be one of UNIX, Kali Linux, and the like. However, the operating system is not limited to above mentioned operating systems.

In an embodiment of the present disclosure, the one or more communication devices 204 operate on any version of windows operating system. In another embodiment of the present disclosure, the one or more communication devices 204 operate on any version of Mac operating system. In yet another embodiment of the present disclosure, the one or more communication devices 204 operate on any version of Linux operating system. In yet another embodiment of the present disclosure, the one or more communication devices 204 operate on any version of Chrome OS. In yet another embodiment of the present disclosure, the one or more communication devices 204 operate on any version of particular operating system corresponding to above mentioned operating systems.

In an embodiment of the present disclosure, the one or more online platforms 102 are installed on the one or more communication devices 204. The one or more online platforms 102 allow the plurality of users 202 to access the plurality of contents. In another embodiment of the present disclosure, the one or more online platforms 102 are run on a plurality of web browsers installed on the one or more communication devices 204. In an example, the plurality of web browsers includes but may not be limited to Opera, Mozilla Firefox, Google Chrome, Internet Explorer, Microsoft Edge, Safari and UC Browser. Further, the plurality of web browsers installed on the one or more communication devices 204 runs on any version of the respective web browser of the above mentioned web browsers. In an example, a user U1 opens an e-commerce application E1 to buy cutlery items. In another example, a user U2 accesses a fintech wepage F2 on Google Chrome for a car loan.

The interactive system 200 includes the over-the top media platform 102A. The plurality of users 202 connects with the over-the top media platform 102A on the one or more communication devices 204 to access the plurality of OTT media contents. In an embodiment of the present disclosure, the over-the top media platform 102A is the application installed on the one or more communication devices 204. In another embodiment of the present disclosure, the over-the top media platform 102A is accessed on the one or more communication devices 204 through the plurality of web browsers. In an example, a user U1 watches a sci-fi movie M1 on an OTT platform O1 installed in a form of application on a communication device D1 (let's say a smartphone). In another example, a user U2 watches a stand-up comedy show S2 on an OTT platform O2 on a communication device D2 (let's say a desktop computer) through a web browser W2 (let's say Google Chrome). In yet another example, a user U3 adds an anime A3 to a watch-list W3 on an OTT platform O3 installed on a communication device D3 (let's say a tablet).

The interactive system 200 includes the e-commerce platform 102B. The plurality of users 202 connects with the e-commerce platform 102B on the one or more communication devices 204 to access the plurality of products. In an embodiment of the present disclosure, the e-commerce platform 102B is the application installed on the one or more communication devices 204. In another embodiment of the present disclosure, the e-commerce platform 102B is accessed on the one or more communication devices 204 through the plurality of web browsers. In an example, a user U1 surfs various smartwatches S1 on an e-commerce platform E1 installed in a form of application on a communication device D1 (let's say a smartphone). In another example, a user U2 buys a grooming kit G2 on an e-commerce platform E2 on a communication device D2 (let's say a desktop computer) through a web browser W2 (let's say UC Browser). In yet another example, a user U3 adds a musical instrument M3 to a cart on an e-commerce platform E3 installed on a communication device D3 (let's say a tablet).

The interactive system 200 includes the fintech platform 102C. The plurality of users 202 connects with the fintech platform 102C on the one or more communication devices 204 to access the plurality of financial services. In an embodiment of the present disclosure, the fintech platform 102C is the application installed on the one or more communication devices 204. In another embodiment of the present disclosure, the fintech platform 102C is accessed on the one or more communication devices 204 through the plurality of web browsers. In an example, a user U1 surfs various account opening options O1 on fintech platform F1 installed in a form of application on a communication device D1 (let's say a smartphone). In another example, a user U2 requests for car loan L2 on a fintech platform F2 on a communication device D2 (let's say a desktop computer) through a web browser W2 (let's say Google Chrome). In yet another example, a user U3 buys a credit card C3 on a fintech platform F3 on a communication device D3 (let's say a tablet) through a web browser W3 (let's say Microsoft Edge).

The interactive system 200 includes the social media platform 102D. The plurality of users 202 connects with the social media platform 102D on the one or more communication devices 204 to access the one or more social media contents. In an embodiment of the present disclosure, the social media platform 102D is the application installed on the one or more communication devices 204. In another embodiment of the present disclosure, the social media platform 102D is accessed on the one or more communication devices 204 through the plurality of web browsers. In an example, a user U1 surfs various multimedia content C1 (let's say a teaser of a music video) on a social media platform S1 installed in a form of application on a communication device D1 (let's say a smartphone). In another example, a user U2 promotes a handcraft product P2 (let's say a woodcraft vase) on a social media platform S2 on a communication device D2 (let's say a desktop computer) through a web browser W2 (let's say Mozilla Firefox). In yet another example, a user U3 streams live video V3 on a social media platform S3 through a web browser W3 (let's say Opera Browser). In yet another example, a manufacturer of goods, a service provider, and a retailer may join the social media platform S4. The social media platform S4 allows users U4 to be connected to the manufacturer of goods, the service provider, and the retailer.

The interactive system 200 includes the health platform 102E. The plurality of users 202 connects with the health platform 102E on the one or more communication devices 204 to access the plurality of health services. In an embodiment of the present disclosure, the health platform 102E is the application installed on the one or more communication devices 204. In another embodiment of the present disclosure, the health platform 102E is accessed on the one or more communication devices 204 through the plurality of web browsers. In an example, a user U1 surfs various healthcare contents (let's say a tuberculosis medicine) on a health platform H1 installed in a form of application on a communication device D1 (let's say a smartphone). In another example, a user U2 creates a dietary plan on a health platform H2 on a communication device D2 (let's say a desktop computer) through a web browser W2 (let's say Mozilla Firefox). In yet another example, a user U3 buys medicine M3 (let's say diabetes medicines) on a health platform H3 installed on a communication device D3 (let's say a tablet).

The interactive system 200 includes the education platform 102F. The plurality of users 202 connects with the education platform 102F on the one or more communication devices 204 to access the plurality of educational services. In an embodiment of the present disclosure, the education platform 102F is the application installed on the one or more communication devices 204. In another embodiment of the present disclosure, the education platform 102F is accessed on the one or more communication devices 204 through the plurality of web browsers. In an example, a user U1 surfs various mathematical training videos (let's say a differential equation lecture) on an education platform E1 on a communication device D1 (let's say a smartphone) through a web browser W1 (let's say UC Browser). In another example, a user U2 submits online science project (let's say a hydraulic power brakes) on an education platform E2 installed in a form of application on a communication device D2 (let's say a desktop computer). In yet another example, a user U3 prepares for common entrance exam on an education platform E3 installed on a communication device D3 (let's say a tablet).

The interactive system 200 includes the real estate and housing platform 102G. The plurality of users 202 connects with the real estate and housing platform 102G on the one or more communication devices 204 to access the plurality of real estate services. In an embodiment of the present disclosure, the real estate and housing platform 102G is the application installed on the one or more communication devices 204. In another embodiment of the present disclosure, the real estate and housing platform 102G is accessed on the one or more communication devices 204 through the plurality of web browsers. In an example, a user U1 surfs various apartments (let's say a studio apartment) on sale on a real estate platform R1 installed in a form of application on a communication device D1 (let's say a smartphone). In another example, a user U2 requests property seller contact details on a real estate platform R2 on a communication device D2 (let's say a desktop computer) through a web browser W2 (let's say Google Chrome). In yet another example, a user U3 uploads images of a property (let's say a penthouse) for sale on a real estate platform R3 on a communication device D3 (let's say a tablet). In yet another example, a user U4 negotiates online for rent of a bungalow on a real estate platform R4 installed on a communication device D4 (let's say a laptop).

The interactive system 200 includes the travel platform 102H. The plurality of users 202 connects with the travel platform 102H on the one or more communication devices 204 to access the plurality of travel services. In an embodiment of the present disclosure, the travel platform 102H is the application installed on the one or more communication devices 204. In another embodiment of the present disclosure, the travel platform 102H is accessed on the one or more communication devices 204 through the plurality of web browsers. In an example, a user U1 surfs various flight options to travel from California to Chicago on a travel platform T1 installed in a form of application on a communication device D1 (let's say a smartphone). In another example, a user U2 requests price quotations for fifty hotel rooms in Cleveland on a travel platform T2 on a communication device D2 (let's say a desktop computer) through a web browser W2 (let's say Safari Browser). In yet another example, a user U3 uploads images of food (let's say a Thai Food) on a travel platform T3 installed on a communication device D3 (let's say a tablet). In yet another example, a user U4 books holiday package (let's say 5 days and 6 nights) for Switzerland on a travel platform T4 on a communication device D4 (let's say a laptop) through a web browser W4 (let's say Opera Browser).

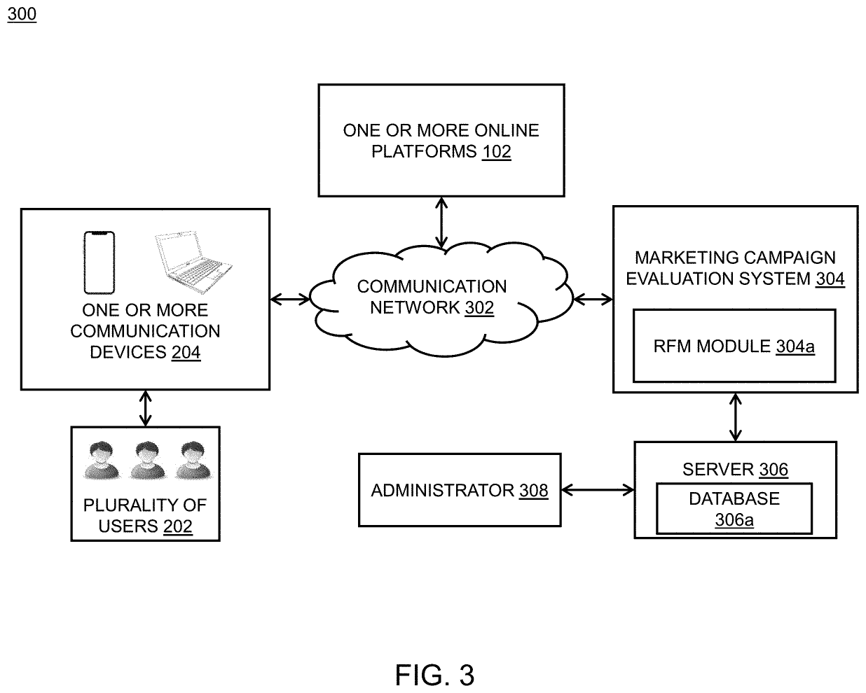

FIG. 3 illustrates an interactive computing environment 300 for segmentation of the plurality of users 202 in real-time, in accordance with various embodiments of the present disclosure. The interactive computing environment 300 includes the plurality of users 202, the one or more communication devices 204, a communication network 302, and the one or more online platforms 102. In addition, the interactive computing environment 300 includes a marketing campaign evaluation system 304, a server 306, a database 306a, and an administrator 308. The above stated elements of the interactive computing environment 300 operate coherently and synchronously to enable segmentation of the plurality of users 202 in real-time.

The interactive computing environment 300 includes the plurality of users 202. The plurality of users 202 corresponds to any number of person or individual associated with the marketing campaign evaluation system 304. The marketing campaign evaluation system 304 accesses behavior of each of the plurality of users 202 on the one or more online platforms 102 through the one or more communication devices 204 using the communication network 302. In an example, a user U1 watches action movie on an online platform P1 through a communication device D1 (let's say a smartphone). In another example, a user U2 clicks on notification N2 (let's say renew of subscription with 25% discount) while surfing on an online platform P2 through a communication device D2 (let's say a desktop computer). In yet another example, a user U3 initiates video on demand transaction on an online platform P3 through a communication device D3 (let's say a laptop).

The interactive computing environment 300 includes the plurality of users 202. In addition, the plurality of users 202 accesses the one or more online platforms 102 through the one or more communication devices 204. Further, the one or more communication devices 204 are associated with the plurality of users 202. Furthermore, the marketing campaign evaluation system 304 receives a first set of data associated with the plurality of users 202. The first set of data corresponds to personal information of the plurality of users 202. Moreover, the first set of data includes but may not be limited to name data, age data, e-mail identity data, contact number data, gender data, geographic location data, and angiographic data. Also, the first set of data includes but may not be limited to demographic data, payment cards data, banking partners data, and relationship status data. In an embodiment of the present disclosure, the first set of data is received from one or more online platform database, one or more communication device database, and third party database. In another embodiment of the present disclosure, the first set of data is received from the plurality of users 202. In an example, a user U1 may provide his or her name, profile picture, city of residence, contact information, birth date, gender, marital status, employment, educational background, interests, and other demographic information.

In an example, a user U2 provides name data on an OTT platform P1 while subscribing through a communication device D1 (let's say a smartphone). In another example, a user U3 installs various mobile applications on a communication device D2 (let's say a desktop computer) through an application store using internet connection. In yet another example, a student S1 chooses fifth standard while accessing geography lecture on an educational platform P2 through a communication device D3 (let's say a tablet). In yet another example, a user U4 provides an email-identity for receiving a real-time updates of regular health check-ups on a health platform P3 through a communication device D4 (let's say a laptop) using internet. In yet another example, a user U5 provides contact number on a fintech platform P4 to receive real-time text updates regarding saving account through a communication device D5 (let's say a smartphone).

In an embodiment of the present disclosure, the first set of data is received from the over-the-top media platform 102A. In another embodiment of the present disclosure, the first set of data is received from the e-commerce platform 102B. In yet another embodiment of the present disclosure, the first set of data is received from the fintech platform 102C. In yet another embodiment of the present disclosure, the first set of data is received from the social media platform 102D. In yet another embodiment of the present disclosure, the first set of data is received from the health platform 102E. In yet another embodiment of the present disclosure, the first set of data is received from the education platform 102F. In yet another embodiment of the present disclosure, the first set of data is received from the real-estate and housing platform 102G. In yet another embodiment of the present disclosure, the first set of data is received from the travel platform 102H.

The interactive computing environment 300 includes the plurality of users 202 who is any person present at any location and accessing the plurality of contents. In addition, the plurality of contents is associated with the one or more online platforms 102. The plurality of users 202 is any legal person or natural person who access the plurality of contents and need an IP based network for accessing the plurality of contents. In addition, the plurality of users 202 is an individual or person who access the plurality of contents on the one or more platforms 102 through the one or more communication devices 204. The plurality of users 202 is associated with the one or more communication devices 204.

In an embodiment of the present disclosure, the plurality of users 202 accesses the plurality of OTT media contents on the over-the-top media platform 102A. In another embodiment of the present disclosure, the plurality of users 202 accesses the plurality of products on the e-commerce platform 102B. In yet another embodiment of the present disclosure, the plurality of users 202 accesses the plurality of financial services on the fintech platform 102C. In yet another embodiment of the present disclosure, the plurality of users 202 accesses the one or more social media contents on the social media platform 102D. In yet another embodiment of the present disclosure, the plurality of users 202 accesses the plurality of health services on the health platform 102E. In yet another embodiment of the present disclosure, the plurality of users 202 accesses the plurality of educational services on the education platform 102F. In yet another embodiment of the present disclosure, the plurality of users 202 accesses the plurality of real estate services on the real-estate and housing platform 102G. In yet another embodiment of the present disclosure, the plurality of users 202 accesses the plurality of travel services on the travel platform 102H.

The interactive computing environment 300 includes the one or more communication devices 204 which enable the plurality of users 202 to access the one or more online platforms 102. The one or more communication devices 204 are internet-enabled device for allowing the plurality of users 202 to access the one or more online platforms 102. In an embodiment of the present disclosure, the plurality of users 202 is the owner of the one or more communication devices 204. In another embodiment of the present disclosure, the plurality of users 202 is not the owner of the one or more communication devices 204.

In an embodiment of the present disclosure, the plurality of users 202 installs an application of the over-the-top media platform 102A on the one or more communication device 204. In another embodiment of the present disclosure, the plurality of users 202 installs an application of the e-commerce platform 102B on the one or more communication device 204. In yet another embodiment of the present disclosure, the plurality of users 202 installs an application of the fintech platform 102C on the one or more communication device 204. In yet another embodiment of the present disclosure, the plurality of users 202 installs an application of the social media platform 102D on the one or more communication device 204. In yet another embodiment of the present disclosure, the plurality of users 202 installs an application of the health platform 102E on the one or more communication device 204. In yet another embodiment of the present disclosure, the plurality of users 202 installs an application of the education platform 102F on the one or more communication device 204. In yet another embodiment of the present disclosure, the plurality of users 202 installs an application of the real-estate and housing platform 102G on the one or more communication device 204. In yet another embodiment of the present disclosure, the plurality of users 202 installs an application of the travel platform 102H on the one or more communication device 204.

In an embodiment of the present disclosure, the plurality of users 202 accesses the over-the-top media platform 102A on the one or more communication devices 204 through the plurality of web browsers. In another embodiment of the present disclosure, the plurality of users 202 accesses the e-commerce platform 102B on the one or more communication devices 204 through the plurality of web browsers. In yet another embodiment of the present disclosure, the plurality of users 202 accesses the fintech platform 102C on the one or more communication devices 204 through the plurality of web browsers. In yet another embodiment of the present disclosure, the plurality of users 202 accesses the social media platform 102D on the one or more communication devices 204 through the plurality of web browsers. In yet another embodiment of the present disclosure, the plurality of users 202 accesses the health platform 102E on the one or more communication devices 204 through the plurality of web browsers. In yet another embodiment of the present disclosure, the plurality of users 202 accesses the education platform 102F on the one or more communication devices 204 through the plurality of web browsers. In yet another embodiment of the present disclosure, the plurality of users 202 accesses the real-estate and housing platform 102G on the one or more communication devices 204 through the plurality of web browsers. In yet another embodiment of the present disclosure, the plurality of users 202 accesses the travel platform 102H on the one or more communication devices 204 through the plurality of web browsers.

The interactive computing environment 300 includes the one or more communication devices 204. The one or more communication devices 204 provide an interface for the plurality of users 202 to interact with the interactive computing environment 300. The plurality of users 202 can interact with the interactive computing environment 300 through more than one device of the one or more communication devices 204. In an example, a user U1 connects with the interactive computing environment 300 through a communication device D1 (let's say a smartphone) to watch video on demand at home. In another example, a user U2 connects with the interactive computing environment 300 through a communication device D2 (let's say a desktop computer) at home. The user U3 connects with the interactive computing environment 300 with a communication device D3 (let's say a tablet) while travelling.

Each of the one or more communication devices 204 comprises of a memory. In general, the memory includes computer-storage media in the form of volatile and/or nonvolatile memory. The memory may be removable, non-removable, or a combination thereof. Exemplary hardware devices include solid-state memory, hard drives, optical-disc drives, etc. The memory is coupled with one or more processors. In general, the one or more processor read data from various entities such as memory or I/O components. The one or more processor execute the one or more instructions which are stored in the memory. The one or more processors provide execution method for one or more instructions provided by the marketing campaign evaluation system 304.

The one or more communication devices 204 is a media device. The one or more communication devices 204 enable the plurality of users 202 to access the plurality of contents on the one or more online platforms 102. The one or more communication devices 204 support various multimedia contents. The plurality of users 202 accesses the plurality of contents in real-time through the one or more communication devices 204. In an embodiment of the present disclosure, the plurality of contents is a video stream. In another embodiment of the present disclosure, the plurality of contents corresponds to video on demand being accessed on the one or more communication devices 204. In yet another embodiment of the present disclosure, the plurality of contents is an audio clip. In yet another embodiment of the present disclosure, the plurality of contents corresponds to an e-commerce product. In yet another embodiment of the present disclosure, the plurality of contents is an illustration. In yet another embodiment of the present disclosure, the plurality of contents is an e-book.

The interactive computing environment 300 includes the one or more online platforms 102. The plurality of users 202 performs various activities on the one or more online platforms 102 through the one or more communication devices 204. In addition, the plurality of users 202 accesses the plurality of contents on the one or more online platforms 102 in real-time. In an example, a user U1 watches comedy show C1 on online platform P1 through a communication device D1 (let's say a smartphone). In another example, a user U2 explores smart watches on the online platform P2 through the communication device D2 (let's say a desktop computer) in real-time. In yet another example, a user U3 reads fiction novel N1 on online platform P3 through a communication device D3 (let's say a laptop) in real-time. In yet another example, a user U4 clicks on notification N2 while watching adventure movie M1 on online platform P4 through a communication device D4 (let's say a tablet) in real-time. Further, the one or more online platforms 102 include the over-the top media platform 102A, the e-commerce platform 102B, the fintech platform 102C, the social media platform 102D, and the health platform 102E. Furthermore, the one or more online platforms 102 include the educational platform 102F, the real estate and housing platform 102G, and the travel platform 102H. However, the one or more online platforms 102 are not limited to the above-mentioned online platforms.

The interactive computing environment 300 includes the communication network 302. The one or more communication devices 204 is connected to the communication network 302. The communication network 302 provides a medium for the plurality of users 202 accessing the plurality of contents on the one or more online platforms 102 to connect with the marketing campaign evaluation system 304. In an embodiment of the present disclosure, the communication network 302 is an internet connection. In another embodiment of the present disclosure, the communication network 302 is a wireless mobile network. In yet another embodiment of the present disclosure, the communication network 302 is a wired network with a finite bandwidth. In yet another embodiment of the present disclosure, the communication network 302 is a combination of the wireless and the wired network for the optimum throughput of data transmission. In yet another embodiment of the present disclosure, the communication network 302 is an optical fiber high bandwidth network that enables a high data rate with negligible connection drops. The communication network 302 includes a set of channels. Each channel of the set of channels supports a finite bandwidth. Moreover, the finite bandwidth of each channel of the set of channels is based on capacity of the communication network 302. The communication network 302 connects the one or more communication devices 204 to the marketing campaign evaluation system 304 using a plurality of methods. The plurality of methods used to provide network connectivity to the one or more communication devices 204 includes 2G, 3G, 4G, 5G, Wifi and the like.

The interactive computing environment 300 includes the marketing campaign evaluation system 304 which is associated with the one or more online platforms 102 and the plurality of users 202. In addition, the marketing campaign evaluation system 304 enables segmentation of the plurality of users 202 in real-time based on the various activities of the plurality of users 202. The marketing campaign evaluation system 304 enables the granular level segmentation of the plurality of users 202 based on analysis done on various activities of the plurality of users 202 on the one or more platforms 102 at the granular level. The marketing campaign evaluation system 304 creates one or more segments based on analysis done on various activities of the plurality of users 202. The marketing campaign evaluation system 304 triggers initialization of one or more marketing campaigns based on the one or more segments.

The marketing campaign evaluation system 304 receives the first set of data associated with the plurality of users 202 in real-time. The plurality of users 202 is associated with the one or more communication devices 204. In addition, the first set of data corresponds to the personal information of the plurality of users 202. The first set of data includes but may not be limited to name data, age data, e-mail identity data, contact number data, gender data, and geographic location data. In addition, the first set of data includes but may not be limited to, angiographic data, demographic data, payment cards data, banking partners data, and relationship status data. In an example, users U1 provide name data D1 on an online platform P1 while signing up for accessing various services and contents through communication devices C1 (let's say smartphones). In another example, users U2 provide e-mail identity data D2 on an online platform P2 before accessing various contents and services through communication devices C2 (let's say desktop computers). In yet another example, users U3 provide demographic data D3 on an online platform P3 while signing up for accessing various services and contents through communication devices C3 (let's say tablets). In yet another example, users U4 provide geographic data D4 on an online platform P4 while signing up for accessing various services and contents through communication devices C4 (let's say laptops). In yet another example, users U5 provide angiographic data on an online health platform P5 while accessing various services and contents.

In an embodiment of the present disclosure, the marketing campaign evaluation system 304 accesses the first set of data from the over-the-top media platform 102A through the communication network 302. In another embodiment of the present disclosure, the marketing campaign evaluation system 304 accesses the first set of data from the e-commerce platform 102B through the communication network 302. In yet another embodiment of the present disclosure, the marketing campaign evaluation system 304 accesses the first set of data from the fintech platform 102C through the communication network 302. In yet another embodiment of the present disclosure, the marketing campaign evaluation system 304 accesses the first set of data from the social media platform 102D through the communication network 302. In yet another embodiment of the present disclosure, the marketing campaign evaluation system 304 accesses the first set of data from the health platform 102E through the communication network 302. In yet another embodiment of the present disclosure, the marketing campaign evaluation system 304 accesses the first set of data from the education platform 102F through the communication network 302. In yet another embodiment of the present disclosure, the marketing campaign evaluation system 304 accesses the first set of data from the real-estate and housing platform 102G through the communication network 302. In yet another embodiment of the present disclosure, the marketing campaign evaluation system 304 accesses the first set of data from the travel platform 102H through the communication network 302. In addition, the first set of data may be received from the one or more online platform database, the one or more communication device database, and the third party database.

The marketing campaign evaluation system 304 fetches a second set of data associated with a plurality of past events of the plurality of users 202 on the one or more online platforms 102. In addition, the second set of data corresponds the plurality of past events of the plurality of users 202 on the granular level. In an example, the plurality of past events includes but may not be limited to past uniform resource locater visits, past number of visits, past number of pages accessed, past webpage visited, and past accessed content. In another example, the plurality of past events includes but may not be limited to past application installed, past number of times application installed, past application launched, past number of times application launched, and past application uninstalled. In yet another example, the plurality of past events includes but may not be limited to past started content, past paused content, past resumed content, past searched content, past notification clicks, and past notification views. In yet another example, the plurality of past events includes but may not be limited to past products surfed, past products added to cart, past reviews for products, past favorite product category, and past inactivity for products. In yet another example, the plurality of past events includes but may not be limited to past accounts opened, past credit card requests, past credit cards issued, past loan requests, and past net-banking requests. In yet another example, the plurality of past events includes but may not be limited to past multimedia content surfed, past multimedia content watched, past texts exchanged, past business blogs, and past live media streamed. In yet another example, the plurality of past events includes but may not be limited to past audio-video callings, past medicines searched, past medicines bought, and past medical test kit bought. In yet another example, the plurality of past events includes but may not be limited to past medical tests scheduled, past bill payments, past doctor consultation scheduled, and past hospital visit planned. In yet another example, the plurality of past events includes but may not be limited to past dietary plan requested, past personal trainer hired, past fitness center searched, and past educational video searched. In yet another example, the plurality of past events includes but may not be limited to past educational video watched, past projects submitted, past mock tests subscribed, and past educational counselling requested. In yet another example, the plurality of past events includes but may not be limited to past problem solving session requested, past international masters interests, and past properties searched. In yet another example, the plurality of past events includes but may not be limited to past properties watched, past properties bought, past rented properties searched, and past maintenance services requested. In yet another example, the plurality of past events includes but may not be limited to past hotel searched, past hotels added to watch-list, past hotel bookings, past holiday plans searched, and past holiday plans booked. In yet another example, the plurality of past events includes but may not be limited to past stock exchange investments, past money donated, past inactivity for product category, and past account created. In yet another example, the plurality of past events includes but may not be limited to past products bought, past repeated products, past subscriptions, past subscription renewals, and past subscription skipped. In yet another example, the plurality of past events includes but may not be limited to past initiated transactions, past failed transactions, past content added to cart, and past completed transactions. In yet another example, the plurality of past events includes but may not be limited to past most visited category, past content details watched, past video on demand accessed, past video on demand initiated, and past video on demand searched. Further, the second set of data may be fetched from the one or more online platform database, the one or more communication device database, and the third party database.

In an embodiment of the present disclosure, the marketing campaign evaluation system 304 accesses the second set of data from the over-the-top media platform 102A through the communication network 302. In another embodiment of the present disclosure, the marketing campaign evaluation system 304 accesses the second set of data from the e-commerce platform 102B through the communication network 302. In yet another embodiment of the present disclosure, the marketing campaign evaluation system 304 accesses the second set of data from the fintech platform 102C through the communication network 302. In yet another embodiment of the present disclosure, the marketing campaign evaluation system 304 accesses the second set of data from the social media platform 102D through the communication network 302. In yet another embodiment of the present disclosure, the marketing campaign evaluation system 304 accesses the second set of data from the health platform 102E through the communication network 302. In yet another embodiment of the present disclosure, the marketing campaign evaluation system 304 accesses the second set of data from the education platform 102F through the communication network 302. In yet another embodiment of the present disclosure, the marketing campaign evaluation system 304 accesses the second set of data from the real-estate and housing platform 102G through the communication network 302. In yet another embodiment of the present disclosure, the marketing campaign evaluation system 304 accesses the second set of data from the travel platform 102H through the communication network 302.

In an embodiment of the present disclosure, the marketing campaign evaluation system 304 fetches the plurality of past events performed on the over-the-top media platform 102A through the communication network 302. In addition, the plurality of past events performed on the over-the-top media platform 102A includes past content watched, past content paused, and past content added to watch later, and the like. Further, the plurality of past events performed on the over-the-top media platform 102A includes past subscriptions, past subscription renewals, past subscription transaction failures, past content details viewed and the like. Furthermore, the plurality of past events performed on the over-the-top media platform 102A includes past contents added to favorites, past content skipped, past subscription skipped, past most visited category, and the like.

In an example, users U1 watched content C1 (let's say comic anime) on an OTT platform P1 in the past through a communication device D1 (let's say smartphones) using internet. In another example, users U2 paused content C2 (let's say horror movie) on an OTT platform P2 in the past through a communication device D2 (let's say desktop computers) using internet. In yet another example, users U3 added content C3 to a watch later list W1 on an OTT platform P3 in the past through a communication device D3 (let's say tablets) using internet. In yet another example, users U4 subscribed for accessing an OTT platform P4 in the past through a communication device D4 (let's say laptops) using internet. In yet another example, users U5 renewed subscription five times for accessing an OTT platform P5 in the past through a communication device D5 using internet. In yet another example, users U6 failed subscription transactions on an OTT platform P6 for accessing various contents in the past through a communication device D6 using internet. In yet another example, users U7 watched description of content C7 (let's say stand-up comedy show) on an OTT platform P7 in the past through a communication device D7 using internet. In yet another example, users U8 clicked notification N8 on an OTT platform P8 while accessing content C8 in the past through a communication device D8 using internet.

In an embodiment of the present disclosure, the marketing campaign evaluation system 304 fetches the plurality of past events performed on the e-commerce platform 102B through the communication network 302. In addition, the plurality of past events performed on the e-commerce platform 102B includes past products surfed, past products added to cart, past account created, past products bought, past repeated products and the like. Further, the plurality of past events performed on the e-commerce platform 102B includes past transactions initiated, past transactions completed, past transactions failed, past notification clicks and the like. Furthermore, the plurality of past events performed on the e-commerce platform 102B includes past reviews for products, past favorite product category, past inactivity for products, past inactivity for product category, and the like.

In an example, users U1 surfed a product T1 (let's say sport shoes) on an e-commerce platform P1 in the past through a communication device D1 (let's say smartphones) using internet. In another example, users U2 added a product T2 (let's say a smartphone) to a cart on an e-commerce platform P2 in the past through a communication device D2 (let's say desktop computers) using internet. In yet another example, users U3 created online account A3 to buy a product T3 (let's say a washing machine) on an e-commerce platform P3 in the past through a communication device D3 (let's say tablets) using internet. In yet another example, users U4 bought a product T4 (let's say a smartwatch) while accessing an e-commerce platform P4 in the past through a communication device D4 (let's say laptops) using internet. In yet another example, users U5 repeatedly bought a product T5 (let's say a formal trouser) on an e-commerce platform P5 in the past through a communication device D5 using internet. In yet another example, users U6 initiated payment transaction 16 for a product T6 (let's say a non-fiction book) on an e-commerce platform P6 in the past through a communication device D6 using internet. In yet another example, users U7 completed payment transaction C7 for a product T7 (let's say a Bluetooth speaker) on an e-commerce platform P7 in the past through a communication device D7 using internet. In yet another example, users U8 left payment transaction L8 for a product T8 (let's say a mattress) on an e-commerce platform P8 in the past through a communication device D8 using internet. In yet another example, users U9 reviewed a product T9 (let's say a play station) on an e-commerce platform P9 in the past through a communication device D9 using internet.

In an embodiment of the present disclosure, the marketing campaign evaluation system 304 fetches the plurality of past events performed on the fintech platform 102C through the communication network 302. In addition, the plurality of past events performed on the fintech platform 102C includes past accounts opened, past credit card requests, past credit cards issued, past loan requests, past net-banking requests and the like. Further, the plurality of past events performed on the fintech platform 102C includes past bill payments, past stock exchange investments, past money donated, past notifications clicked and the like. Furthermore, the plurality of past events performed on the fintech platform 102C includes past transaction initiated, past transaction failed, past transaction left, past transaction completed and the like.

In an example, users U1 opened an account A1 (let's say a saving account) on a fintech platform P1 in the past through a communication device D1 (let's say smartphones) using internet. In another example, users U2 requested for a credit card C2 on a fintech platform P2 in the past through a communication device D2 (let's say desktop computers) using internet. In yet another example, users U3 requested for loan L3 (let's say a home loan) on a fintech platform P3 in the past through a communication device D3 (let's say tablets) using internet. In yet another example, users U4 requested to start net-banking service on a fintech platform P4 in the past through a communication device D4 (let's say laptops) using internet. In yet another example, users U5 paid a bill B5 (let's say a broadband bill) through a fintech platform P5 in the past through a communication device D5 using internet. In yet another example, users U6 invested money in stock exchange S6 on a fintech platform P6 in the past through a communication device D6 using internet. In yet another example, users U7 donated money for social, disaster, environment and economical campaigns S7 (let's say a donation for Tsunami victims) on a fintech platform P7 in the past through a communication device D7 using internet. In yet another example, users U8 clicked a notification N8 on a fintech platform P8 in the past through a communication device D8 using internet. In yet another example, users U9 initiated transaction T9 (let's say $50) for credit card payments on a fintech platform P9 in the past through a communication device D9 using internet. In yet another example, users U10 completed transaction T10 (let's say $100) for a grocery store G10 on a fintech platform P10 in the past through a communication device D10 using internet.

In an embodiment of the present disclosure, the marketing campaign evaluation system 304 fetches the plurality of past events performed on the social media platform 102D through the communication network 302. In addition, the plurality of past events performed on the social media platform 102D includes past multimedia content surfed, past multimedia content watched, past account created, past texts exchanged, past business blogs and the like. Further, the plurality of past events performed on the social media platform 102D includes past paid promotions, past services activated, past live media streamed, past audio-video callings, and the like.

In an example, users U1 surfed a multimedia content M1 (let's say an animation cartoon) on a social media platform P1 in the past through a communication device D1 (let's say smartphones) using internet. In another example, users U2 watched a multimedia content M2 (let's say an action movie teaser) on a social media platform P2 in the past through a communication device D2 (let's say desktop computers) using internet. In yet another example, users U3 created an online account on a social media platform P3 in the past through a communication device D3 (let's say tablets) using internet. In yet another example, users U4 exchanged a text message T4 (let's say a promotional text message) on a social media platform P4 in the past through a communication device D4 (let's say laptops) using internet. In yet another example, users U5 wrote a business blog B5 (let's say a grooming product business blog) through a social media platform P5 in the past through a communication device D5 using internet. In yet another example, users U6 requested for a paid promotion (let's say a paid promotion for clothing page) on a social media platform P6 in the past through a communication device D6 using internet. In yet another example, users U7 streamed a live video L7 (let's say a live stream of a baseball match) on a social media platform P7 in the past through a communication device D7 using internet. In yet another example, users U8 clicked a notification N8 on a social media platform P8 in the past through a communication device D8 using internet.

In an embodiment of the present disclosure, the marketing campaign evaluation system 304 fetches the plurality of past events performed on the health platform 102E through the communication network 302. In addition, the plurality of past events performed on the health platform 102E includes past medicines searched, past medicines bought, past medical test kit bought, past medical tests scheduled, and the like. Further, the plurality of past events performed on the health platform 102E includes past transaction initiated, past transaction completed, past doctor consultation scheduled, past hospital visit planned, and the like. Furthermore, the plurality of past events performed on the health platform 102E includes past dietary plan requested, past personal trainer hired, past fitness center searched and the like.

In an example, users U1 searched a medicine M1 (let's say a diabetes medicine) on a health platform P1 in the past through a communication device D1 (let's say smartphones) using internet. In another example, users U2 bought a medicine M2 (let's say a blood pressure medicine) on a health platform P2 in the past through a communication device D2 (let's say desktop computers) using internet. In yet another example, users U3 bought a medical kit M3 (let's say a sugar level test kit) on a health platform P3 in the past through a communication device D3 (let's say tablets) using internet. In yet another example, users U4 scheduled a medical test T4 (let's say a pregnancy test) on a health platform P4 in the past through a communication device D4 (let's say laptops) using internet. In yet another example, users U5 initiated a transaction T5 (let's say $10) for buying a medicine M5 on a health platform P5 in the past through a communication device D5 using internet. In yet another example, users U6 completed a transaction T6 (let's say a $50) for medical kit M6 on a health platform P6 in the past through a communication device D6 using internet. In yet another example, users U7 scheduled a consultation with a doctor D7 (let's say a cardiologist) on a health platform P7 in the past through a communication device D7 using internet. In yet another example, users U8 requested a dietary plan M8 (let's a weight loss diet plan) on a health platform P8 in the past through a communication device D8 using internet. In yet another example, users U9 hired a personal trainer T9 (let's an aerobics instructor) on a health platform P9 in the past through a communication device D9 using internet.

In an embodiment of the present disclosure, the marketing campaign evaluation system 304 fetches the plurality of past events performed on the education platform 102F through the communication network 302. In addition, the plurality of past events performed on the education platform 102F includes past educational video searched, past educational video watched, past projects submitted, past account created, and the like. Further, the plurality of past events performed on the education platform 102F includes past transaction initiated, past transaction failures, past transaction completed, past notification clicked, and the like. Furthermore, the plurality of past events performed on the education platform 102F includes past mock tests subscribed, past educational counselling requested, past problem solving session requested, past international masters interests and the like.

In an example, users U1 searched an educational video E1 (let's say an educational video on trigonometry) on an education platform P1 in the past through a communication device D1 (let's say smartphones) using internet. In another example, users U2 watched an educational video E2 (let's say an educational video on Anatomy) on an education platform P2 in the past through a communication device D2 (let's say desktop computers) using internet. In yet another example, users U3 submitted an educational project E3 (let's say an educational solar project) on an education platform P3 in the past through a communication device D3 (let's say tablets) using internet. In yet another example, users U4 created an account A4 on an education platform P4 in the past through a communication device D4 (let's say laptops) using internet. In yet another example, users U5 initiated a transaction T5 (let's say $10) for buying a zoology book Z5 on an education platform P5 in the past through a communication device D5 using internet. In yet another example, users U6 completed a transaction T6 (let's say a $50) for a business communication skills lectures B6 on an education platform P6 in the past through a communication device D6 using internet. In yet another example, users U7 clicked a notification N7 on an education platform P7 in the past through a communication device D7 using internet. In yet another example, users U8 subscribed for a mock test M8 (let's a mock test for geography subject) on an education platform P8 in the past through a communication device D8 using internet. In yet another example, users U9 requested a problem solving session S9 (let's a problem solving session with an Integration expert) on an education platform P9 in the past through a communication device D9 using internet.

In an embodiment of the present disclosure, the marketing campaign evaluation system 304 fetches the plurality of past events performed on the real estate and housing platform 102G through the communication network 302. In addition, the plurality of past events performed on the real estate and housing platform 102G includes past properties searched, past properties watched, past properties bought, past rented properties searched, and the like. In addition, the plurality of past events performed on the real estate and housing platform 102G includes past account created, past maintenance services requested, past transaction initiated, past transaction completed and the like.

In an example, users U1 searched a property E1 (let's say an apartment in California) on a real estate and housing platform P1 in the past through a communication device D1 (let's say smartphones) using internet. In another example, users U2 watched a property E2 (let's say a home in Alaska) on a real estate and housing platform P2 in the past through a communication device D2 (let's say desktop computers) using internet. In yet another example, users U3 bought a property E3 (let's say a commercial property in New York) on a real estate and housing platform P3 in the past through a communication device D3 (let's say tablets) using internet. In yet another example, users U4 created an account A4 on a real estate and housing platform P4 in the past through a communication device D4 (let's say laptops) using internet. In yet another example, users U5 initiated a transaction T5 (let's say $15000) on a real estate and housing platform P5 in the past through a communication device D5 using internet. In yet another example, users U6 completed a transaction T6 (let's say a $5000) on a real estate and housing platform P6 in the past through a communication device D6 using internet. In yet another example, users U7 clicked a notification N7 (let's say a notification suggesting apartments in Chicago) on a real estate and housing platform P7 in the past through a communication device D7 using internet. In yet another example, users U8 requested a maintenance service M8 (let's maintenance of electronic elements) on a real estate and housing platform P8 in the past through a communication device D8 using internet.

In an embodiment of the present disclosure, the marketing campaign evaluation system 304 fetches the plurality of past events performed on the travel platform 102H through the communication network 302. In addition, the plurality of past events performed on the travel platform 102H includes past hotel searched, past hotels added to watch-list, past hotel bookings, past account created, past holiday plans searched, and the like. Further, the plurality of past events performed on the travel platform 102H includes past holiday plans booked, past transaction initiated, past transaction completed, past restaurant pre-booked, and the like.

In an example, users U1 searched a hotel H1 (let's say a hotel in San Francisco) on a travel P1 in the past through a communication device D1 (let's say smartphones) using internet. In another example, users U2 added a hotel H2 (let's say a hotel in Seattle) to a watch-list W2 on a travel platform P2 in the past through a communication device D2 (let's say desktop computers) using internet. In yet another example, users U3 booked a hotel H3 (let's say a hotel in San Jose) on a travel platform P3 in the past through a communication device D3 using internet. In yet another example, users U4 created an account A4 on a travel platform P4 in the past through a communication device D4 using internet. In yet another example, users U5 searched a holiday plan H5 (let's say a holiday plan to Maldives for 5 days 4 nights) on a travel platform P5 in the past through a communication device D5 (let's say tablets) using internet. In yet another example, users U6 booked a holiday plan H6 (let's say a holiday plan to Cairo for 4 days 5 nights) on a travel platform P6 in the past through a communication device D6 using internet. In yet another example, users U7 initiated a transaction T7 (let's say $150) on a travel platform P7 in the past through a communication device D7 using internet. In yet another example, users U8 completed a transaction T8 (let's say a $500) on a travel platform P8 in the past through a communication device D8 (let's say laptops) using internet. In yet another example, users U9 clicked a notification N9 (let's say a notification suggesting Holiday plans for Switzerland) on a travel platform P9 in the past through a communication device D9 using internet. In yet another example, users U10 pre-booked a restaurant R10 (let's an Indian restaurant in Dallas) on a travel platform P10 in the past through a communication device D10 using internet.

The marketing campaign evaluation system 304 obtains a third set of data associated with a plurality of live events of the plurality of users 202 on the one or more online platforms 102 through the one or more communication devices 204. The third set of data corresponds the plurality of live events of the plurality of users 202 on the granular level. In an example, the plurality of live events includes but may not be limited to real-time uniform resource locater visits, real-time number of webpage visits, and real-time number of webpages accessed. In another example, the plurality of live events includes but may not be limited to real-time application installed, real-time application launch, and real-time application uninstalled. In yet another example, the plurality of live events includes but may not be limited to real-time webpage visit, real-time accessed content, real-time started content, real-time paused content, and real-time resumed content. In yet another example, the plurality of live events includes but may not be limited to real-time searched content, real-time notification clicks, real-time notification views, real-time products surfed, and real-time products added to cart. In yet another example, the plurality of live events includes but may not be limited to real-time reviews for products, real-time favorite product category, real-time inactivity for products, and real-time accounts opened. In yet another example, the plurality of live events includes but may not be limited to real-time credit card requests, real-time credit cards issued, real-time loan requests, and real-time net-banking requests. In yet another example, the plurality of live events includes but may not be limited to real-time multimedia content surfed, real-time multimedia content watched, real-time texts exchanged, and real-time business blogs. In yet another example, the plurality of live events includes but may not be limited to real-time live media streamed, real-time audio-video callings, real-time medicines searched, and real-time medicines bought. In yet another example, the plurality of live events includes but may not be limited to real-time medical test kit bought, real-time medical tests scheduled, real-time bill payments, and real-time doctor consultation scheduled. In yet another example, the plurality of live events includes but may not be limited to real-time hospital visit planned, real-time dietary plan requested, real-time personal trainer hired, and real-time fitness center searched. In yet another example, the plurality of live events includes but may not be limited to real-time educational video searched, real-time educational video watched, and real-time projects submitted. In yet another example, the plurality of live events includes but may not be limited to real-time mock tests subscribed, real-time educational counselling requested, and real-time problem solving session requested. In yet another example, the plurality of live events includes but may not be limited to real-time international masters interests, real-time properties searched, real-time properties watched, and real-time properties bought. In yet another example, the plurality of live events includes but may not be limited to real-time rented properties searched, real-time maintenance services requested, and real-time hotel searched. In yet another example, the plurality of live events includes but may not be limited to real-time hotels added to watch-list, real-time hotel bookings, real-time holiday plans searched, and real-time holiday plans booked. In yet another example, the plurality of live events includes but may not be limited to real-time stock exchange investments, real-time money donated, real-time inactivity for product category, and real-time account created. In yet another example, the plurality of live events includes but may not be limited to real-time products bought, real-time repeated products, real-time subscriptions, and real-time subscription renewals. In yet another example, the plurality of live events includes but may not be limited to real-time subscription skipped, real-time initiated transactions, real-time failed transactions, and real-time content added to cart. In yet another example, the plurality of live events includes but may not be limited to real-time completed transactions, real-time most visited category, real-time content details watched, and real-time video on demand accessed. In yet another example, the plurality of live events includes but may not be limited to real-time video on demand initiated, and real-time video on demand searched.

In an embodiment of the present disclosure, the marketing campaign evaluation system 304 accesses the third set of data from the over-the-top media platform 102A through the communication network 302. In another embodiment of the present disclosure, the marketing campaign evaluation system 304 accesses the third set of data from the e-commerce platform 102B through the communication network 302. In yet another embodiment of the present disclosure, the marketing campaign evaluation system 304 accesses the third set of data from the fintech platform 102C through the communication network 302. In yet another embodiment of the present disclosure, the marketing campaign evaluation system 304 accesses the third set of data from the social media platform 102D through the communication network 302. In yet another embodiment of the present disclosure, the marketing campaign evaluation system 304 accesses the third set of data from the health platform 102E through the communication network 302. In yet another embodiment of the present disclosure, the marketing campaign evaluation system 304 accesses the third set of data from the education platform 102F through the communication network 302. In yet another embodiment of the present disclosure, the marketing campaign evaluation system 304 accesses the third set of data from the real-estate and housing platform 102G through the communication network 302. In yet another embodiment of the present disclosure, the marketing campaign evaluation system 304 accesses the third set of data from the travel platform 102H through the communication network 302.

In an embodiment of the present disclosure, the marketing campaign evaluation system 304 obtains the plurality of live events performed on the over-the-top media platform 102A through the communication network 302. In addition, the plurality of live events performed on the over-the-top media platform 102A includes content watched in real-time, content paused in real-time, and content added to watch later in real-time. Further, the plurality of live events performed on the over-the-top media platform 102A includes subscriptions in real-time, subscription renewals in real-time, subscription transaction failures in real-time, content details viewed in real-time and the like. Furthermore, the plurality of live events performed on the over-the-top media platform 102A includes contents added to favorites in real-time, content skipped in real-time, subscription skipped in real-time, most visited category in real-time, and the like.

In an example, users U1 watch content C1 (let's say comic anime) on an OTT platform P1 in real-time through a communication device D1 (let's say smartphones) using internet. In another example, users U2 pause content C2 (let's say horror movie) on an OTT platform P2 in the real-time through a communication device D2 using internet. In yet another example, users U3 add content C3 (let's say a documentary) to a watch later list W1 on an OTT platform P3 in the real-time through a communication device D3 (let's say desktop computers) using internet. In yet another example, users U4 subscribe for accessing an OTT platform P4 in the real-time through a communication device D4 using internet. In yet another example, users U5 renew subscription for accessing an OTT platform P5 in the real-time through a communication device D5 (let's say tablets) using internet. In yet another example, users U6 fail subscription transactions on an OTT platform P6 for accessing various contents in the real-time through a communication device D6 using internet. In yet another example, users U7 watch description of content C7 (let's say stand-up comedy show) on an OTT platform P7 in the real-time through a communication device D7 (let's say laptops) using internet. In yet another example, users U8 click notification N8 on an OTT platform P8 while accessing content C8 in the real-time through a communication device D8 using internet.

In an embodiment of the present disclosure, the marketing campaign evaluation system 304 obtains the plurality of live events performed on the e-commerce platform 102B through the communication network 302. In addition, the plurality of live events performed on the e-commerce platform 102B includes products surfed in real-time, products added to cart in real-time, account created in real-time, products bought in real-time, repeated products in real-time and the like. Further, the plurality of live events performed on the e-commerce platform 102B includes transactions initiated in real-time, transactions completed in real-time, transactions failed in real-time, notification clicks in real-time and the like. Furthermore, the plurality of live events performed on the e-commerce platform 102B includes reviews for products in real-time, product category visits in real-time, inactivity for products in real-time, inactivity for product category in real-time, and the like.

In an example, users U1 surf a product T1 (let's say sport shoes) on an e-commerce platform P1 in real-time through a communication device D1 (let's say smartphones) using internet. In another example, users U2 add a product T2 (let's say a smartphone) to a cart on an e-commerce platform P2 in the real-time through a communication device D2 using internet. In yet another example, users U3 create online account A3 to buy a product T3 (let's say a washing machine) on an e-commerce platform P3 in the past through a communication device D3 (let's say desktop computers) using internet. In yet another example, users U4 buy a product T4 (let's say a smartwatch) while accessing an e-commerce platform P4 in the real-time through a communication device D4 using internet. In yet another example, users U5 repeatedly buy a product T5 (let's say a formal trouser) on an e-commerce platform P5 in the real-time through a communication device D5 (let's say tablets) using internet. In yet another example, users U6 initiate payment transaction 16 for a product T6 (let's say a non-fiction book) on an e-commerce platform P6 in the real-time through a communication device D6 using internet. In yet another example, users U7 completes payment transaction C7 for a product T7 (let's say a Bluetooth speaker) on an e-commerce platform P7 in the real-time through a communication device D7 (let's say laptops) using internet. In yet another example, users U8 leave payment transaction L8 for a product T8 (let's say a mattress) on an e-commerce platform P8 in the real-time through a communication device D8 using internet. In yet another example, users U9 review a product T9 (let's say a play station) on an e-commerce platform P9 in the real-time through a communication device D9 using internet.

In an embodiment of the present disclosure, the marketing campaign evaluation system 304 obtains the plurality of live events performed on the fintech platform 102C through the communication network 302. In addition, the plurality of live events performed on the fintech platform 102C includes accounts opened in real-time, credit card requests in real-time, credit cards issued in real-time, loan requests in real-time, net-banking requests in real-time and the like. Further, the plurality of live events performed on the fintech platform 102C includes bill payments in real-time, stock exchange investments in real-time, money donated in real-time, notifications clicked in real-time, and the like. Furthermore, the plurality of live events performed on the fintech platform 102C includes transaction initiated in real-time, transaction failed in real-time, transaction left in real-time, transaction completed in real-time, and the like.

In an example, users U1 open an account A1 (let's say a saving account) on a fintech platform P1 in the real-time through a communication device D1 (let's say smartphones) using internet. In another example, users U2 request for a credit card C2 on a fintech platform P2 in the real-time through a communication device D2 using internet. In yet another example, users U3 request for loan L3 (let's say a home loan) on a fintech platform P3 in the real-time through a communication device D3 (let's desktop computers) using internet. In yet another example, users U4 request to start net-banking service on a fintech platform P4 in the real-time through a communication device D4 using internet. In yet another example, users U5 pay a bill B5 (let's say a broadband bill) through a fintech platform P5 in the real-time through a communication device D5 (let's say tablets) using internet. In yet another example, users U6 invest money in stock exchange S6 on a fintech platform P6 in the real-time through a communication device D6 using internet. In yet another example, users U7 donate money for social, disaster, environment and economical campaigns S7 (let's say a donation for Tsunami victims) on a fintech platform P7 in the real-time through a communication device D7 (let's say laptops) using internet. In yet another example, users U8 click a notification N8 on a fintech platform P8 in the real-time through a communication device D8 using internet. In yet another example, users U9 initiate transaction T9 (let's say $50) for credit card payments on a fintech platform P9 in the real-time through a communication device D9 using internet. In yet another example, users U10 complete transaction T10 (let's say $100) fora grocery store G10 on a fintech platform P10 in the real-time through a communication device D10 using internet.

In an embodiment of the present disclosure, the marketing campaign evaluation system 304 obtains the plurality of live events performed on the social media platform 102D through the communication network 302. In addition, the plurality of live events performed on the social media platform 102D includes multimedia content surfed in real-time, multimedia content watched in real-time, and account created in real-time. Further, the plurality of live events performed on the social media platform 102D includes texts exchanged in real-time, business blogs accessed in real-time, paid promotions in real-time, and the like. Furthermore, the plurality of live events performed on the social media platform 102D includes services activated in real-time, live media streamed in real-time, audio-video callings in real-time, and the like.

In an example, users U1 surf a multimedia content M1 (let's say an animation cartoon) on a social media platform P1 in the real-time through a communication device D1 (let's say smartphones) using internet. In another example, users U2 watch a multimedia content M2 (let's say an action movie teaser) on a social media platform P2 in the real-time through a communication device D2 using internet. In yet another example, users U3 create an online account on a social media platform P3 in the real-time through a communication device D3 (let's say laptops) using internet. In yet another example, users U4 exchange a text message T4 (let's say a promotional text message) on a social media platform P4 in the real-time through a communication device D4 using internet. In yet another example, users U5 write a business blog B5 (let's say a grooming product business blog) through a social media platform P5 in the real-time through a communication device D5 (let's say desktop computers) using internet. In yet another example, users U6 request for a paid promotion (let's say a paid promotion for clothing page) on a social media platform P6 in the real-time through a communication device D6 using internet. In yet another example, users U7 stream a live video L7 (let's say a live stream of a baseball match) on a social media platform P7 in the real-time through a communication device D7 (let's say tablets) using internet. In yet another example, users U8 click a notification N8 on a social media platform P8 in the real-time through a communication device D8 using internet.

In an embodiment of the present disclosure, the marketing campaign evaluation system 304 obtains the plurality of live events performed on the health platform 102E through the communication network 302. In addition, the plurality of live events performed on the health platform 102E includes medicines searched in real-time, medicines bought in real-time, medical test kit bought in real-time, and the like. Further, the plurality of live events performed on the health platform 102E includes medical tests scheduled in real-time, transaction initiated in real-time, transaction completed in real-time, and the like. Furthermore, the plurality of live events performed on the health platform 102E includes doctor consultation scheduled in real-time, hospital visit planned in real-time, and the like. Moreover, the plurality of live events performed on the health platform 102E includes dietary plan requested in real-time, personal trainer hired in real-time, fitness center searched in real-time and the like.

In an example, users U1 search a medicine M1 (let's say a diabetes medicine) on a health platform P1 in the real-time through a communication device D1 (let's say desktop computers) using internet. In another example, users U2 buy a medicine M2 (let's say a blood pressure medicine) on a health platform P2 in the real-time through a communication device D2 using internet. In yet another example, users U3 buy a medical kit M3 (let's say a sugar level test kit) on a health platform P3 in the real-time through a communication device D3 (let's say smartphones) using internet. In yet another example, users U4 schedule a medical test T4 (let's say a pregnancy test) on a health platform P4 in the real-time through a communication device D4 using internet. In yet another example, users U5 initiate a transaction T5 (let's say $10) for buying a medicine M5 on a health platform P5 in the real-time through a communication device D5 (let's say tablets) using internet. In yet another example, users U6 complete a transaction T6 (let's say a $50) for medical kit M6 on a health platform P6 in the real-time through a communication device D6 using internet. In yet another example, users U7 schedule a consultation with a doctor D7 (let's say a cardiologist) on a health platform P7 in the real-time through a communication device D7 using internet. In yet another example, users U8 request a dietary plan M8 (let's a weight loss diet plan) on a health platform P8 in the real-time through a communication device D8 (let's say laptops) using internet. In yet another example, users U9 hire a personal trainer T9 (let's an aerobics instructor) on a health platform P9 in the real-time through a communication device D9 using internet.

In an embodiment of the present disclosure, the marketing campaign evaluation system 304 obtains the plurality of live events performed on the education platform 102F through the communication network 302. In addition, the plurality of live events performed on the education platform 102F includes educational video searched in real-time, educational video watched in real-time, projects submitted in real-time, and the like. Further, the plurality of live events performed on the education platform 102F includes account created in real-time, and the like. Furthermore, the plurality of live events performed on the education platform 102F includes transaction initiated in real-time, transaction failures in real-time, transaction completed in real-time, and the like. Moreover, the plurality of live events performed on the education platform 102F includes notification clicked in real-time, mock tests subscribed in real-time, educational counselling requested in real-time, and the like. Also, the plurality of live events performed on the education platform 102F includes problem solving session requested in real-time, international masters searched in real-time, and the like.

In an example, users U1 search an educational video E1 (let's say an educational video on trigonometry) on an education platform P1 in the real-time through a communication device D1 (let's say laptops) using internet. In another example, users U2 watch an educational video E2 (let's say an educational video on Anatomy) on an education platform P2 in the real-time through a communication device D2 (let's say tablets) using internet. In yet another example, users U3 submit an educational project E3 (let's say an educational solar project) on an education platform P3 in the real-time through a communication device D3 using internet. In yet another example, users U4 create an account A4 on an education platform P4 in the real-time through a communication device D4 using internet. In yet another example, users U5 initiate a transaction T5 (let's say $10) for buying a zoology book Z5 on an education platform P5 in the real-time through a communication device D5 (let's say desktop computers) using internet. In yet another example, users U6 complete a transaction T6 (let's say a $50) for a business communication skills lectures B6 on an education platform P6 in the real-time through a communication device D6 using internet. In yet another example, users U7 click a notification N7 on an education platform P7 in the real-time through a communication device D7 using internet. In yet another example, users U8 subscribe for a mock test M8 (let's a mock test for geography subject) on an education platform P8 in the real-time through a communication device D8 (let's say smartphones) using internet. In yet another example, users U9 request a problem solving session S9 (let's a problem solving session with an Integration expert) on an education platform P9 in the real-time through a communication device D9 using internet.

In an embodiment of the present disclosure, the marketing campaign evaluation system 304 obtains the plurality of live events performed on the real estate and housing platform 102G through the communication network 302. In addition, the plurality of live events performed on the real estate and housing platform 102G includes properties searched in real-time, properties watched in real-time, properties bought in real-time, and the like. Further, the plurality of live events performed on the real estate and housing platform 102G includes rented properties in real-time, maintenance services requested in real-time, and the like. Furthermore, the plurality of live events performed on the real estate and housing platform 102G includes transaction initiated in real-time, account created in real-time, transaction completed in real-time, and the like.

In an example, users U1 search a property E1 (let's say an apartment in California) on a real estate and housing platform P1 in the real-time through a communication device D1 (let's say tablets) using internet. In another example, users U2 watch a property E2 (let's say a home in Alaska) on a real estate and housing platform P2 in the real-time through a communication device D2 using internet. In yet another example, users U3 buy a property E3 (let's say a commercial property in New York) on a real estate and housing platform P3 in the real-time through a communication device D3 (let's say desktop computers) using internet. In yet another example, users U4 create an account A4 on a real estate and housing platform P4 in the real-time through a communication device D4 using internet. In yet another example, users U5 initiate a transaction T5 (let's say $15000) on a real estate and housing platform P5 in the real-time through a communication device D5 using internet. In yet another example, users U6 complete a transaction T6 (let's say a $5000) on a real estate and housing platform P6 in the real-time through a communication device D6 (let's say laptops) using internet. In yet another example, users U7 click a notification N7 (let's say a notification suggesting apartments in Chicago) on a real estate and housing platform P7 in the real-time through a communication device D7 using internet. In yet another example, users U8 request a maintenance service M8 (let's maintenance of electronic elements) on a real estate and housing platform P8 in the real-time through a communication device D8 (let's say smartphones) using internet.

In an embodiment of the present disclosure, the marketing campaign evaluation system 304 obtains the plurality of live events performed on the travel platform 102H through the communication network 302. In addition, the plurality of live events performed on the travel platform 102H includes hotel searched in real-time, hotels added to watch-list in real-time, hotel bookings in real-time, and the like. Further, the plurality of live events performed on the travel platform 102H includes account created in real-time, holiday plans searched in real-time, holiday plans booked in real-time, and the like. Furthermore, the plurality of live events performed on the travel platform 102H includes transaction initiated in real-time, transaction completed in real-time, restaurant pre-booked in real-time, and the like.

In an example, users U1 search a hotel H1 (let's say a hotel in San Francisco) on a travel P1 in the real-time through a communication device D1 (let's say smartphones) using internet. In another example, users U2 add a hotel H2 (let's say a hotel in Seattle) to a watch-list W2 on a travel platform P2 in the real-time through a communication device D2 (let's say tablets) using internet. In yet another example, users U3 book a hotel H3 (let's say a hotel in San Jose) on a travel platform P3 in the real-time through a communication device D3 using internet. In yet another example, users U4 create an account A4 on a travel platform P4 in the real-time through a communication device D4 using internet. In yet another example, users U5 search a holiday plan H5 (let's say a holiday plan to Maldives for 5 days 4 nights) on a travel platform P5 in the real-time through a communication device D5 using internet. In yet another example, users U6 book a holiday plan H6 (let's say a holiday plan to Cairo for 4 days 5 nights) on a travel platform P6 in the real-time through a communication device D6 (let's say desktop computers) using Internet. In yet another example, users U7 initiate a transaction T7 (let's say $150) on a travel platform P7 in the real-time through a communication device D7 using Internet. In yet another example, users U8 complete a transaction T8 (let's say a $500) on a travel platform P8 in the real-time through a communication device D8 (let's say laptops) using Internet. In yet another example, users U9 click a notification N9 (let's say a notification suggesting Holiday plans for Switzerland) on a travel platform P9 in the real-time through a communication device D9 using Internet. In yet another example, users U10 pre-book a restaurant R10 (let's an Indian restaurant in Dallas) on a travel platform P10 in the real-time through a communication device D10 using Internet.

The marketing campaign evaluation system 304 analyzes the first set of data, the second set of data and the third set of data using one or more machine learning algorithms. In an embodiment of the present disclosure, the one or more machine learning algorithms include a decision tree algorithm and a random forest algorithm. In another embodiment of the present disclosure, the one or more machine learning algorithms include but may not be limited to prediction algorithms, deep learning algorithms, natural language processing algorithm and the like. However, the one or more machine learning algorithms are not limited to the above-mentioned algorithms. The analysis of the first set of data, the second set of data, and the third set of data based on the one or more machine learning algorithms is done in real-time. In addition, the marketing campaign evaluation system 304 creates a machine learning model to perform analysis of the first set of data, the second set of data, and the third set of data. The machine learning model is trained to identify one or more patterns from the first set of data, the second set of data, and the third set of data for one or more categories. The one or more categories are pre-defined by the administrator 308. The one or more categories include a past behavior category and a live behavior category. The past behavior category allows the segmentation of the plurality of users 202 based on the plurality of past events. The live behavior category allows the segmentation of the plurality of users 202 based on the plurality of live events. Further, the one or more patterns include uniform resource locater visit pattern, webpage visit pattern, number of webpage accessed pattern, accessed content pattern, started content pattern, paused content pattern, and the like. Furthermore, the one or more patterns include application installation pattern, application launch pattern, application uninstallation pattern, and the like. Moreover, the one or more patterns include resumed content pattern, searched content pattern, notification click pattern, notification views pattern, products surfed pattern, products added to cart pattern, and the like. Also, the one or more patterns include reviews for products pattern, favorite product category pattern, inactivity for products pattern, accounts opened pattern, credit card requests pattern, and the like. Also, the one or more patterns include credit cards issued pattern, loan request patterns, net-banking requests pattern, multimedia content surfed pattern, multimedia content watched pattern, and the like. Also, the one or more patterns include texts exchanged pattern, business blogs pattern, live media streamed pattern, audio-video calling pattern, medicines searched pattern, medicines bought pattern, and the like. Also, the one or more patterns include medical test kit bought pattern, medical tests scheduled pattern, bill payments pattern, doctor consultation scheduled pattern, hospital visit pattern, and the like. Also, the one or more patterns include dietary plan request pattern, personal trainer hired pattern, fitness center search pattern, educational video search pattern, educational video watched pattern, and the like. Also, the one or more patterns include projects submission pattern, mock tests subscription pattern, educational counselling request pattern, problem solving session request pattern, and the like. Also, the one or more patterns include international masters interests pattern, properties search pattern, properties watched pattern, properties bought pattern, rented properties search pattern, and the like. Also, the one or more patterns include maintenance services request pattern, hotel search pattern, hotels added to watch-list pattern, hotel bookings pattern, holiday plans search pattern, and the like. Also, the one or more patterns include holiday plans booked pattern, stock exchange investments pattern, money donated pattern, inactivity for product category pattern, account creation pattern, and the like. Also, the one or more patterns include products bought pattern, repeated products pattern, subscriptions pattern, subscription renewals pattern, subscription skipped pattern, initiated transactions pattern, and the like. Also, the one or more patterns include failed transactions pattern, content added to cart pattern, completed transactions pattern, most visited category pattern, content details watched pattern, and the like. Also, the one or more patterns include video on demand accessed pattern, video on demand initiated pattern, video on demand searched pattern, and the like.

The machine learning model is trained to analyze the first set of data, the second set of data, and the third set of data. Furthermore, the machine learning model is trained to identify the match of the one or more patterns of each of the plurality of users 202. In an embodiment of the present disclosure, the machine learning model is trained using supervised machine learning model. In another embodiment of the present disclosure, the machine learning model is trained using un-supervised machine learning model. Moreover, the machine learning model predicts behavior of each of the plurality of users 202 based on the one or more patterns, the second set of data and the third set of data. Also, the behavior of the plurality of users 202 is predicted in real-time.

In addition, the marketing campaign evaluation system 304 estimates a customer value of each of the plurality of users 202. The customer value is calculated at a user level or at a segment level. In an embodiment of the present disclosure, the customer value is used for identifying a right segment of the plurality of users 202 to treat differentially to maximize their revenue. In another embodiment of the present disclosure, the customer value is used for designing an appropriate advertisement for the one or more marketing campaigns. The right segment of the plurality of users 202 is provided with differential treatment. In an example, the plurality of users 202 is specially routed to suitable marketing campaign and frequently provided with promotional offers or discounts. In another example, if the user U1 has a high customer value (let's say 9 on the scale of 10), then the system displays pop-up notification offering promotional discounts to the user U1 for a product (let's say a play station) that the user U1 is currently viewing on the e-commerce platform P1. In yet another example, a user U2 is offered assistance through voice channel to enable the user U2 to make a purchase (let's say an entrance test study material) on an education platform P2 through a communication device D2 (let's say a smartphone).

In addition, the marketing campaign evaluation system 304 includes a RFM module 304a for estimating the customer value. The RFM module 304a estimates the customer value of the plurality of users 202 based on Recency-Frequency-Monetary value matrix. In an example, the RFM module 304a analyzes the customer value based on how recently a user U1 interacted with an OTT platform O1 through a communication device D1 (let's say a smartphone) using a recency value matrix model R1. In another example, the RFM module 304a analyzes the customer value based on how recently a user U2 interacted with an e-commerce platform E2 through a communication device D2 (let's say a laptop) using a recency value matrix model R2. In yet another example, the RFM module 304a analyzes the customer value based on how recently a user U3 interacted with a fintech platform F3 through a communication device D3 (let's say a desktop computer) using a recency value matrix model R3. In yet another example, the RFM module 304a analyzes the customer value based on how recently a user U4 interacted with a social media platform S4 through a communication device D4 (let's say a tablet) using a recency value matrix model R4. In yet another example, the RFM module 304a analyzes the customer value based on how recently a user U5 interacted with a health platform H5 through a communication device D5 (let's say a smartphone) using a recency value matrix model R5. In yet another example, the RFM module 304a analyzes the customer value based on how recently a user U6 interacted with an education platform E6 through a communication device D6 (let's say a laptop) using a recency value matrix model R6. In yet another example, the RFM module 304a analyzes the customer value based on how recently a user U7 interacted with a real estate and housing platform P7 through a communication device D7 (let's say a desktop computer) using a recency value matrix model R7. In yet another example, the RFM module 304a analyzes the customer value based on how recently a user U8 interacted with a travel platform T8 through a communication device D8 (let's say a tablet) using a recency value matrix model R8.

In an example, the RFM module 304a analyzes the customer value based on how frequently a user U1 interacted with an OTT platform O1 through a communication device D1 (let's say a smartphone) using a frequency value matrix model F1. In another example, the RFM module 304a analyzes the customer value based on how frequently a user U2 interacted with an e-commerce platform E2 through a communication device D2 (let's say a laptop) using a frequency value matrix model F2. In yet another example, the RFM module 304a analyzes the customer value based on how frequently a user U3 interacted with a fintech platform F3 through a communication device D3 (let's say a desktop computer) using a frequency value matrix model F3. In yet another example, the RFM module 304a analyzes the customer value based on how frequently a user U4 interacted with a social media platform S4 through a communication device D4 (let's say a tablet) using a frequency value matrix model F4. In yet another example, the RFM module 304a analyzes the customer value based on how frequently a user U5 interacted with a health platform H5 through a communication device D5 (let's say a smartphone) using a frequency value matrix model F5. In yet another example, the RFM module 304a analyzes the customer value based on how frequently a user U6 interacted with an education platform E6 through a communication device D6 (let's say a laptop) using a frequency value matrix model F6. In yet another example, the RFM module 304a analyzes the customer value based on how frequently a user U7 interacted with a real estate and housing platform R7 through a communication device D7 (let's say a desktop computer) using a frequency value matrix model F7. In yet another example, the RFM module 304a analyzes the customer value based on how frequently a user U8 interacted with a travel platform T8 through a communication device D8 (let's say a tablet) using a frequency value matrix model F8.

In an example, the RFM module 304a analyzes the customer value based on transaction performed by a user U1 interacting with an OTT platform O1 through a communication device D1 (let's say a smartphone) using a monetary value matrix model M1. In another example, the RFM module 304a analyzes the customer value based on transaction performed by a user U2 interacting with an e-commerce platform E2 through a communication device D2 (let's say a laptop) using a monetary value matrix model M2. In yet another example, the RFM module 304a analyzes the customer value based on transaction performed by a user U3 interacting with a fintech platform F3 through a communication device D3 (let's say a desktop computer) using a monetary value matrix model M3. In yet another example, the RFM module 304a analyzes the customer value based on transaction performed by a user U4 interacting with a social media platform S4 through a communication device D4 (let's say a tablet) using a monetary value matrix model M4. In yet another example, the RFM module 304a analyzes the customer value based on transaction performed by a user U5 interacting with a health platform H5 through a communication device D5 (let's say a smartphone) using a monetary value matrix model M5. In yet another example, the RFM module 310a analyzes the customer value based on transaction performed by a user U6 interacting with an education platform E6 through a communication device D6 (let's say a laptop) using a monetary value matrix model M6. In yet another example, the RFM module 304a analyzes the customer value based on transaction performed by a user U7 interacting with a real estate and housing platform R7 through a communication device D7 (let's say a desktop computer) using a monetary value matrix model M7. In yet another example, the RFM module 304a analyzes the customer value based on transaction performed by a user U8 interacting with a travel platform T8 through a communication device D8 (let's say a tablet) using a monetary value matrix model M8.

The marketing campaign evaluation system 304 creates the one or more segments of the plurality of users 202 based on the customer value using the analysis of the RFM module 310a on the granular level. In addition, the one or more segments of the plurality of users 202 are created for the plurality of live activities and the plurality of past activities using the RFM module 310a. Further, the one or more segments are created using a plurality of RFM filters. In addition, the plurality of RFM filters includes recency based filters, frequency based filters, and monetary based filters, time based filters, days based filters, age based filters, location based filters, and events based filters. Further, the plurality of RFM filters includes inactivity based filters, user properties filters, categories based filters, demographic filters, geographic filters, technographic filters, and application field filters. However, the plurality of RFM filters is not limited to the above-mentioned filters. Furthermore, the plurality of RFM filters is based on one or more parameters. The one or more parameters include day, time, language, location, events, inactivity, recency, frequency, monetary, and online platform. In an embodiment of the present disclosure, the one or more segments of the plurality of users 202 are created based on at least one RFM filter of the plurality of RFM filters. The one or more segments are created in real-time. The one or more segments are created for the one or more categories using the plurality of RFM filters. In an embodiment of the present disclosure, the one or more categories include the past behavior category and the live behavior category. However, the one or more online categories are not limited to the above-mentioned categories. In addition, the past behavior category corresponds a category where behavior and interests of the plurality of users 202 are considered to create the one or more segments. The past behavior category includes a plurality of first sub-categories. The plurality of first sub-categories includes a past action sub-category, a past inaction sub-category, a past action with properties sub-category, and the like. Further, the past action sub-category includes the plurality of past events, and the one or more parameters. The one or more parameters include day, time, language, location, events, inactivity, and online platform. Furthermore, the past inaction sub-category includes a plurality of past inactions, and the one or more parameters. The plurality of past inactions corresponds to the plurality of past actions not performed by the plurality of users 202. Moreover, the past action with properties sub-category includes a plurality of properties and the one or more parameters. The plurality of properties includes user properties, demographic properties, geographic properties, technographic properties, reachability, application fields, and the like. The user properties include activation date, birthday, e-mail identity, customer type, preferred language, preferred genre, postal code, and the like. The demographic properties include age, gender and the like. The geographic properties include continents, countries, states, cities, villages and the like. The technographic properties include the plurality of browsers, the one or more communication devices 204, the operating system, and the like. The reachability includes device token, e-mail identity, contact number, and the like.

In addition, the live behavior category corresponds a category where behavior and interests displayed by the plurality of users 202 in real-time to create the one or more segments. The live behavior category includes a plurality of second sub-categories. The plurality of second sub-categories includes a real-time action sub-category, a real-time inaction sub-category, a real-time page visit sub-category, a real-time page count sub-category, and the like. Further, the real-time action sub-category includes the plurality of live events, and the one or more parameters. Furthermore, the real-time inaction sub-category includes a plurality of live inactions, and the one or more parameters. The plurality of live inactions corresponds to the plurality of live events not performed by the plurality of users 202 within a certain time.

In an embodiment of the present disclosure, the one or more segments of the plurality of users 202 are created based on the frequency based filters. In another embodiment of the present disclosure, the one or more segments of the plurality of users 202 are created based on the recency based filters. In yet another embodiment of the present disclosure, the one or more segments of the plurality of users 202 are created based on the monetary based filters. In yet another embodiment of the present disclosure, the one or more segments of the plurality of users 202 are created based on combination of the recency based filters and the frequency based filters. In yet another embodiment of the present disclosure, the one or more segments of the plurality of users 202 are created based on combination of the recency based filters and the monetary based filters. In yet another embodiment of the present disclosure, the one or more segments of the plurality of users 202 are created based on combination of the frequency based filters and the monetary based filters. In yet another embodiment of the present disclosure, the one or more segments of the plurality of users 202 are created based on combination of the recency based filters, the frequency based filters, and the monetary based filters.

In an example, a segment S1 is created for users U1 performing actions A1 (let's say notification click) on an online platform P1 (let's say social media platform) on communication devices D1 (let's say laptop) using a filter F1 (let's say frequency filter). In another example, a segment S2 is created for users U2 performing actions A2 (let's say webpage launched) on an online platform P2 (let's say over-the-top platform) on communication devices D2 (let's say smartphone) using a filter F2 (let's say recency filter). In yet another example, a segment S3 is created for users U3 performing actions A3 (let's say wrist watch added to watchlist) on an online platform P3 (let's say e-commerce platform) on communication devices D3 (let's say desktop) using two filters F3 (let's say frequency filter and recency filter). In yet another example, a segment S4 is created for users U4 performing actions A4 (let's say paused a genetics lecture and inaction) on an online platform P4 (let's say education platform) on communication devices D4 (let's say tablet) using a filter F4 (let's say recency filter). In yet another example, a segment S5 is created for users U5 performing actions A5 (let's say transaction initiated) on an online platform P5 (let's say fintech platform) on communication devices D5 (let's say laptop) using a filter F5 (let's say monetary filter).

The marketing campaign evaluation system 304 generates a RFM grid for the one or more segments of the plurality of users 202. In addition, the marketing campaign evaluation system 304 presents the results of the RFM analysis for the plurality of users 202 in the RFM grid highlighting the number of users in each segment of the one or more segments. Further, the RFM grid is generated using the frequency value matrix model, the recency value matrix model, and the monetary value matrix model. Furthermore, the RFM grid visualizes the reachability of each of the one or more segments on the plurality of channels for the one or more marketing campaigns. In an embodiment of the present disclosure, the RFM grid is generated for frequency versus recency using the frequency value matrix model, the recency value matrix model, and the monetary value matrix model. Moreover, the RFM grid is generated for the one or more segments of the plurality of users 202 in real-time.

The marketing campaign evaluation system 304 assigns one or more segment goals for each of the one or more segments of the one or more online platforms 102 through the RFM grid. In general, segment goal is to achieve a target for any event for a specific user segment in a selected timeframe. The one or more segment goals are ambitious aim of the one or more online platforms 102 for the one or more segments. Each of the one or more segment goals is tracked in real-time. In addition, the one or more segment goals include but may not be limited to maximizing uniform resource locater visits, maximizing number of visits, maximizing number of pages accessed, maximizing webpage visits, and maximizing application installations. Further, the one or more segment goals include but may not be limited to maximizing application launches, minimizing application uninstallations, maximizing accessed content, maximizing started content, and minimizing paused content. Furthermore, the one or more segment goals include but may not be limited to maximizing searched content, maximizing notification clicks, maximizing notification views, maximizing products surfed, and maximizing products added to cart. Moreover, the one or more segment goals include but may not be limited to maximizing reviews for products, minimizing inactivity for products, maximizing accounts opening, maximizing credit card requests, and maximizing credit cards issued. Also, the one or more segment goals include but may not be limited to maximizing loan requests, maximizing net-banking requests, maximizing multimedia content surfed, maximizing multimedia content watched, and maximizing texts exchange. Also, the one or more segment goals include but may not be limited to maximizing live media streaming, maximizing audio-video callings, maximizing medicines searched, maximizing medicines bought, and maximizing medical test kit bought. Also, the one or more segment goals include but may not be limited to maximizing dietary plan requests, maximizing personal trainer hiring, maximizing fitness center searches, and maximizing educational video searches. Also, the one or more segment goals include but may not be limited to maximizing educational video watched, maximizing projects submission, maximizing mock tests subscription, and maximizing properties searches. Also, the one or more segment goals include but may not be limited to maximizing properties watched, maximizing rented properties searches, maximizing maintenance services requests, and maximizing hotel searches. Also, the one or more segment goals include but may not be limited to maximizing hotel bookings, maximizing holiday plans searches, maximizing holiday plans bookings, and maximizing stock exchange investments. Also, the one or more segment goals include but may not be limited to maximizing money donations, maximizing account creations, maximizing subscription renewals, minimizing subscription skipped, and maximizing initiated transactions. Also, the one or more segment goals include but may not be limited to minimizing failed transactions, maximizing completed transactions, and minimizing transaction cancellations.

In an embodiment of the present disclosure, the marketing campaign evaluation system 304 assigns the one or more segment goals for the one or more segments of the over-the-top media platform 102A. In another embodiment of the present disclosure, the marketing campaign evaluation system 304 assigns the one or more segment goals for the one or more segments of the e-commerce platform 102B. In yet another embodiment of the present disclosure, the marketing campaign evaluation system 304 assigns the one or more segment goals for the one or more segments of the fintech platform 102C. In yet another embodiment of the present disclosure, the marketing campaign evaluation system 304 assigns the one or more segment goals for the one or more segments of the social media platform 102D. In yet another embodiment of the present disclosure, the marketing campaign evaluation system 304 assigns the one or more segment goals for the one or more segments of the health platform 102E. In yet another embodiment of the present disclosure, the marketing campaign evaluation system 304 assigns the one or more segment goals for the one or more segments of the education platform 102F. In yet another embodiment of the present disclosure, the marketing campaign evaluation system 304 assigns the one or more segment goals for the one or more segments of the real-estate and housing platform 102G. In yet another embodiment of the present disclosure, the marketing campaign evaluation system 304 assigns the one or more segment goals for the one or more segments of the travel platform 102H.

In an embodiment of the present disclosure, the marketing campaign evaluation system 304 assigns the one or more segment goals for the one or more segments of the over-the-top media platform 102A. In addition, the one or more segment goals include maximizing content watched, maximizing content reach, maximizing account created, maximizing subscriptions, minimizing content paused, minimizing inactivity and the like. Further, the one or more segment goals include maximizing subscription renewal, maximizing application installation, minimizing content stopped, minimizing incomplete transactions, minimizing content excluded from watchlist and the like.

In an example, segment goal S1 (let's say maximizing anime watched) is assigned for users U1 of segment T1 accessing an OTT platform P1 on communication devices D1 (let's say laptop) using a filter F1 (let's say time filter). In another example, segment goal S2 (let's say minimizing inactivity for horror movies) is assigned for users U2 of segment T2 accessing an OTT platform P2 on communication devices D2 (let's say smartphone) using a filter F2 (let's say recency filter). In yet another example, segment goal S3 (let's say minimizing webpage closed) is assigned for users U3 of segment T3 accessing an OTT platform P3 on communication devices D3 (let's say desktop) using a filter F3 (let's say frequency filter). In yet another example, segment goal S4 (let's say maximizing application launched) is assigned for users U4 of segment T4 accessing an OTT platform P4 on communication devices D4 (let's say tablet) using a filter F4 (let's say sub-category filter). In yet another example, segment goal S5 (let's say maximizing subscriptions) is assigned for users U5 of segment T5 accessing an OTT platform P5 on communication devices D5 (let's say laptop) using a filter F5 (let's say activities filter). In yet another example, segment goal S6 (let's say maximizing transaction completed) is assigned for users U6 of segment T6 accessing an OTT platform P6 on communication devices D6 (let's say smartphone) using a filter F6 (let's say monetary filter).

In an embodiment of the present disclosure, the marketing campaign evaluation system 304 assigns the one or more segment goals for the one or more segments of the e-commerce platform 102B. In addition, the one or more segment goals include maximizing products surfed, maximizing products added to cart, maximizing account created, maximizing products bought and the like. Further, the one or more segment goals include maximizing transaction initiated, minimizing application uninstalled, minimizing inaction time, minimizing product removed from cart, minimizing product unavailability and the like.

In an example, segment goal S1 (let's say maximizing mattress surfed) is assigned for users U1 of segment T1 accessing an e-commerce platform P1 on communication devices D1 (let's say laptop) using a filter F1 (let's say activities filter). In another example, segment goal S2 (let's say minimizing inactivity for grocery items) is assigned for users U2 of segment T2 accessing an e-commerce platform P2 on communication devices D2 (let's say smartphone) using a filter F2 (let's say inactivity filter). In yet another example, segment goal S3 (let's say minimizing application uninstalled) is assigned for users U3 of segment T3 accessing an e-commerce platform P3 on communication devices D3 (let's say desktop) using a filter F3 (let's say recency filter). In yet another example, segment goal S4 (let's say maximizing application launched) is assigned for users U4 of segment T4 accessing an e-commerce platform P4 on communication devices D4 (let's say tablet) using a filter F4 (let's say technographic filter). In yet another example, segment goal S5 (let's say maximizing smartphone bought) is assigned for users U5 of segment T5 accessing an e-commerce platform P5 on communication devices D5 (let's say laptop) using a filter F5 (let's say recency filter). In yet another example, segment goal S6 (let's say minimizing transaction failures) is assigned for users U6 of segment T6 accessing an e-commerce platform P6 on communication devices D6 (let's say smartphone) using a filter F6 (let's say monetary filter).

In an embodiment of the present disclosure, the marketing campaign evaluation system 304 assigns the one or more segment goals for the one or more segments of the fintech platform 102C. In addition, the one or more segment goals include maximizing accounts opening, maximizing credit cards issued, maximizing credit card requests, maximizing loan requests, maximizing net-banking requests and the like. Further, the one or more segment goals include maximizing bill payments, maximizing stock exchange investments, maximizing money donated, maximizing notifications clicked and the like. Furthermore, the one or more segment goals maximizing transaction initiated, minimizing transaction failed, minimizing transaction left, minimizing application uninstallation and the like.

In an example, segment goal S1 (let's say maximizing saving account opening requests) is assigned for users U1 of segment T1 accessing a fintech platform P1 on communication devices D1 (let's say laptop) using a filter F1 (let's say activities filter). In another example, segment goal S2 (let's say minimizing inactivity for loan requests) is assigned for users U2 of segment T2 accessing a fintech platform P2 on communication devices D2 (let's say smartphone) using a filter F2 (let's say inactivity filter). In yet another example, segment goal S3 (let's say minimizing application uninstalled) is assigned for users U3 of segment T3 accessing a fintech platform P3 on communication devices D3 (let's say desktop) using a filter F3 (let's say recency filter). In yet another example, segment goal S4 (let's say maximizing application launched) is assigned for users U4 of segment T4 accessing a fintech platform P4 on communication devices D4 (let's say tablet) using a filter F4 (let's say technographic filter). In yet another example, segment goal S5 (let's say maximizing online bill payments) is assigned for users U5 of segment T5 accessing a fintech platform P5 on communication devices D5 (let's say laptop) using a filter F5 (let's say frequency filter). In yet another example, segment goal S6 (let's say minimizing transaction failures) is assigned for users U6 of segment T6 accessing a fintech platform P6 on communication devices D6 (let's say smartphone) using a filter F6 (let's say monetary filter).

In an embodiment of the present disclosure, the marketing campaign evaluation system 304 assigns the one or more segment goals for the one or more segments of the social media platform 102D. In addition, the one or more segment goals include maximizing multimedia content surfed, maximizing multimedia content watched, maximizing account created, maximizing texts exchanged, maximizing time spent, and the like. Further, the one or more segment goals include maximizing paid promotions, maximizing services activated, minimizing inactivity on platform, maximizing live media streamed, maximizing audio-video callings in real-time, and the like.

In an example, segment goal S1 (let's say maximizing rock music surfed) is assigned for users U1 of segment T1 accessing a social media platform P1 on communication devices D1 (let's say laptop) using a filter F1 (let's say activities filter). In another example, segment goal S2 (let's say maximizing romantic movie watched) is assigned for users U2 of segment T2 accessing a social media platform P2 on communication devices D2 (let's say smartphone) using a filter F2 (let's say recency filter). In yet another example, segment goal S3 (let's say maximizing time spent while using application) is assigned for users U3 of segment T3 accessing a social media platform P3 on communication devices D3 (let's say desktop) using a filter F3 (let's say time filter). In yet another example, segment goal S4 (let's say maximizing paid promotions of a fashion page) is assigned for users U4 of segment T4 accessing a social media platform P4 on communication devices D4 (let's say tablet) using a filter F4 (let's say monetary filter). In yet another example, segment goal S5 (let's say minimizing inactivity after launching application) is assigned for users U5 of segment T5 accessing a social media platform P5 on communication devices D5 (let's say laptop) using a filter F5 (let's say inactivity filter). In yet another example, segment goal S6 (let's say minimizing transaction failures) is assigned for users U6 of segment T6 accessing a social media platform P6 on communication devices D6 (let's say smartphone) using a filter F6 (let's say monetary filter).

In an embodiment of the present disclosure, the marketing campaign evaluation system 304 assigns the one or more segment goals for the one or more segments of the health platform 102E. In addition, the one or more segment goals include maximizing medicines searched, maximizing medicines bought, maximizing medical test kit bought, maximizing medical tests scheduled, and the like. Further, the one or more segment goals include maximizing transaction initiated, maximizing transaction completed, maximizing doctor consultation scheduled, maximizing hospital visit planned, and the like. Furthermore, the one or more segment goals include maximizing dietary plan requested, maximizing personal trainer hired, maximizing fitness center searched and the like. Moreover, the one or more segment goals include minimizing subscription expired, minimizing transaction failures, minimizing inactivity, and the like.

In an example, segment goal S1 (let's say maximizing diabetes medicine searched) is assigned for users U1 of segment T1 accessing a health platform P1 on communication devices D1 (let's say laptop) using a filter F1 (let's say activities filter). In another example, segment goal S2 (let's say maximizing blood pressure medicine bought) is assigned for users U2 of segment T2 accessing a health platform P2 on communication devices D2 (let's say smartphone) using a filter F2 (let's say monetary filter). In yet another example, segment goal S3 (let's say maximizing transaction initiated for yoga classes) is assigned for users U3 of segment T3 accessing a health platform P3 on communication devices D3 (let's say desktop) using a filter F3 (let's say recency filter). In yet another example, segment goal S4 (let's say minimizing transaction failed to receive regular health checkup notification) is assigned for users U4 of segment T4 accessing a health platform P4 on communication devices D4 (let's say tablet) using a filter F4 (let's say monetary filter). In yet another example, segment goal S5 (let's say minimizing inactivity after opening health webpage) is assigned for users U5 of segment T5 accessing a health platform P5 on communication devices D5 (let's say laptop) using a filter F5 (let's say inactivity filter). In yet another example, segment goal S6 (let's say maximizing Zumba class schedule notification clicked) is assigned for users U6 of segment T6 accessing a health platform P6 on communication devices D6 (let's say smartphone) using a filter F6 (let's say frequency filter). In yet another example, segment goal S7 (let's say maximizing overall time spent on surfing best fitness gym in south Carolina) is assigned for users U7 of segment T7 accessing a health platform P7 on communication devices D7 (let's say desktop) using a filter F7 (let's say time filter).

In an embodiment of the present disclosure, the marketing campaign evaluation system 304 assigns the one or more segment goals for the one or more segments of the education platform 102F. In addition, the one or more segment goals include maximizing educational video searched, maximizing educational video watched, maximizing projects submitted, maximizing account created, and the like. Further, the one or more segment goals include maximizing transaction initiated, minimizing transaction failures, maximizing transaction completed, maximizing notification clicked, and the like. Furthermore, the one or more segment goals include maximizing mock tests subscribed, maximizing educational counselling requested, maximizing time spent, minimizing inactivity on the platform, and the like.

In an example, segment goal S1 (let's say maximizing botany lecture searched) is assigned for users U1 of segment T1 accessing an education platform P1 on communication devices D1 (let's say laptop) using a filter F1 (let's say activities filter). In another example, segment goal S2 (let's say maximizing differential equation lecture watched) is assigned for users U2 of segment T2 accessing an education platform P2 on communication devices D2 (let's say smartphone) using a filter F2 (let's say frequency filter). In yet another example, segment goal S3 (let's say maximizing renewal energy project submitted) is assigned for users U3 of segment T3 accessing an education platform P3 on communication devices D3 (let's say desktop) using a filter F3 (let's say recency filter). In yet another example, segment goal S4 (let's say minimizing transaction failed to receive regular mathematics lecture notification) is assigned for users U4 of segment T4 accessing an education platform P4 on communication devices D4 (let's say tablet) using a filter F4 (let's say monetary filter). In yet another example, segment goal S5 (let's say minimizing inactivity after opening education application) is assigned for users U5 of segment T5 accessing an education platform P5 on communication devices D5 (let's say laptop) using a filter F5 (let's say inactivity filter). In yet another example, segment goal S6 (let's say maximizing life science lecture schedule notification clicked) is assigned for users U6 of segment T6 accessing an education platform P6 on communication devices D6 (let's say smartphone) using a filter F6 (let's say frequency filter). In yet another example, segment goal S7 (let's say maximizing overall time spent on surfing international business management colleges) is assigned for users U7 of segment T7 accessing an education platform P7 on communication devices D7 (let's say desktop) using a filter F7 (let's say time filter).

In an embodiment of the present disclosure, the marketing campaign evaluation system 304 assigns the one or more segment goals for the one or more segments of the real estate and housing platform 102G. In addition, the one or more segment goals include maximizing properties searched, maximizing properties watched, maximizing properties bought, maximizing rented properties searched, and the like. Further, the one or more segment goals include maximizing account created, maximizing maintenance services requested, maximizing transaction initiated, maximizing transaction completed, and the like. Furthermore, the one or more segment goals include minimizing maintenance service cancelled, minimizing inactivity, minimizing transaction failures, minimizing application uninstalled, and the like.

In an example, segment goal S1 (let's say maximizing property search in California) is assigned for users U1 of segment T1 accessing a real estate and housing platform P1 on communication devices D1 (let's say laptop) using a filter F1 (let's say activities filter). In another example, segment goal S2 (let's say maximizing property bought in Washington) is assigned for users U2 of segment T2 accessing a real estate and housing platform P2 on communication devices D2 (let's say smartphone) using a filter F2 (let's say frequency filter). In yet another example, segment goal S3 (let's say maximizing air conditioner maintenance service requests) is assigned for users U3 of segment T3 accessing a real estate and housing platform P3 on communication devices D3 (let's say desktop) using a filter F3 (let's say recency filter). In yet another example, segment goal S4 (let's say minimizing transaction failed for rented apartment in Chicago) is assigned for users U4 of segment T4 accessing a real estate and housing platform P4 on communication devices D4 (let's say tablet) using a filter F4 (let's say monetary filter). In yet another example, segment goal S5 (let's say minimizing inactivity after opening real estate application) is assigned for users U5 of segment T5 accessing a real estate and housing platform P5 on communication devices D5 (let's say laptop) using a filter F5 (let's say inactivity filter). In yet another example, segment goal S6 (let's say maximizing best home loan notification clicked) is assigned for users U6 of segment T6 accessing a real estate and housing platform P6 on communication devices D6 (let's say smartphone) using a filter F6 (let's say demographic filter). In yet another example, segment goal S7 (let's say maximizing overall time spent for farms on sale in Texas) is assigned for users U7 of segment T7 accessing a real estate and housing platform P7 on communication devices D7 (let's say desktop) using a filter F7 (let's say geographic filter).

In an embodiment of the present disclosure, the marketing campaign evaluation system 304 assigns the one or more segment goals for the one or more segments of the travel platform 102H. In addition, the one or more segment goals include maximizing hotel searched, maximizing hotels added to watch-list, minimizing hotels removed from watch-list, maximizing hotel bookings, maximizing account created, and the like. Further, the one or more segment goals include maximizing holiday plans searched, maximizing holiday plans booked, maximizing transaction initiated, maximizing transaction completed, and the like. Furthermore, the one or more segment goals include minimizing inactivity, minimizing transaction failures, minimizing hotel booking cancellations, and the like.

In an example, segment goal S1 (let's say maximizing hotel search in Dallas) is assigned for users U1 of segment T1 accessing a travel platform P1 on communication devices D1 (let's say laptop) using a filter F1 (let's say activities filter). In another example, segment goal S2 (let's say minimizing hotel removal from a watch-list) is assigned for users U2 of segment T2 accessing a travel platform P2 on communication devices D2 (let's say smartphone) using a filter F2 (let's say frequency filter). In yet another example, segment goal S3 (let's say maximizing holiday plan booked for Cairo) is assigned for users U3 of segment T3 accessing a travel platform P3 on communication devices D3 (let's say desktop) using a filter F3 (let's say recency filter). In yet another example, segment goal S4 (let's say minimizing transaction failed for hotel booking in Ohio) is assigned for users U4 of segment T4 accessing a travel platform P4 on communication devices D4 (let's say tablet) using a filter F4 (let's say monetary filter). In yet another example, segment goal S5 (let's say minimizing inactivity after opening webpage of hotels in Hawaii) is assigned for users U5 of segment T5 accessing a travel platform P5 on communication devices D5 (let's say laptop) using a filter F5 (let's say inactivity filter). In yet another example, segment goal S6 (let's say minimizing hotel booking cancellation in Florida) is assigned for users U6 of segment T6 accessing a travel platform P6 on communication devices D6 (let's say smartphone) using a filter F6 (let's say demographic filter). In yet another example, segment goal S7 (let's say maximizing overall time spent for Italian restaurants in Georgia) is assigned for users U7 of segment T7 accessing a travel platform P7 on communication devices D7 (let's say desktop) using a filter F7 (let's say time filter).

The marketing campaign evaluation system 304 initiates the one or more marketing campaigns for the one or more segments form the RFM grid to achieve the one or more segment goals. In addition, the one or more marketing campaigns are initiated to achieve the one or more segment goals for the one or more segments related to the one or more online platforms 102. Further, the one or more marketing campaigns are initiated based on the one or more patterns of the one or more segments using the plurality of RFM filters. The one or more marketing campaigns are initiated for the one or more segments by a plurality of advertisers. In addition, the plurality of advertisers purchases one or more advertisement slots from the one or more online platforms 102. In an embodiment of the present disclosure, the plurality of advertisers purchases the one or more advertisement slots for displaying one or more advertisements on the corresponding advertisement slots. In general, the one or more marketing campaigns are organized, strategized efforts to achieve the one or more segment goals. The one or more marketing campaigns reach the plurality of users 202 of the one or more segments in the plurality of channels.

The one or more marketing campaigns reach the plurality of users 202 in a plurality of channels. The plurality of channels includes but may not be limited to mobile channels, email channels, desktop channels, social channels, remarketing channels, server channels, and the like. However, the various channels are not limited to the above-mentioned channels. The one or more marketing campaigns may include an advertiser defined parameters. The advertiser defined parameters include minimum spend, discounts, campaign duration, campaign relevancy, campaign location, a customer's patronage of the online platform, user interaction, and the like. However, the advertiser defined parameters are not limited to the above-mentioned parameters.

In an embodiment of the present disclosure, the one or more marketing campaigns have an acquisition objective designed to send offers to new users of the plurality of users 202 that have not sufficiently patronized the one or more online platforms 102. In another embodiment of the present disclosure, the one or more marketing campaigns have a loyalty campaign designed to send offers to former users of the plurality of users 202 that have sufficiently patronized the one or more of online platforms 102. In yet another embodiment of the present disclosure, the one or more marketing campaigns have an all-inclusive campaign are designed to send offers to both new and former users. In an example, a marketing campaign M1 with an all-inclusive objective O1 has a discount value from 10% to 40%. In another example, a marketing campaign M2 with a loyalty objective O2 has a discount value from 20% to 50% (wherein 25% discount value is a default). In yet another example, a marketing campaign M3 with an acquisition objective O3 has a discount value from 40% to 60% (wherein 25% discount value is a default).

The marketing campaign evaluation system 304 displays the one or more advertisements to the plurality of users 202 on a corresponding advertisement slot of the one or more advertisement slots. The one or more advertisements associated with the one or more marketing campaigns. In an embodiment of the present disclosure, the one or more advertisements are displayed on the one or more communication devices 204 in the form of flash messages. In another embodiment of the present disclosure, the one or more advertisements are displayed on the one or more communication devices 204 in the form of text messages. In yet another embodiment of the present disclosure, the one or more advertisements are displayed on the one or more communication devices 204 in the form of telephonic calls. In yet another embodiment of the present disclosure, the one or more advertisements are displayed on the one or more communication devices 204 in the form of multimedia messages. In yet another embodiment of the present disclosure, the one or more advertisements are displayed on the one or more online platforms 102 in the form of notification. In yet another embodiment of the present disclosure, the one or more advertisements are displayed on the one or more communication devices 204 as Google Ads. The one or more advertisements are displayed on the one or more communication devices 204 in real-time. In an embodiment of the present disclosure, the one or more advertisements displayed are associated with the interests of the user of the plurality of users 202. In addition, the one or more advertisements include text advertisements, video advertisements, audio advertisements, audio-video advertisements, pictorial advertisements, and the like.

The marketing campaign evaluation system 304 produces a transition representation for each of the one or more segments due to the one or more marketing campaigns based on a Recency-Frequency-Monetary value matrix model. In addition, the transition representation helps to understand flow of each of the plurality of users 202 from one segment of the one or more segments to another segment based on the Recency-Frequency-Monetary value matrix model. The transition representation depicts the transition of each of the plurality of users 202 from the one segment to another segment after running the one or more marketing campaigns. In an example, 25 users of a segment S1 (let's say a segment of customers having high customer value) transitioned to a segment St (let's say a segment of customers having medium customer value). In another example, 41 users of a segment S2 (let's say a segment of customers having low customer value) transitioned to a segment S2′ (let's say a segment of customers having high customer value). In yet another example, 70 users of a segment S3 (let's say a segment of customers having low customer value) transitioned to a segment S3′ (let's say a segment of customers having medium customer value). Further, the marketing campaign evaluation system 304 produces the transition representation for each of the one or more segments due to the one or more marketing campaigns in real-time.

The marketing campaign evaluation system 304 evaluates the effectiveness of each of the one or more marketing campaigns initiated for the one or more segments using the Recency-Frequency-Monetary value matrix model. In addition, the effectiveness is the degree to which a marketing campaign is successful from the one or more marketing campaigns in achieving the one or more segment goals. In an example, a marketing campaign M1 successfully achieves a segment goal G1 of transition of 50 users of a segment S1 (let's say a segment of customers having low customer value) to a segment St (let's say a segment of customers having medium customer value). In another example, a marketing campaign M2 successfully achieves a segment goal G2 of transition of 2108 users of a segment S2 (let's say a segment of customers having low customer value) to a segment S2′ (let's say a segment of customers having high customer value). Further, the marketing campaign evaluation system 304 evaluates the effectiveness of each of the one or more marketing campaigns in real-time. Furthermore, the marketing campaign evaluation system 304 analyzes a real-time impact of the one or more marketing campaigns on the customer value of each of the plurality of users 202 of the one or more segments. Moreover, the marketing campaign evaluation system 304 analyzes the impact of the one or more marketing campaigns on the customer value in real-time.

The interactive computing environment 300 further includes the server 306 and the database 306a. The marketing campaign evaluation system 304 is associated with the server 306. In general, server is a computer program or device that provides functionality for other programs or devices. The server 306 provides various functionalities, such as sharing data or resources among multiple clients, or performing computation for a client. However, those skilled in the art would appreciate that the marketing campaign evaluation system 304 is connected to more number of servers. Furthermore, it may be noted that the server 306 includes the database 306a. However, those skilled in the art would appreciate that more number of the servers include more numbers of database.

In an embodiment of the present disclosure, the marketing campaign evaluation system 304 is located in the server 306. In another embodiment of the present disclosure, the marketing campaign evaluation system 304 is connected with the server 306. In yet another embodiment of the present disclosure, the marketing campaign evaluation system 304 is a part of the server 306. The server 306 handles each operation and task performed by the marketing campaign evaluation system 304. The server 306 stores one or more instructions for performing the various operations of the marketing campaign evaluation system 304. The server 306 is located remotely from the one or more online platforms 102. The server 306 is associated with the administrator 308. In general, administrator manages the different components in the marketing campaign evaluation system 304. The administrator 308 coordinates the activities of the components involved in the marketing campaign evaluation system 304. The administrator 308 is any person or individual who monitors the working of the marketing campaign evaluation system 304 and the server 306 in real-time. The administrator 308 monitors the working of the marketing campaign evaluation system 304 and the server 306 through a communication device. The communication device includes the laptop, the desktop computer, the tablet, a personal digital assistant and the like.

The database 306a stores different sets of information associated with various components of the marketing campaign evaluation system 304. In general, the database 306a is used to hold general information and specialized data, such as characteristics data of the plurality of users 202, data of the one or more communication devices 204, data of the one or more online platforms 102 and the like. The database 306a stores the information of the one or more online platforms 102, the one or more communication devices 204, the profiles of the plurality of users 202, demographic information of the plurality of users 202 and the like. The database 306a organizes the data using model such as relational models or hierarchical models. Further, the database 306a store data provided by the administrator 308.

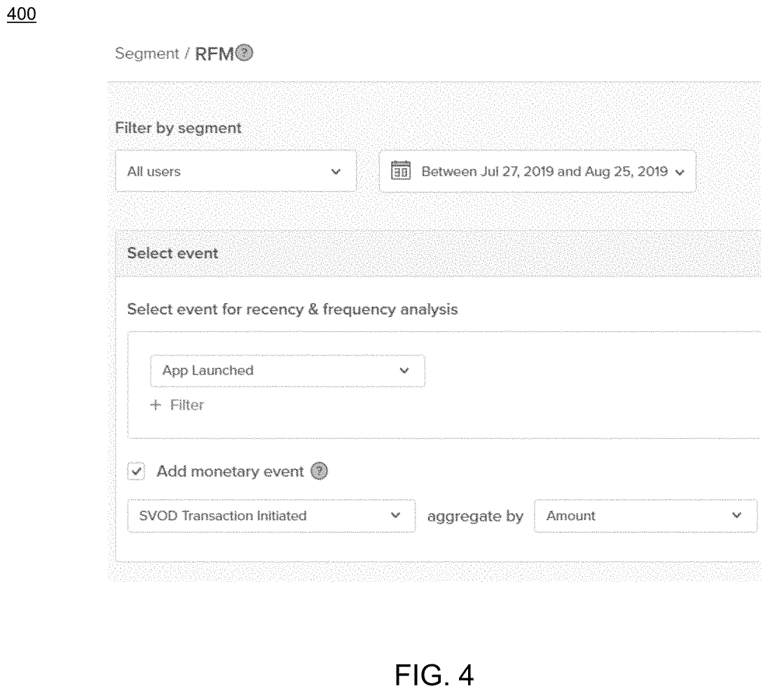

FIG. 4 illustrates an example 400 for initiating RFM analysis of the plurality of users 202 based on RFM using various filters, in accordance with various embodiments of the present disclosure. The example 400 depicts a section entitled “Segment” for creation of a segment of the one or more segments using “RFM” and various filters. In the example 400, the section entitled “Segment” includes “filter by segment” and “select events”. In the example 400, the “filter by segment” is for “all users” between Jul. 27, 2019 and Aug. 25, 2019. In the example 400, the “select events” includes “select event for recency and frequency analysis” with a “add monetary event” filter. In the example 400, the “select event for recency and frequency analysis” is “application launched”. In another example, the “select event for recency and frequency analysis” is “application installed”. In yet another example, the “select event for recency and frequency analysis” is “content watched”. In yet another example, the “select event for recency and frequency analysis” is “content stopped”. In yet another example, the “select event for recency and frequency analysis” is “product added to cart” (let's say a Tennis Kit added to kit). In the example 400, the “add monetary event” filter is selected for an event “SVOD transaction initiated” aggregated by “amount”. In another example, the “add monetary event” filter is selected for an event “TVOD transaction initiated” aggregated by “duration”.

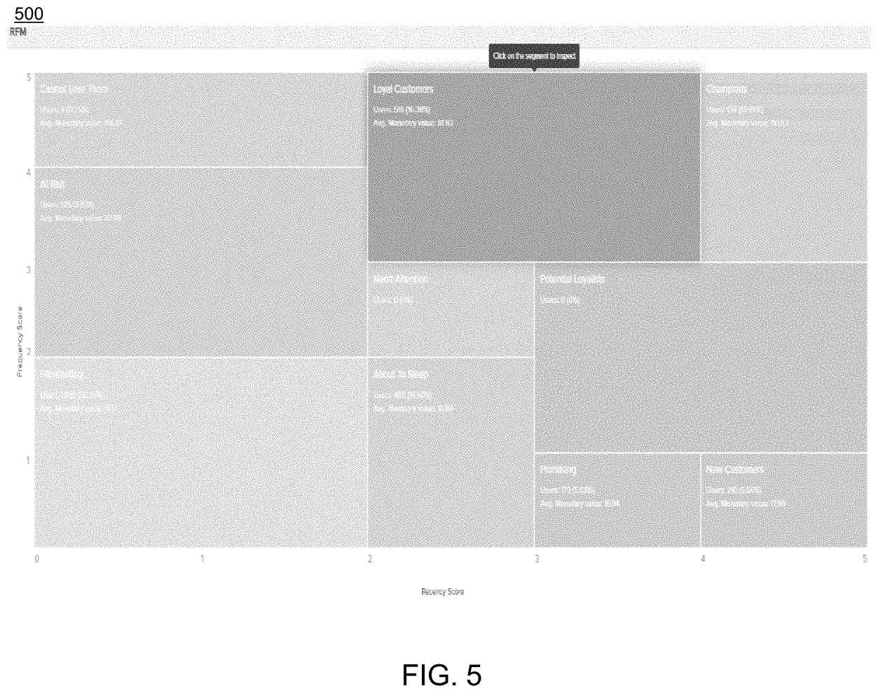

FIG. 5 illustrates an example 500 of a “RFM plot” for the plurality of users 202, in accordance with various embodiments of the present disclosure. The example 500 depicts the one or more segments based on the RFM analysis on the “RFM plot” of “frequency score” vs “recency score”. In the example 500, the “RFM plot” demonstrates “recency score” on the X-axis and “requency score” on the Y-axis. In the example 500, the “RFM plot” includes the one or more segments based on the RFM analysis. In the example 500, the one or more segments based on the RFM analysis include “hibernating”, “about to sleep”, “promising”, “new customers”, “at risk”, “cannot lose them”, “need attention”, “potential loyalists”, “loyal customers”, and “champions”. In general, the “hibernating” segment has users having lowest “recency score” and “frequency score”. The “about to sleep” segment has users having below average “recency score” and “frequency score” and may slip away if not engaged. The “promising” segment has the users having high “recency score” with the potential to become high frequency users. The “new customers” segment has the users who are most recent with low “frequency score”. The “at risk” segment has the users having above average “frequency score” but low “recency score” and needs to be re-engaged. The “cannot lose them” segment has the users who were frequent at one point but haven't been back recently. The “loyal customers” segment has the users having highest “frequency score with strong “recency score”. The “champions” segment has the users which are most active users. In addition, the “champions” segment has highest “recency score” and “frequency score”.

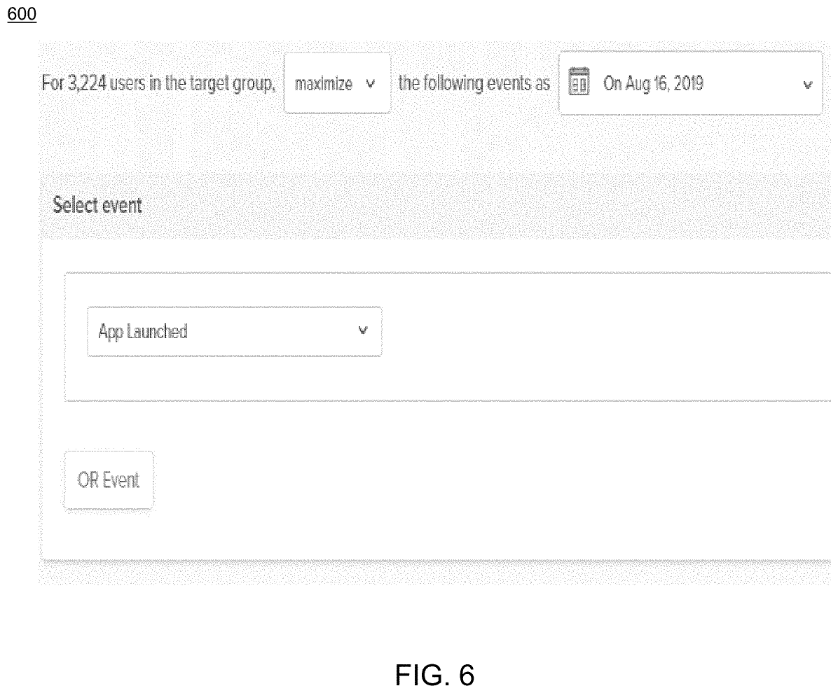

FIG. 6 illustrates an example 600 for assigning the one or more segment goals, in accordance with various embodiments of the present disclosure. The example 600 demonstrates the creation of the one or more segment goals based on segment goal parameter, time parameters, and the one or more events. In addition, the segment goal parameter include “maximize” and “minimize”. In an example 600, the one or more segment goal G1 is to “maximize” application launch for 3224 users. In another example, the one or more segment goal G2 is to “minimize” the application uninstallation. In the example 600, the one or more segment goal G1 is created for at least one event of the one or more events.

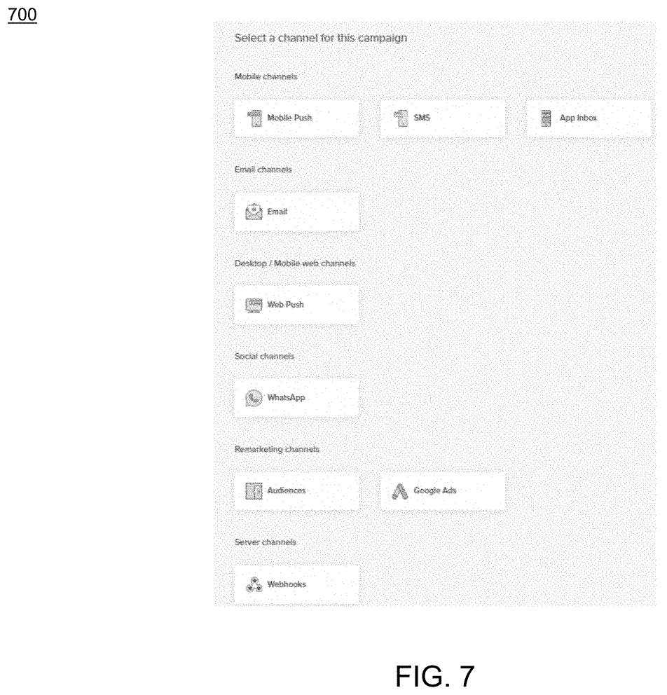

FIG. 7 illustrates an example 700 for selecting the plurality of channels for initiating a marketing campaign, in accordance with various embodiments of the present disclosure. The example 700 depicts various mediums and “channels” for a specific marketing campaign from the one or more marketing campaigns. In the example 700, the plurality of channels includes the “mobile channels”, the “email channels”, the “desktop/mobile web channels”, the “social channels”, the “remarketing channels”, and the “server channels”. Further, the “mobile channels” include “mobile push”, “SMS”, and “application inbox”. Furthermore, the “remarketing channels” include “audiences” and “google ads”. In the example 700, the “social channels” includes “WhatsApp”. In another example, the “social channels” includes Facebook, Skype, Google Hangouts, Microsoft Teams, Slack, Business Chat, Telegram, and the like. In the example 700, at least one of the channel is selected from the plurality of channels for the specific marketing campaign.

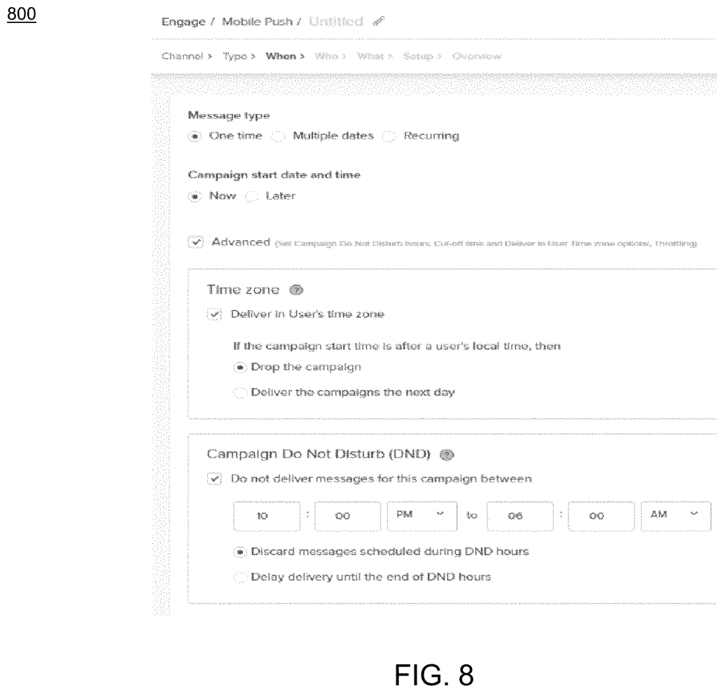

FIG. 8 illustrates an example 800 for engaging the marketing campaign using a “mobile push” channel, in accordance with various embodiments of the present disclosure. The example 800 depicts a section entitled “when” to engage the marketing campaign using the “mobile push” channel. In the example 800, the section entitled “when” of the “mobile push” channel includes a “message type”, a “campaign start date and time”, a “time zone”, and a “campaign do not disturb”. In the example 800, the “message type” is “one time” message. In another example, the “message type” is “multiple dates” and “recurring”. In the example 800, the “campaign start date and time” is “now”. In another example, the “campaign start date and time” is “later”. In the example 800, the “time zone” is selected as “deliver in user's time zone” using the filter “drop the campaign” if the specific campaign start time is after the user's local time. In another example, the “time zone” is selected as “deliver in user's time zone” using the filter “deliver the campaigns the next day”. In the example 800, the “campaign do not disturb” for the specific campaign of the one or more marketing campaigns allows to not deliver messages between 10:00 PM to 06:000 AM using the filter “discard messages scheduled during do not disturb hours”. In another example, the “campaign do not disturb” for the specific campaign of the one or more marketing campaigns allows to use the filter “delay delivery until the end of the do not disturb hours”.

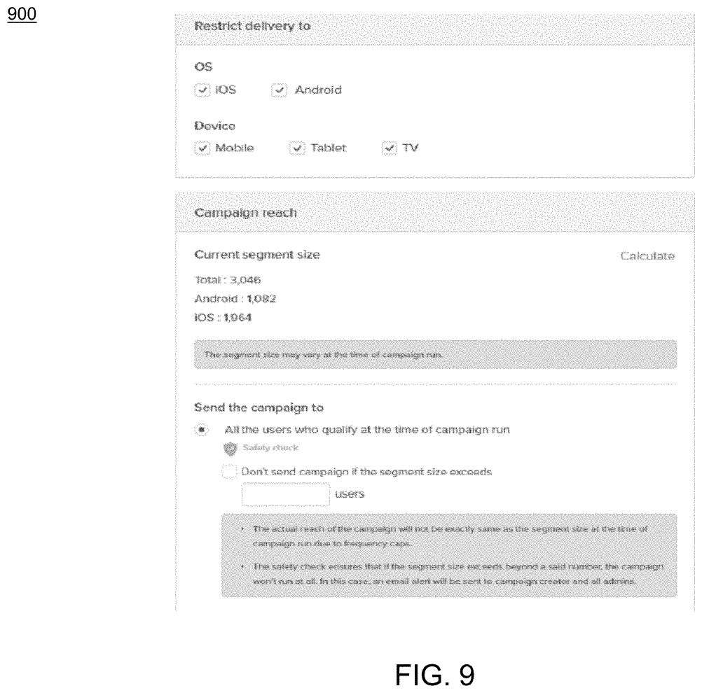

FIG. 9 illustrates an example 900 of a campaign delivery and a campaign reach, in accordance with various embodiments of the present disclosure. The example 900 depicts a section entitled “who” to engage the marketing campaign using the “mobile push” channel. In the example 900, the section entitled “who” includes “restrict delivery to” and the “campaign reach”. In the example 900, the subsection “restrict delivery to” includes an “operating system” and a “device”. In addition, the “operating system” includes “iOS” and “Android”. Further, the “device” includes “mobile”, “tablet”, and “television”. In the example 900, subsection “campaign reach” includes “current segment size”. In the example 900, total number of users in the current segment is 3,046. In the example 900, the number of users using the android in the current segment is 1,082. In the example 900, the number of users using the iOS in the current segment is 1,964. In addition, the example 900 shows that the segment size may vary at the time of campaign run. In the example 900, a first filter for sending the campaign is “all the users who qualify at the time of campaign run”. In another example, a second filter is “don't send campaign if the segment size exceeds” 10,000 users.

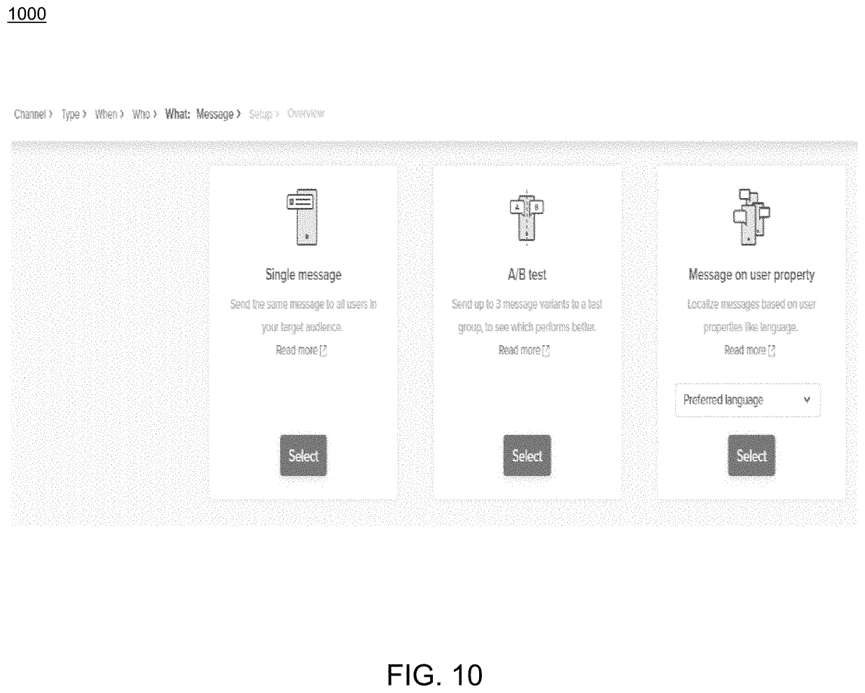

FIG. 10 illustrates an example 1000 for sending message for the marketing campaign, in accordance with various embodiments of the present disclosure. The example 1000 depicts a section entitled “what” to send while engaging with the marketing campaign. In the example 1000, the section entitled “what” includes a “single message”, an “A/B test”, and a “message on user property”. In addition, the “single message” is a same message sent to all the users in the target audience for the marketing campaign as shown in the example 1000. Further, the “A/B test” is used to send up to 3 message variants to a test group of the users to see which performs better for the marketing campaign. Furthermore, the “message on user property” is used to send localize messages based on user properties. In the example 1000, the “message on user property” is used to send the localize messages based on the user property preferred language. In another example, the “message on user property” is used to send the localize messages based on the user property location. In yet another example, the “message on user property” is used to send the localize messages based on the user property preferred genre. In yet another example, the “message on user property” is used to send the localize messages based on the user property birthday. In yet another example, the “message on user property” is used to send the localize messages based on the user property activation date.

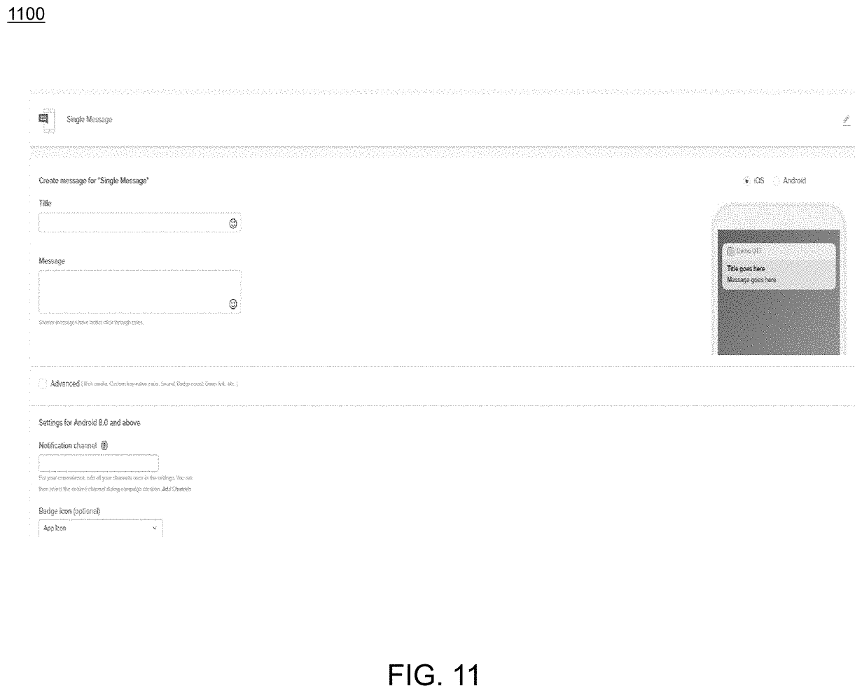

FIG. 11 illustrates an example 1100 of the “single message” for the marketing campaign, in accordance with various embodiments of the present disclosure. The example 1100 depicts a section for creating the “single message” while engaging with the marketing campaign. In addition, the “single message” is created with a “title” and a “message” as shown in the example 1100. Further, the “single message” has an “advanced” filter. In the example 1100, the “advanced” filter includes rich media, custom key value pairs, sound media, badge count, deep link, and the like. In another example, the “advanced” filter includes a video media. In yet another example, the “advanced” filter includes a web banner. In the example 1100, the “single message” is created using customized setting for notification channel on Android version 8.0 and above.

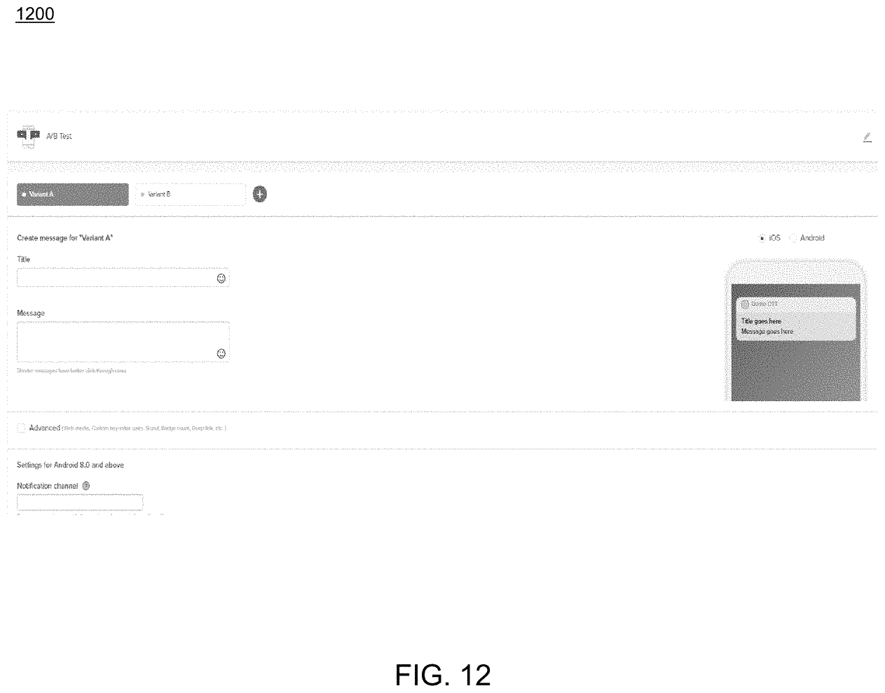

FIG. 12 illustrates an example 1200 of the “A/B test” for the marketing campaign, in accordance with various embodiments of the present disclosure. The example 1200 depicts a section “A/B test” for creating various variant messages engaging with the marketing campaign. In addition, a message is created for “variant A” with a title A and a message A as shown in the example 1200. Further, a message is created for “variant B” with a title B and a message B. In the example 1200, more variant is added according to the requirement of the marketing campaign. In the example 1200, each of the variant messages has an “advanced” filter. In the example 1200, the “advanced” filter includes rich media, custom key value pairs, sound media, badge count, deep link, and the like. Furthermore, the “A/B test” helps to evaluate better performing message variant for the marketing campaign.

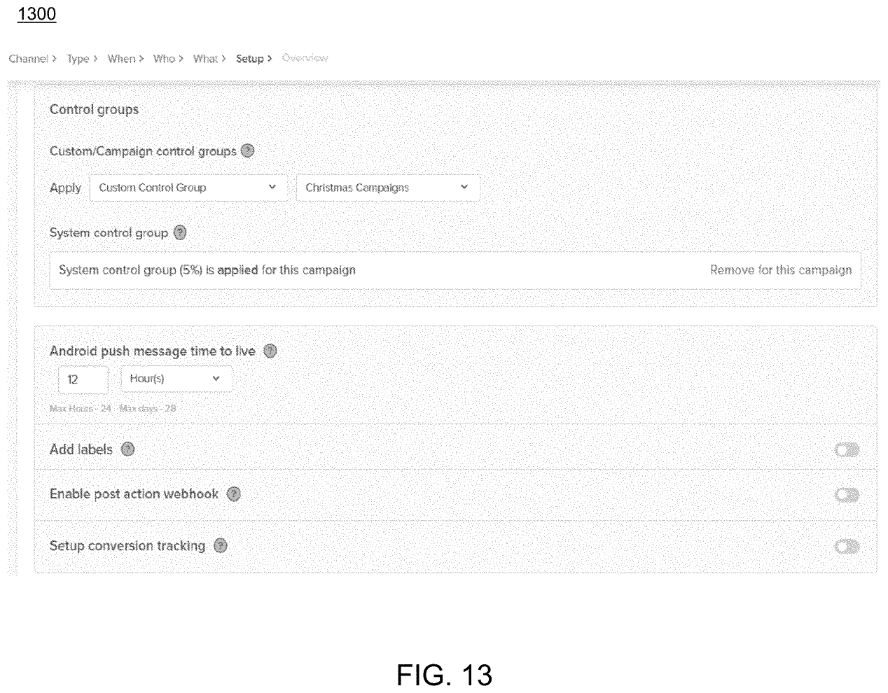

FIG. 13 illustrates an example 1300 of a “setup” for the marketing campaign, in accordance with various embodiments of the present disclosure. The example 1300 depicts a section entitled “setup” while engaging with the marketing campaign. In the example 1300, the “setup” includes “control groups” and “android push message time to live”. In addition, the “control groups” include a “custom control group”, a “campaign control group”, and a “system control group”. In the example 1300, the “custom control group” selected is “Christmas campaign”. In another example, the “custom control group” selected is “Easter campaign”. In yet another example, the “custom control group” selected is “Aloha festival campaign”. In yet another example, the “custom control group” selected is “Halloween campaign”. Further, the “system control group” is automatically applied to the marketing campaign and measures effectiveness of the marketing campaign. Furthermore, the “android push message time to live” specifies for how long the message is preserved to be delivered to the plurality of users 202. In the example 1300, the “android push message time to live” is 12 hours. In the example 1300, “add labels” filter enables labelling of the marketing campaign with descriptive theme. In addition, the performance of each of the labels is also analyzed for the marketing campaign. In the example 1300, “post action webhook” filter enables the receiving of the notification data on the webhook. In the example 1300, “setup conversion tracking” filter enables tracking of conversion for the marketing campaign.

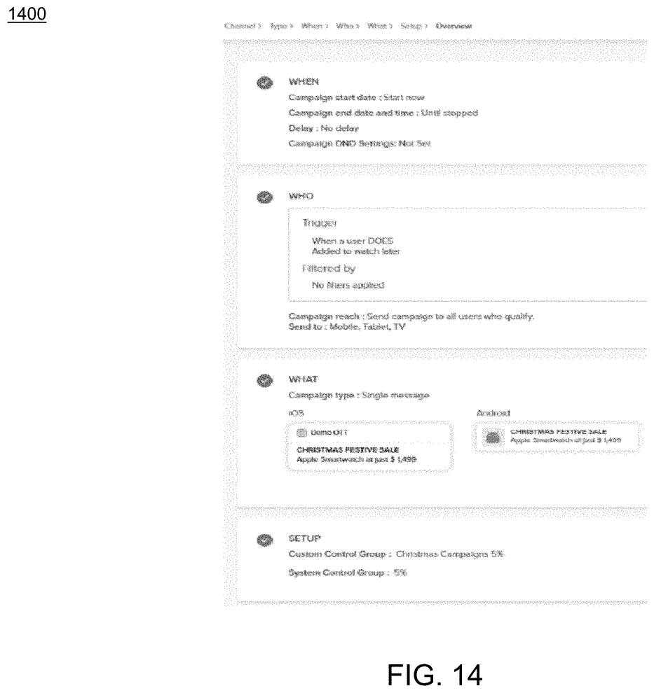

FIG. 14 illustrates an example 1400 of an “overview” for engagement of the marketing campaign, in accordance with various embodiments of the present disclosure. The example 1400 depicts a section entitled “overview” while engaging with the marketing campaign. In the example 1400, the “overview” displays the section entitled “when”, the section entitled “who”, the section entitled “what”, and the section entitled “setup”. In the example 1400, the section entitled “when” includes “campaign start date”, “campaign end date and time”, “delay”, and “campaign do not disturb setting”. In the example 1400, the marketing campaign starts now until stopped with no delay. In addition, the do not disturb setting is disabled for the marketing campaign. In another example, the section entitled “when” starts the marketing campaign in a form of a message now and discard the marketing campaign from 10:00 PM to 06:00 AM. In the example 1400, the section entitled “who” shows a trigger point for the marketing campaign when a user performs add to watch later. In another example, the section entitled “who” shows sending the message to the users who launched an application in the last 30 days. In addition, the section entitled “who” shows sending the message to Mobile, Tablet, and TV. In the example 1400, the section entitled “what” shows sending the message titled “Christmas Festive Sale” for “Apple Smartwatch at just $1,499”. In the example 1400, the section entitled “setup” shows the “custom control group” selected as “Christmas Campaign” and the “system control group” selected as 5%. In another example, the section entitled “setup” shows the “custom control group” selected as “Halloween Campaign”.

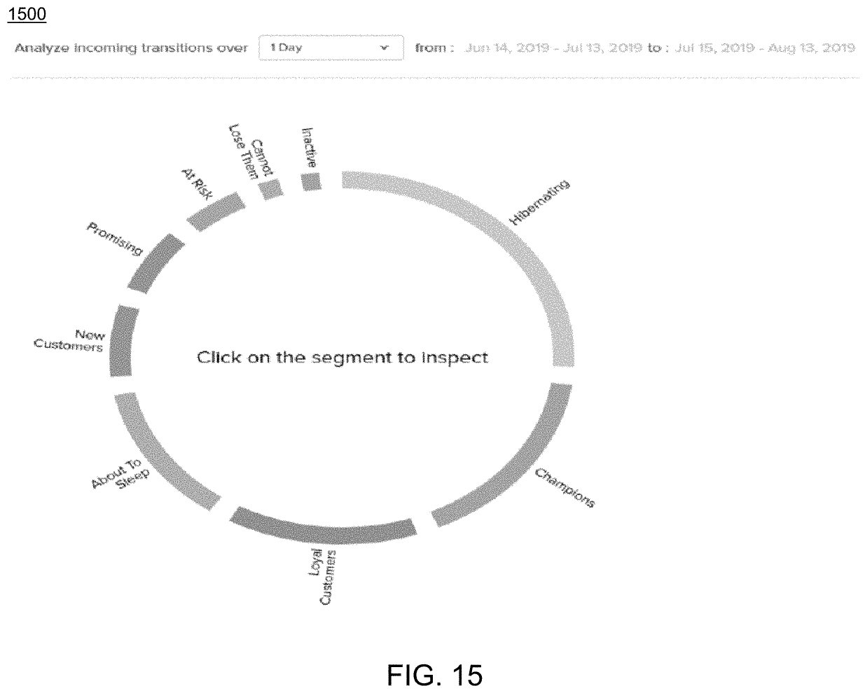

FIG. 15 illustrates an example of a “doughnut chart” for “transitions” analysis of the plurality of users 202 based on the RFM matrix in a segment, in accordance with various embodiments of the present disclosure. The example 1500 depicts transition of the user of the plurality of users 202 through the one or more segments based on the RFM. In the example 1500, analysis of transitions over “1 day” from “Jun. 14, 2019-Jul. 13, 2019 to Jul. 15, 2019-Aug. 13, 2019”. In the example 1500, the “doughnut chart” shows the one or more segments based on the RFM analysis. In addition, the example 1500 shows “click on the segment to inspect” for analyzing the transitions of the corresponding segment of the one or more segments.

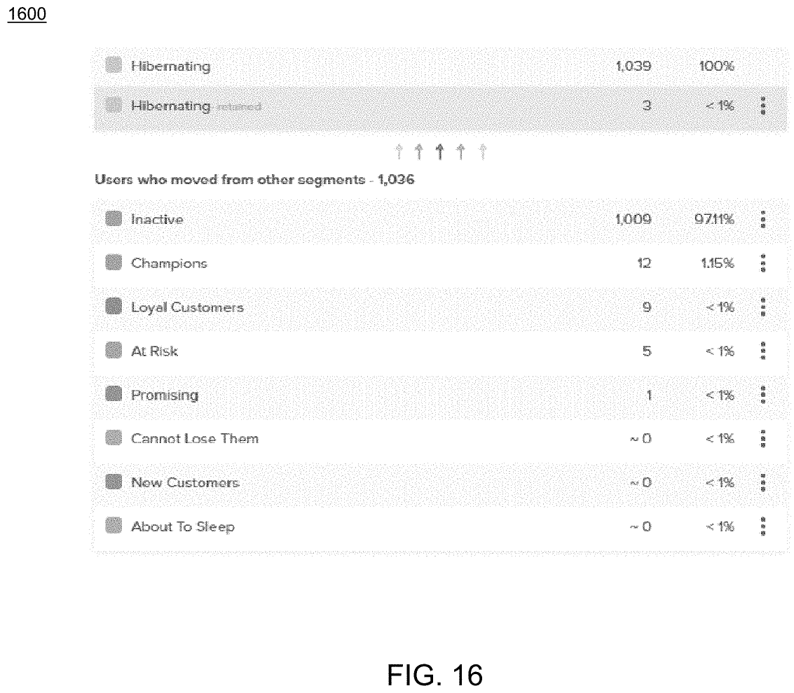

FIG. 16 illustrates an example of a “transitions” for a “hibernating” segment, in accordance with various embodiments of the present disclosure. The example 1600 depicts a table for the “transitions” for the “hibernating” segment. In the example 1600, the “hibernating” segment has 1,039 number of the users. In the example 1600, 3 number of the users are retained from the “hibernating” segment (that is 0.2% of the total number of users) over “1 day” from “Jun. 14, 2019-Jul. 13, 2019 to Jul. 15, 2019-Aug. 13, 2019”. In the example 1600, 1,009 users are moved from the “inactive” segment to “hibernating” segment (that is 97.11% of the total number of users) over “1 day” from “Jun. 14, 2019-Jul. 13, 2019 to Jul. 15, 2019-Aug. 13, 2019”. In the example 1600, 12 users are moved from the “champions” segment to “hibernating” segment (that is 1.15% of the total number of users) over “1 day” from “Jun. 14, 2019-Jul. 13, 2019 to Jul. 15, 2019-Aug. 13, 2019”. In the example 1600, 9 users are moved from the “loyal customers” segment to “hibernating” segment (that is 0.86% of the total number of users) over “1 day” from “Jun. 14, 2019-Jul. 13, 2019 to Jul. 15, 2019-Aug. 13, 2019”. In the example 1600, 5 users are moved from the “at risk” segment to “hibernating” segment (that is 0.48% of the total number of users) over “1 day” from “Jun. 14, 2019-Jul. 13, 2019 to Jul. 15, 2019-Aug. 13, 2019”. In the example 1600, 1 user is moved from the “promising” segment to “hibernating” segment over “1 day” from “Jun. 14, 2019-Jul. 13, 2019 to Jul. 15, 2019-Aug. 13, 2019”.

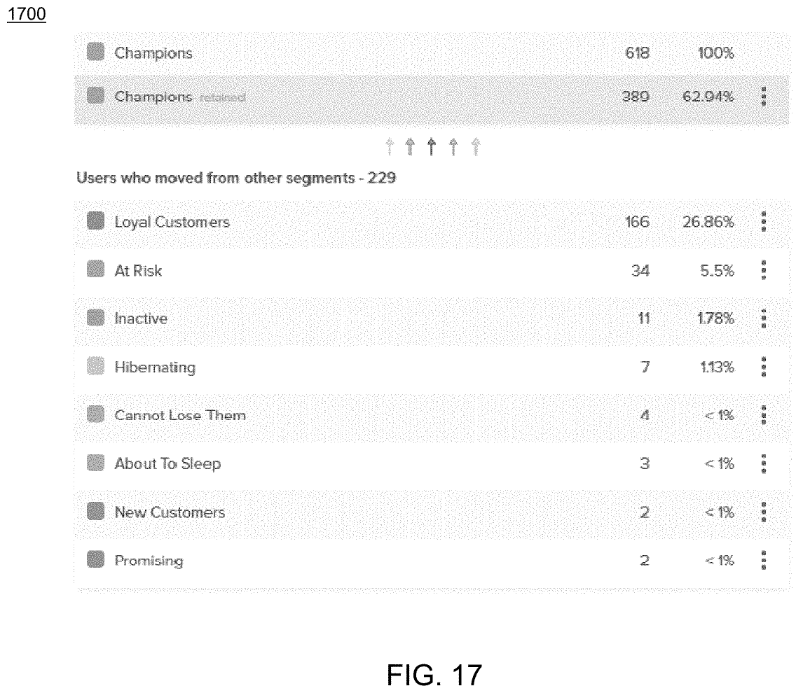

FIG. 17 illustrates an example 1700 of the “transitions” for the “champions” segment, in accordance with various embodiments of the present disclosure. The example 1700 depicts a table for the “transitions” for the “champions” segment. In the example 1700, the “champions” segment has 618 number of the users. In the example 1700, 389 users are retained from the “champions” segment (that is 62.94% of the total number of users) over “1 day” from “Jun. 14, 2019-Jul. 13, 2019 to Jul. 15, 2019-Aug. 13, 2019”. In the example 1700, 166 users are moved from the “local customers” segment to “champions” segment (that is 26.86% of the total number of users) over “1 day” from “Jun. 14, 2019-Jul. 13, 2019 to Jul. 15, 2019-Aug. 13, 2019”. In the example 1700, 34 users are moved from the “at risk” segment to “champions” segment (that is 5.5% of the total number of users) over “1 day” from “Jun. 14, 2019-Jul. 13, 2019 to Jul. 15, 2019-Aug. 13, 2019”. In the example 1700, 11 users are moved from the “inactive” segment to “champions” segment (that is 1.78% of the total number of users) over “1 day” from “Jun. 14, 2019-Jul. 13, 2019 to Jul. 15, 2019-Aug. 13, 2019”. In the example 1700, 7 users are moved from the “hibernating” segment to “champions” segment (that is 1.13% of the total number of users) over “1 day” from “Jun. 14, 2019-Jul. 13, 2019 to Jul. 15, 2019-Aug. 13, 2019”. In the example 1700, 4 users are moved from the “cannot lose them” segment to “champions” segment over “1 day” from “Jun. 14, 2019-Jul. 13, 2019 to Jul. 15, 2019-Aug. 13, 2019”. In the example 1700, 3 users are moved from the “about to sleep” segment to “champions” segment over “1 day” from “Jun. 14, 2019-Jul. 13, 2019 to Jul. 15, 2019-Aug. 13, 2019”. In the example 1700, 2 users are moved from the “new customers” segment to “champions” segment over “1 day” from “Jun. 14, 2019-Jul. 13, 2019 to Jul. 15, 2019-Aug. 13, 2019”. In the example 1700, 2 users are moved from the “promising” segment to “champions” segment over “1 day” from “Jun. 14, 2019-Jul. 13, 2019 to Jul. 15, 2019-Aug. 13, 2019”.

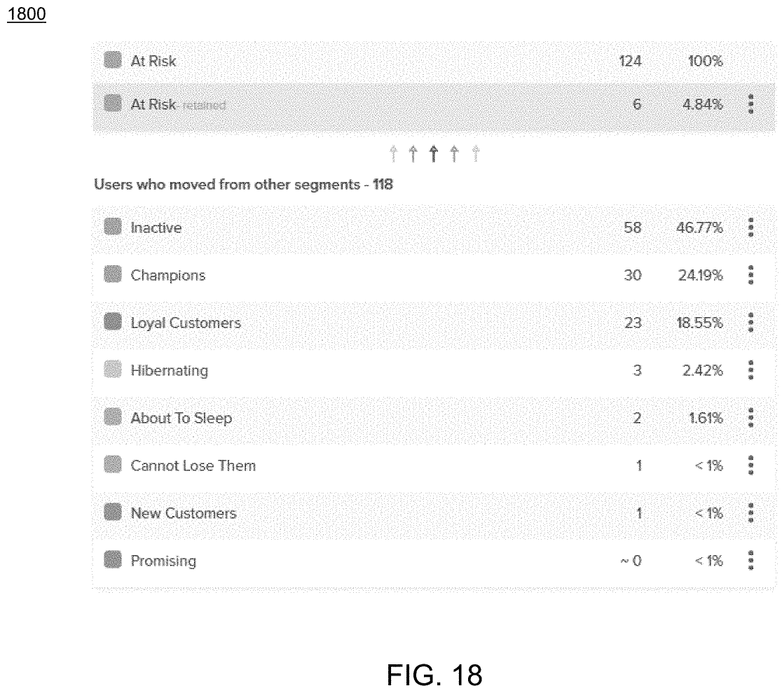

FIG. 18 illustrates an example 1800 of the “transitions” for the “at risk” segment, in accordance with various embodiments of the present disclosure. The example 1800 depicts a table for the “transitions” for the “at risk” segment. In the example 1800, the “at risk” segment has 124 number of the users. In the example 1800, 6 number of the users are retained from the “at risk” segment (that is 4.84% of the total number of users) over “1 day” from “Jun. 14, 2019-Jul. 13, 2019 to Jul. 15, 2019-Aug. 13, 2019”. In the example 1800, 58 users are moved from the “inactive” segment to “at risk” segment (that is 46.77% of the total number of users) over “1 day” from “Jun. 14, 2019-Jul. 13, 2019 to Jul. 15, 2019-Aug. 13, 2019”. In the example 1800, 30 users are moved from the “champions” segment to “at risk” segment (that is 24.19% of the total number of users) over “1 day” from “Jun. 14, 2019-Jul. 13, 2019 to Jul. 15, 2019-Aug. 13, 2019”. In the example 1800, 23 users are moved from the “loyal customers” segment to “at risk” segment (that is 18.55% of the total number of users) over “1 day” from “Jun. 14, 2019-Jul. 13, 2019 to Jul. 15, 2019-Aug. 13, 2019”. In the example 1800, 3 users are moved from the “hibernating” segment to “at risk” segment over “1 day” from “Jun. 14, 2019-Jul. 13, 2019 to Jul. 15, 2019-Aug. 13, 2019”. In the example 1800, 2 users are moved from the “about to sleep” segment to “at risk” segment over “1 day” from “Jun. 14, 2019-Jul. 13, 2019 to Jul. 15, 2019-Aug. 13, 2019”. In the example 1800, 1 user is moved from the “cannot lose them” segment to “at risk” segment over “1 day” from “Jun. 14, 2019-Jul. 13, 2019 to Jul. 15, 2019-Aug. 13, 2019”. In the example 1800, 1 user is moved from the “new customers” segment to “at risk” segment over “1 day” from “Jun. 14, 2019-Jul. 13, 2019 to Jul. 15, 2019-Aug. 13, 2019”.

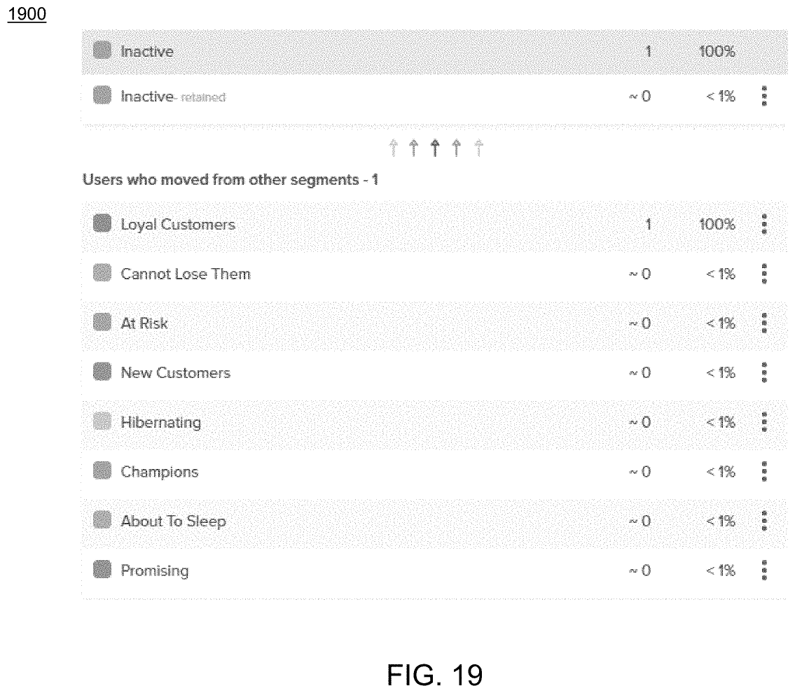

FIG. 19 illustrates an example 1900 of the “transitions” for the “inactive” segment, in accordance with various embodiments of the present disclosure. The example 1900 depicts a table for the “transitions” for the “inactive” segment. In the example 1900, the “inactive” segment has only 1 user. In the example 1900, no user is retained from the “inactive” segment (that is 0% of the total number of users) over “1 day” from “Jun. 14, 2019-Jul. 13, 2019 to Jul. 15, 2019-Aug. 13, 2019”. In the example 1900, 1 user is moved from the “loyal customers” segment to “inactive” segment (that is 100% of the total number of users) over “1 day” from “Jun. 14, 2019-Jul. 13, 2019 to Jul. 15, 2019-Aug. 13, 2019”.

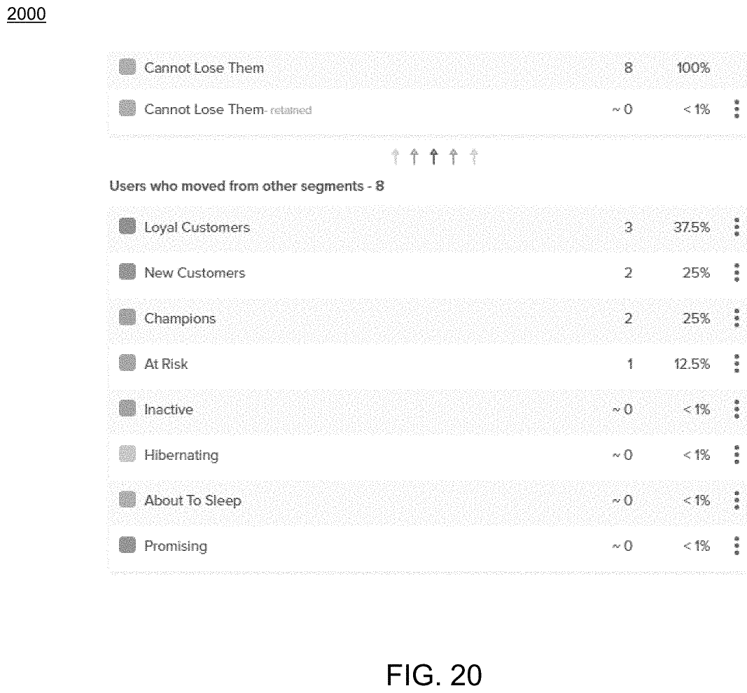

FIG. 20 illustrates an example 2000 of the “transitions” for the “cannot lose them” segment, in accordance with various embodiments of the present disclosure. The example 2000 depicts a table for the “transitions” for the “cannot lose them” segment. In the example 2000, the “cannot lose them” segment has 8 number of the users. In the example 2000, no user is retained from the “cannot lose them” segment (that is 0% of the total number of users) over “1 day” from “Jun. 14, 2019-Jul. 13, 2019 to Jul. 15, 2019-Aug. 13, 2019”. In the example 2000, 3 users are moved from the “loyal customers” segment to “cannot lose them” segment (that is 37.5% of the total number of users) over “1 day” from “Jun. 14, 2019-Jul. 13, 2019 to Jul. 15, 2019-Aug. 13, 2019”. In the example 2000, 2 users are moved from the “new customers” segment to “cannot lose them” segment (that is 25% of the total number of users) over “1 day” from “Jun. 14, 2019-Jul. 13, 2019 to Jul. 15, 2019-Aug. 13, 2019”. In the example 2000, 2 users are moved from the “champions” segment to “cannot lose them” segment (that is 25% of the total number of users) over “1 day” from “Jun. 14, 2019-Jul. 13, 2019 to Jul. 15, 2019-Aug. 13, 2019”. In the example 2000, 1 user is moved from the “at risk” segment to “cannot lose them” segment (that is 12.5% of the total number of users) over “1 day” from “Jun. 14, 2019-Jul. 13, 2019 to Jul. 15, 2019-Aug. 13, 2019”.

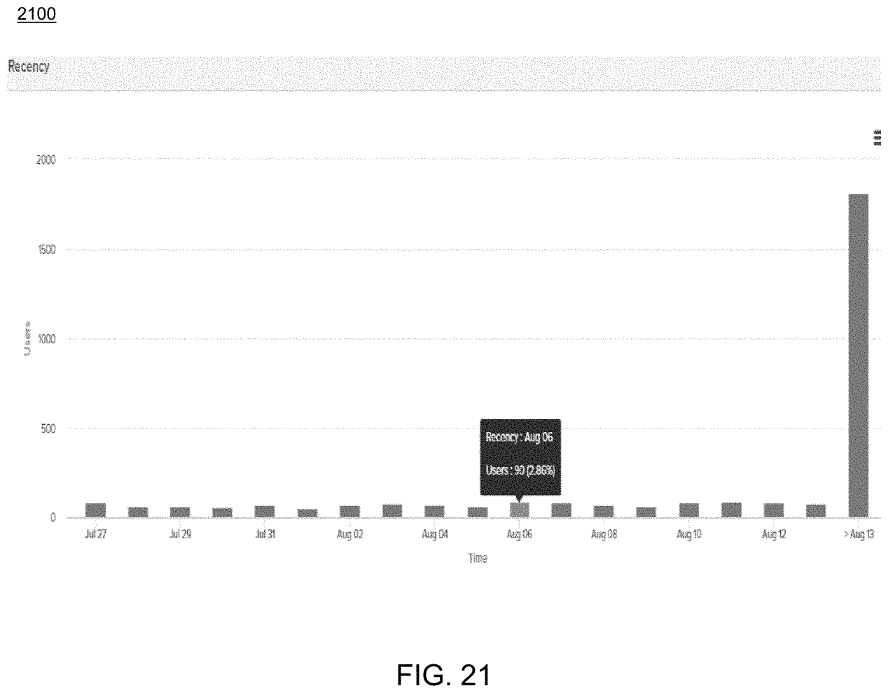

FIG. 21 illustrates an example 2100 of “distribution” for “recency” in the form of a “bar graph” for the plurality of users 202, in accordance with various embodiments of the present disclosure. The example 2100 depicts the “bar graph” for the “recency” of the plurality of users 202. as “users” vs “date & time”. In the example 2100, the “bar graph” for the “recency” demonstrates “date & time” on the X-axis and “users” on the Y-axis. In the example 2100, 82 “users” (2.61% of the total number of users) are recent for the “date & time” Jul. 27, 2019. In the example 2100, 67 “users” (2.13% of the total number of users) are recent for the “date & time” Jul. 28, 2019. In the example 2100, 66 “users” (2.1% of the total number of users) are recent for the “date & time” Jul. 29, 2019. In the example 2100, 61 “users” (1.94% of the total number of users) are recent for the “date & time” Jul. 30, 2019. In the example 2100, 73 “users” (2.32% of the total number of users) are recent for the “date & time” Jul. 31, 2019. In the example 2100, 49 “users” (1.56% of the total number of users) are recent for the “date & time” Aug. 1, 2019. In the example 2100, 73 “users” (2.32% of the total number of users) are recent for the “date & time” Aug. 2, 2019. In the example 2100, 80 “users” (2.55% of the total number of users) are recent for the “date & time” Aug. 3, 2019. In the example 2100, 72 “users” (2.29% of the total number of users) are recent for the “date & time” Aug. 4, 2019. In the example 2100, 63 “users” (2% of the total number of users) are recent for the “date & time” Aug. 5, 2019. In the example 2100, 90 “users” (2.86% of the total number of users) are recent for the “date & time” Aug. 6, 2019. In the example 2100, 83 “users” (2.64% of the total number of users) are recent for the “date & time” Aug. 7, 2019. In the example 2100, 72 “users” (2.29% of the total number of users) are recent for the “date & time” Aug. 8, 2019. In the example 2100, 62 “users” (1.97% of the total number of users) are recent for the “date & time” Aug. 9, 2019. In the example 2100, 84 “users” (2.67% of the total number of users) are recent for the “date & time” Aug. 10, 2019. In the example 2100, 88 “users” (2.8% of the total number of users) are recent for the “date & time” Aug. 11, 2019. In the example 2100, 85 “users” (2.7% of the total number of users) are recent for the “date & time” Aug. 12, 2019. In the example 2100, 79 “users” (2.51% of the total number of users) are recent for the “date & time” Aug. 13, 2019. In the example 2100, 1,814 “users” (57.72% of the total number of users) are recent for the “date & time” Aug. 14, 2019.

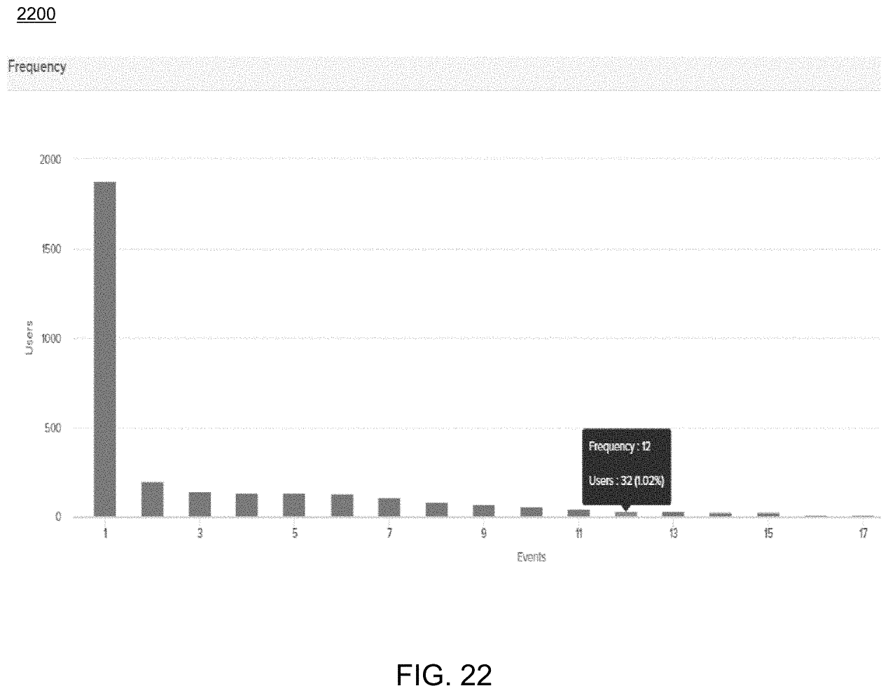

FIG. 22 illustrates an example 2200 of the “distribution” for “frequency” in the form of the “bar graph” for the plurality of users 202, in accordance with various embodiments of the present disclosure. The example 2200 depicts the “bar graph” for the “frequency” of the plurality of users 202. as “users” vs “events”. In the example 2200, the “bar graph” for the “frequency” demonstrates “events” on the X-axis and “users” on the Y-axis. In the example 2200, 1,876 “users” (59.69% of the total number of users) are frequent for the “events” 1. In the example 2200, 198 “users” (6.3% of the total number of users) are frequent for the “events” 2. In the example 2200, 140 “users” (4.45% of the total number of users) are frequent for the “events” 3. In the example 2200, 137 “users” (4.36% of the total number of users) are frequent for the “events” 4. In the example 2200, 137 “users” (4.36% of the total number of users) are frequent for the “events” 5. In the example 2200, 126 “users” (4.01% of the total number of users) are frequent for the “events” 6. In the example 2200, 108 “users” (3.44% of the total number of users) are frequent for the “events” 7. In the example 2200, 84 “users” (2.67% of the total number of users) are frequent for the “events” 8. In the example 2200, 69 “users” (2.2% of the total number of users) are frequent for the “events” 9. In the example 2200, 61 “users” (1.94% of the total number of users) are frequent for the “events” 10. In the example 2200, 48 “users” (1.53% of the total number of users) are frequent for the “events” 11. In the example 2200, 32 “users” (1.02% of the total number of users) are frequent for the “events” 12. In the example 2200, 35 “users” (1.11% of the total number of users) are frequent for the “events” 13. In the example 2200, 27 “users” (0.86% of the total number of users) are frequent for the “events” 14. In the example 2200, 23 “users” (0.73% of the total number of users) are frequent for the “events” 15. In the example 2200, 16 “users” (0.51% of the total number of users) are frequent for the “events” 16. In the example 2200, 10 “users” (0.32% of the total number of users) are frequent for the “events” 17.

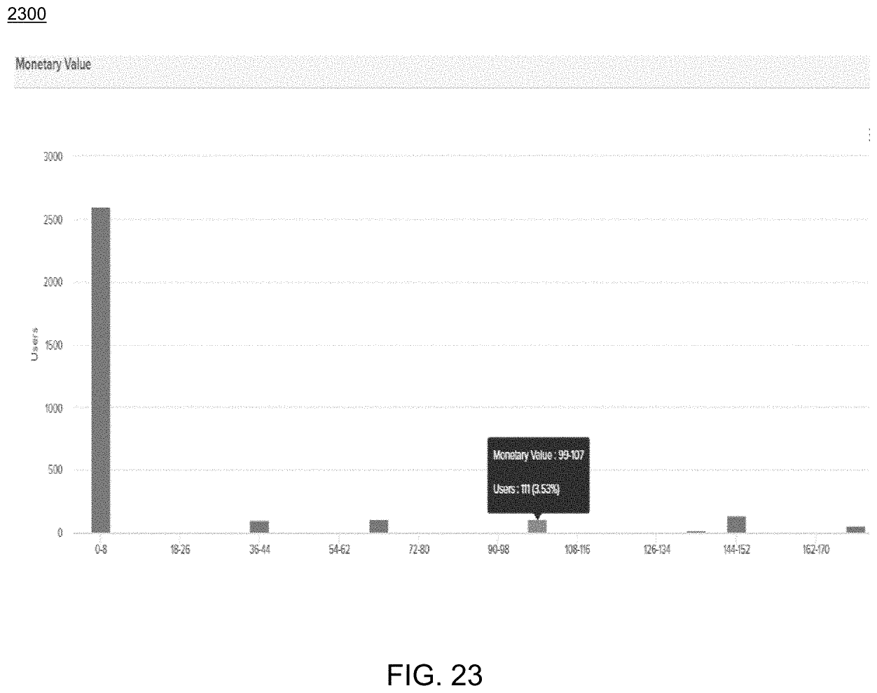

FIG. 23 illustrates an example 2300 of the “distribution” for “monetary” in the form of the “bar graph” for the plurality of users 202, in accordance with various embodiments of the present disclosure. The example 2300 depicts the “bar graph” for the “monetary” of the plurality of users 202. as “users” vs “monetary value”. In the example 2300, the “bar graph” for the “monetary” demonstrates “monetary value” on the X-axis and “users” on the Y-axis. In the example 2300, 2,601 “users” (82.76% of the total number of users) are in the “monetary value” range of 0-8. In the example 2300, 0 “users” (0% of the total number of users) are in the “monetary value” range of 18-26. In the example 2300, 98 “users” (3.12% of the total number of users) are in the “monetary value” range of 36-44. In the example 2300, 0 “users” (0% of the total number of users) are in the “monetary value” range of 54-62. In the example 2300, 105 “users” (3.34% of the total number of users) are in the “monetary value” range of 63-71. In the example 2300, 111 “users” (3.53% of the total number of users) are in the “monetary value” range of 99-107. In the example 2300, 21 “users” (0.67% of the total number of users) are in the “monetary value” range of 135-143. In the example 2300, 135 “users” (4.3% of the total number of users) are in the “monetary value” range of 144-152.

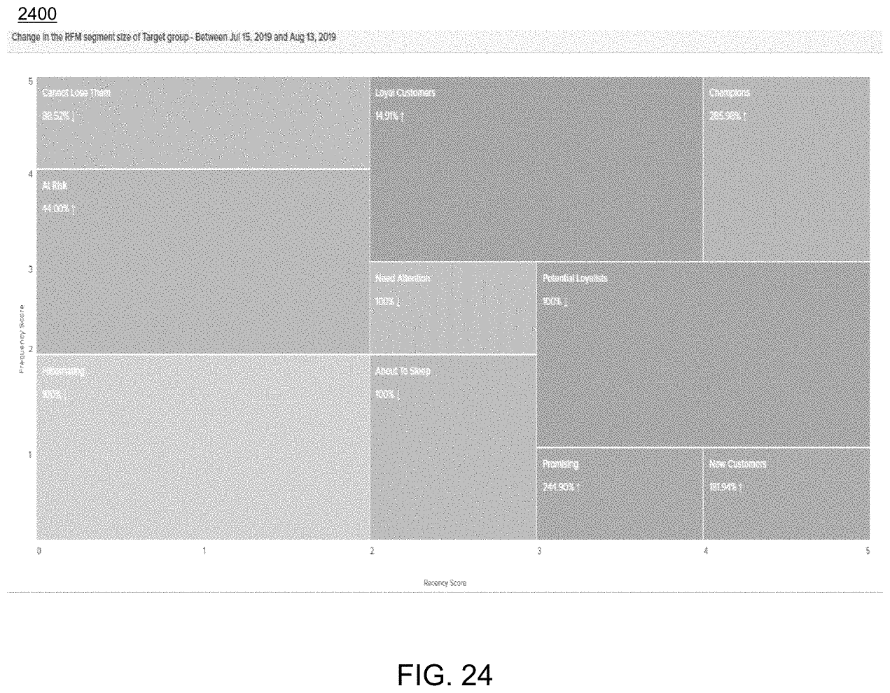

FIG. 24 illustrates an example 2400 of a change in size of the one or more segments based on the RFM analysis for the “date & time”, in accordance with various embodiments of the present disclosure. The example 2400 depicts the “RFM plot” for the changes in the size of the one or more segments based on the RFM analysis for the “date & time” in real-time. In the example 2400, the “RFM plot” demonstrates “recency score” on the X-axis and “frequency score” on the Y-axis. In the example 2400, the “RFM plot” shows the real-time impact for each of the one or more segments based on the RFM analysis using the one or more marketing campaigns. In the example 2400, the real-time impact for the one or more segments such as “hibernating”, “about to sleep”, “promising”, “new customers”, “at risk”, “cannot lose them”, “need attention”, “potential loyalists”, “loyal customers”, and “champions”.

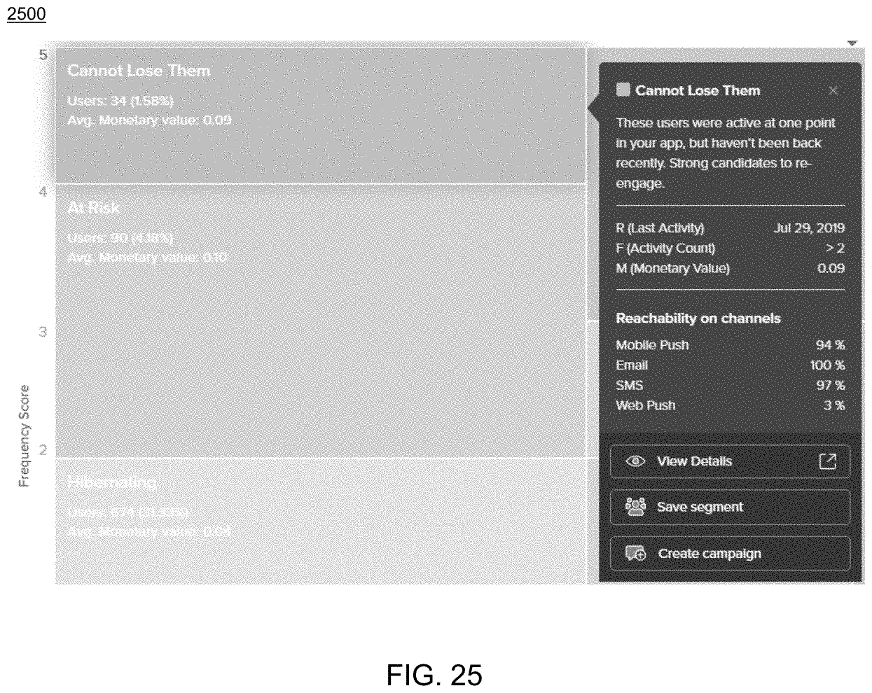

FIG. 25 illustrates an example 2500 of a detail of the segment “cannot lose them” of the one or more segments on the “RFM plot”, in accordance with various embodiments of the present disclosure. The example 2500 depicts the detail of “cannot lose them” segment on the “RFM plot”. In the example 2500, the “cannot lose them” segment has 34 users (that is 1.58% of the total number of users) of the total number of users. In the example 2500, an average monetary value of the “cannot lose them” segment is 0.09. In the example 2500, R (recency based on last activity) of the “cannot lose them” segment is Jul. 29, 2019. In the example 2500, F (frequency value based on activity count) of the “cannot lose them” segment is greater than 2. In the example 2500, the reachability on channel “mobile push” for the “cannot lose them” segment is 94%. In the example 2500, the reachability on channel “email” for the “cannot lose them” segment is 100%. In the example 2500, the reachability on channel “SMS” for the “cannot lose them” segment is 97%. In the example 2500, the reachability on channel “web push” for the “cannot lose them” segment is 3%.

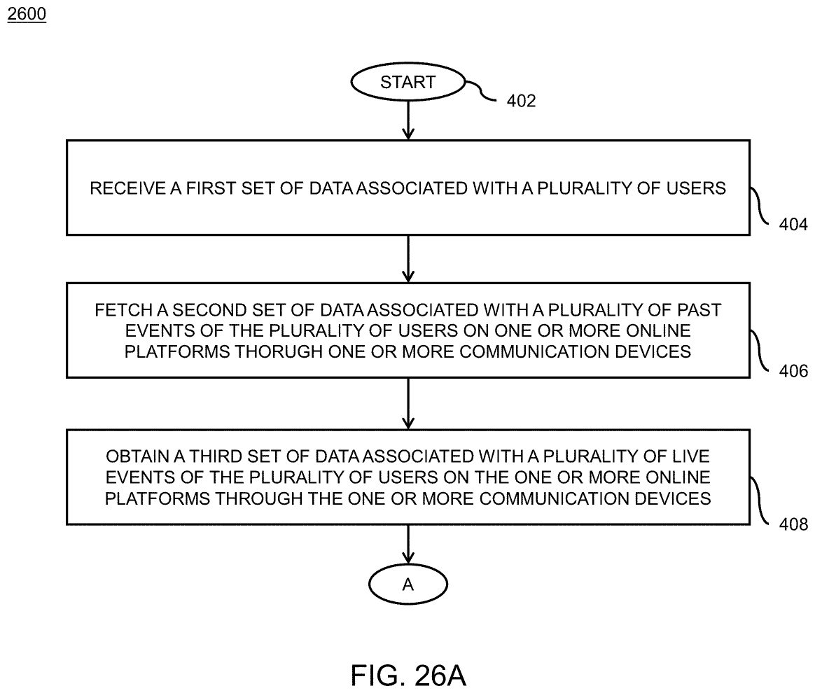

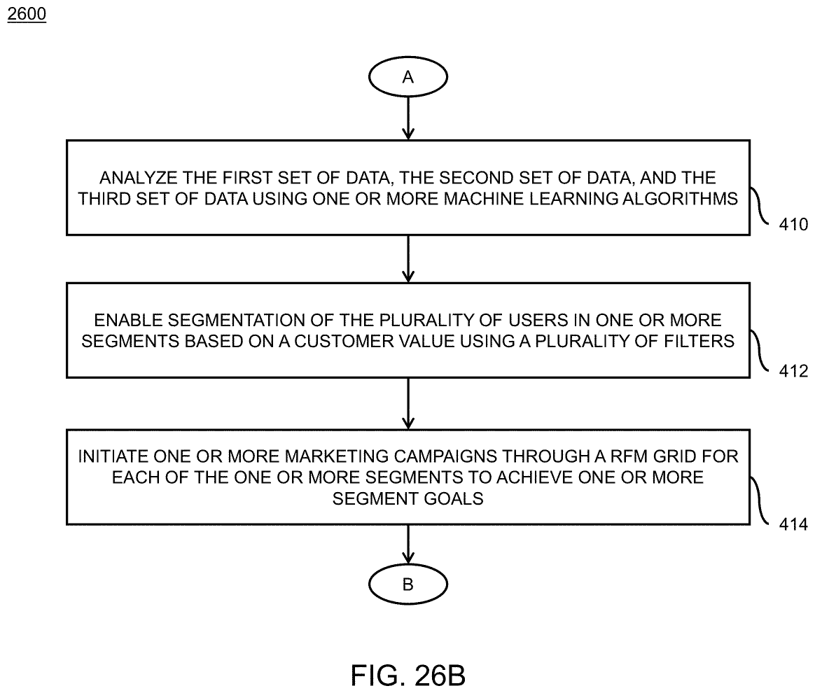

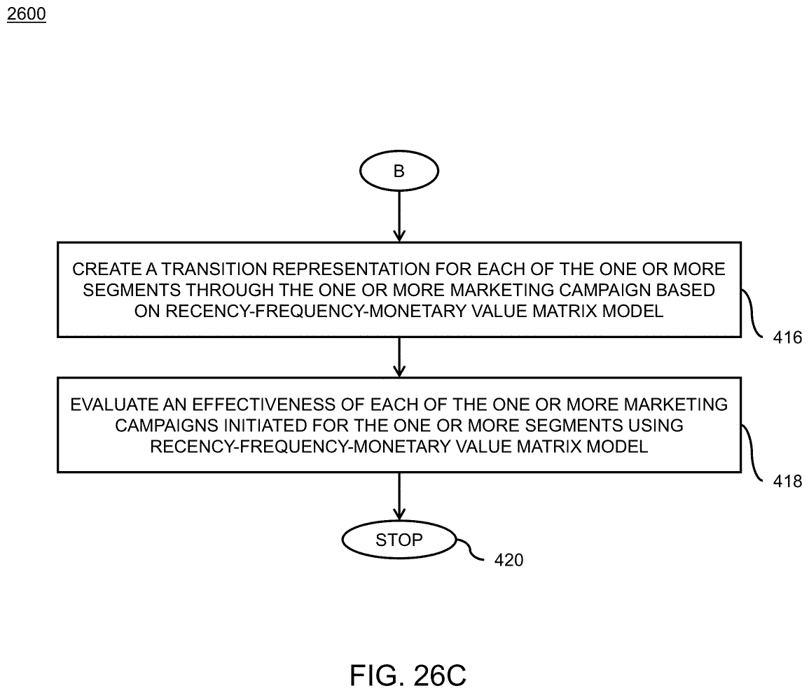

FIGS. 26A, 26B and 26C illustrate a flow chart 2600 of the method for assessing the effectiveness of the one or more marketing campaigns using the RFM matrix in real-time, in accordance with various embodiments of the present disclosure. It may be noted that in order to explain the method steps of the flowchart 2600, references will be made to the elements explained in FIG. 3. The flow chart 2600 starts at step 402. At step 404, the marketing campaign evaluation system 304 receives the first set of data associated with the plurality of users 202. At step 406, the marketing campaign evaluation system 304 fetches the second set of data associated with the plurality of past events of the plurality of users 202 on the one or more online platforms 102 through the one or more communication devices 204. At step 408, the marketing campaign evaluation system 304 obtains the third set of data associated with the plurality of live events of the plurality of users 202 on the one or more online platforms 102 through the one or more communication devices 204. At step 410, the marketing campaign evaluation system 304 analyzes the first set of data, the second set of data, and the third set of data using the one or more machine learning algorithms. At step 412, the marketing campaign evaluation system 304 enables segmentation of the plurality of users 202 in the one or more segments based on the customer value using the plurality of RFM filters. At step 414, the marketing campaign evaluation system 304 initiates the one or more marketing campaigns through the RFM grid for each of the one or more segments to achieve the one or more segment goals. At step 416, the marketing campaign evaluation system 304 creates the transition representation for each of the one or more segments through the one or more marketing campaigns based on the Recency-Frequency-Monetary value matrix model. At step 418, the marketing campaign evaluation system 304 evaluates the effectiveness of each of the one or more marketing campaigns initiated for the one or more segments using the Recency-Frequency-Monetary value matrix model.

The flow chart 2600 terminates at step 420. It may be noted that the flowchart 2600 is explained to have above stated process steps; however, those skilled in the art would appreciate that the flowchart 2600 may have more/less number of process steps which may enable all the above stated embodiments of the present disclosure.

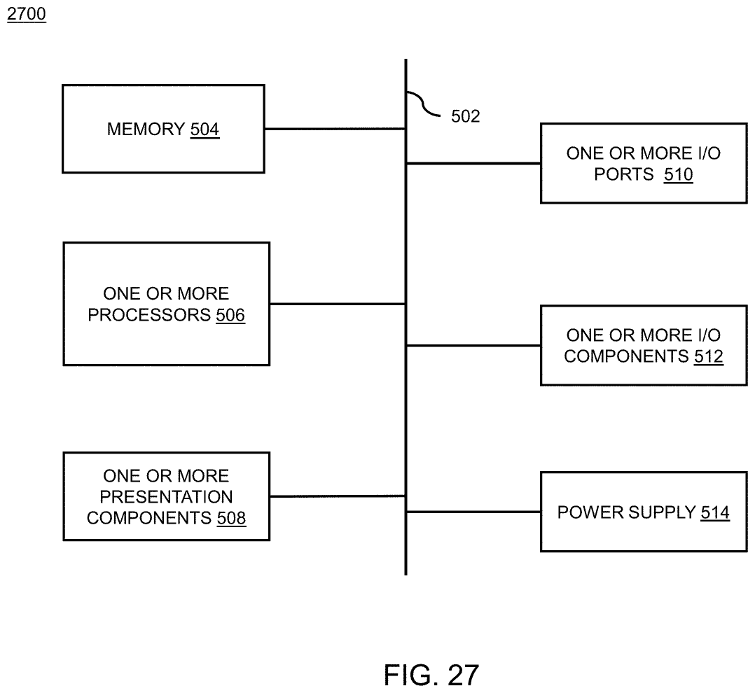

FIG. 27 illustrates a block diagram of a computing device 2700, in accordance with various embodiments of the present disclosure. The computing device 2700 includes a bus 502 that directly or indirectly couples the following devices: a memory 504, one or more processors 506, one or more presentation components 508, one or more input/output (I/O) ports 510, one or more input/output components 512, and an illustrative power supply 514. The bus 502 represents what may be one or more busses (such as an address bus, data bus, or combination thereof). Although the various blocks of FIG. 27 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 27 is merely illustrative of an exemplary computing device 2700 that can be used in connection with one or more embodiments of the present invention. Distinction is not made between such categories as “workstation,” “server,” “laptop,” “hand-held device,” etc., as all are contemplated within the scope of FIG. 27 and reference to “computing device.”

The computing device 2700 typically includes a variety of computer-readable media. The computer-readable media can be any available media that can be accessed by the computing device 2700 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data.

The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 2700. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 504 includes computer-storage media in the form of volatile and/or nonvolatile memory. The memory 504 may be removable, non-removable, or a combination thereof. Exemplary hardware devices include solid-state memory, hard drives, optical-disc drives, etc. The computing device 2700 includes one or more processors that read data from various entities such as memory 504 or I/O components 512. The one or more presentation components 508 present data indications to a user or other device. Exemplary presentation components include a display device, speaker, printing component, vibrating component, etc. The one or more I/O ports 510 allow the computing device 2700 to be logically coupled to other devices including the one or more I/O components 512, some of which may be built in. Illustrative components include a microphone, joystick, game pad, satellite dish, scanner, printer, wireless device, etc.

The present disclosure has numerous advantages over the prior art. The present disclosure provides a method and system to enable tracking of actions of the plurality of users. The disclosure provides the method and system to enable analysis of actions of the plurality of users on the one or more online platforms. The disclosure provides the method and system to enable segmentation of the plurality of users based on the actions on the granular level using the one or more categories based on RFM matrix. The disclosure provides the method and system to assign the one or more segment goals for each of the one or more segments in real-time. The disclosure provides the method and system to enable running of the targeted marketing campaigns for the one or more segments of the plurality of users to achieve the one or more segment goals based on the RFM matrix. The disclosure provides the method and system to enable analysis of each of the one or more marketing campaigns to understand the real-time impact on user engagement based on the RFM matrix. The disclosure provides the method and system to enable customization of the marketing campaigns according to the granularity of the one or more segments of the plurality of users based on the RFM matrix. The disclosure provides the method and system to monitor the effectiveness of the one or more marketing campaigns based on the RFM matrix.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for assessing an effectiveness of one or more marketing campaigns using RFM matrix in real-time, the computer-implemented method comprising:
receiving, at a marketing campaign evaluation system with a processor, a first set of data associated with a plurality of users, wherein the plurality of users is associated with one or more communication devices, wherein the first set of data is received in real time;
fetching, at the marketing campaign evaluation system with the processor, a second set of data associated with a plurality of past events of the plurality of users on one or more online platforms;
obtaining, at the marketing campaign evaluation system with the processor, a third set of data associated with a plurality of live events of the plurality of users on the one or more online platforms through the one or more communication devices, wherein the third set of data is obtained in real-time;
analyzing, at the marketing campaign evaluation system with the processor, the first set of data, the second set of data and the third set of data using one or more machine learning algorithms, wherein the analysis is performed based on training of a machine learning model, wherein the analysis is performed to identify one or more patterns, wherein the analysis is performed in real-time;
enabling, at the marketing campaign evaluation system with the processor, segmentation of the plurality of users in one or more segments based on a customer value using a plurality of RFM filters, wherein the plurality of RFM filters is based on one or more parameters, wherein the segmentation of the plurality of users is enabled in real-time;
initiating, at the marketing campaign evaluation system with the processor, the one or more marketing campaigns through a RFM grid for each of the one or more segments to achieve one or more segment goals, wherein the one or more marketing campaigns are initiated based on the one or more patterns of the one or more segments using the plurality of RFM filters, wherein the one or more marketing campaigns are initiated in the real-time;
creating, at the marketing campaign evaluation system with the processor, a transition representation for each of the one or more segments through the one or more marketing campaigns based on a Recency-Frequency-Monetary value matrix model, wherein the transition representation signifies transition of each of the plurality of users within the one or more segments, wherein the transition representation for each of the one or more segments is created in real-time; and
evaluating, at the marketing campaign evaluation system with the processor, the effectiveness of each of the one or more marketing campaigns initiated for the one or more segments using the Recency-Frequency-Monetary value matrix model, wherein the effectiveness of each of the one or more marketing campaigns is evaluated in real-time.

2. The computer-implemented method as recited in claim 1, wherein the first set of data corresponds to personal information of the plurality of users, wherein the first set of data comprises name data, age data, e-mail identity data, contact number data, gender data, geographic location data, angiographic data, demographic data, payment cards data, banking partners data, and relationship status data, wherein the first set of data is received from one or more online platform database, one or more communication device database, and third party database.

3. The computer-implemented method as recited in claim 1, wherein the second set of data corresponds the plurality of past events of the plurality of users on the one or more online platforms, wherein the plurality of past events comprises past uniform resource locater visits, past number of visits, past number of pages accessed, past webpage visited, past application installed, past number of times application installed, past application launched, past number of times application launched, past application uninstalled, past accessed content, past started content, past paused content, past resumed content, past searched content, past notification clicks, past notification views, past products surfed, past products added to cart, past reviews for products, past favourite product category, past inactivity for products, past accounts opened, past credit card requests, past credit cards issued, past loan requests, past net-banking requests, past multimedia content surfed, past multimedia content watched, past texts exchanged, past business blogs, past live media streamed, past audio-video callings, past medicines searched, past medicines bought, past medical test kit bought, past medical tests scheduled, past bill payments, past doctor consultation scheduled, past hospital visit planned, past dietary plan requested, past personal trainer hired, past fitness center searched, past educational video searched, past educational video watched, past projects submitted, past mock tests subscribed, past educational counselling requested, past problem solving session requested, past international masters interests, past properties searched, past properties watched, past properties bought, past rented properties searched, past maintenance services requested, past hotel searched, past hotels added to watch-list, past hotel bookings, past holiday plans searched, past holiday plans booked, past stock exchange investments, past money donated, past inactivity for product category, past account created, past products bought, past repeated products, past subscriptions, past subscription renewals, past subscription skipped, past initiated transactions, past failed transactions, past content added to cart, past completed transactions, past most visited category, past content details watched, past video on demand accessed, past video on demand initiated, and past video on demand searched, wherein the one or more online platforms comprise an over-the-top media platform, an e-commerce platform, a fintech platform, a social media platform, a health platform, an educational platform, a real estate and housing platform, and a travel platform.

4. The computer-implemented method as recited in claim 1, wherein the third set of data corresponds the plurality of live events of the plurality of users, wherein the plurality of live events comprises real-time uniform resource locater visits, real-time number of webpage visits, real-time number of webpages accessed, real-time webpage visit, real-time application installed, real-time application launch, real-time application uninstalled, real-time accessed content, real-time started content, real-time paused content, real-time resumed content, real-time searched content, real-time notification clicks, real-time notification views, real-time products surfed, real-time products added to cart, real-time reviews for products, real-time favorite product category, real-time inactivity for products, real-time accounts opened, real-time credit card requests, real-time credit cards issued, real-time loan requests, real-time net-banking requests, real-time multimedia content surfed, real-time multimedia content watched, real-time texts exchanged, real-time business blogs, real-time live media streamed, real-time audio-video callings, real-time medicines searched, real-time medicines bought, real-time medical test kit bought, real-time medical tests scheduled, real-time bill payments, real-time doctor consultation scheduled, real-time hospital visit planned, real-time dietary plan requested, real-time personal trainer hired, real-time fitness center searched, real-time educational video searched, real-time educational video watched, real-time projects submitted, real-time mock tests subscribed, real-time educational counselling requested, real-time problem solving session requested, real-time international masters interests, real-time properties searched, real-time properties watched, real-time properties bought, real-time rented properties searched, real-time maintenance services requested, real-time hotel searched, real-time hotels added to watch-list, real-time hotel bookings, real-time holiday plans searched, real-time holiday plans booked, real-time stock exchange investments, real-time money donated, real-time inactivity for product category, real-time account created, real-time products bought, real-time repeated products, real-time subscriptions, real-time subscription renewals, real-time subscription skipped, real-time initiated transactions, real-time failed transactions, real-time content added to cart, real-time completed transactions, real-time most visited category, real-time content details watched, real-time video on demand accessed, real-time video on demand initiated, and real-time video on demand searched.

5. The computer-implemented method as recited in claim 1, further comprising creating, at the marketing campaign evaluation system with the processor, the machine learning model to perform analysis of the first set of data, the second set of data, and the third set of data, wherein the machine learning model is trained to identify the one or more patterns of the first set of data, the second set of data, and the third set of data for one or more categories, wherein the one or more categories comprise a past behavior category and a live behavior category, wherein the past behavior category allows the segmentation of the plurality of users based on the plurality of past events, wherein the live behavior category allows the segmentation of the plurality of users based on the plurality of live events, wherein the one or more categories are pre-defined by an administrator.

6. The computer-implemented method as recited in claim 1, further comprising assigning, at the marketing campaign evaluation system with the processor, the customer value for each of the plurality of users based on the analysis of the first set of data, the second set of data, and the third set of data, wherein the customer value of each of the plurality of users is based on the Recency-Frequency-Monetary value matrix model, wherein the customer value is assigned for the segmentation of the plurality of users, wherein the customer value is assigned in real-time.

7. The computer-implemented method as recited in claim 1, wherein the plurality of RFM filters comprises recency based filters, frequency based filters, and monetary based filters, wherein the plurality of RFM filters comprises time based filters, days based filters, age based filters, location based filters, events based filters, inactivity based filters, user properties filters, categories based filters, demographic filters, geographic filters, technographic filters, and application field filters, wherein the one or more parameters comprise day, time, language, location, events, inactivity, recency, frequency, monetary, and online platform, wherein the Recency-Frequency-Monetary value matrix model comprises a recency value matrix model, a frequency value matrix model, and a monetary value matrix model.

8. The computer-implemented method as recited in claim 1, further comprising generating, at the marketing campaign evaluation system with the processor, the RFM grid for the one or more segments of the plurality of users, wherein the RFM grid highlights reachability and average monetary value for each of the plurality of users of the one or more segments, wherein the RFM grid is generated in real-time.

9. The computer-implemented method as recited in claim 1, wherein the one or more segment goals comprise maximizing uniform resource locater visits, maximizing number of visits, maximizing number of pages accessed, maximizing webpage visits, maximizing application installations, maximizing application launches, minimizing application uninstallations, maximizing recency value, maximizing frequency value, maximizing monetary value, maximizing accessed content, maximizing started content, minimizing paused content, maximizing searched content, maximizing notification clicks, maximizing notification views, maximizing products surfed, maximizing products added to cart, maximizing reviews for products, minimizing inactivity for products, maximizing accounts opening, maximizing credit card requests, maximizing credit cards issued, maximizing loan requests, maximizing net-banking requests, maximizing multimedia content surfed, maximizing multimedia content watched, maximizing texts exchange, maximizing live media streaming, maximizing audio-video callings, maximizing medicines searched, maximizing medicines bought, maximizing medical test kit bought, maximizing dietary plan requests, maximizing personal trainer hiring, maximizing fitness center searches, maximizing educational video searches, maximizing educational video watched, maximizing projects submission, maximizing mock tests subscription, maximizing properties searches, maximizing properties watched, maximizing rented properties searches, maximizing maintenance services requests, maximizing hotel searches, maximizing hotel bookings, maximizing holiday plans searches, maximizing holiday plans bookings, maximizing stock exchange investments, maximizing money donations, maximizing account creations, maximizing subscription renewals, minimizing subscription skipped, maximizing initiated transactions, minimizing failed transactions, maximizing completed transactions, and minimizing transaction cancellations.

10. The computer-implemented method as recited in claim 1, further comprising displaying, at the marketing campaign evaluation system with the processor, one or more advertisements associated with the one or more marketing campaigns for the one or more segments, wherein the one or more advertisements are displayed to each of the plurality of users on the one or more communication devices based on the one or more patterns, wherein the one or more advertisements are displayed in the real-time on the one or more communication devices.

11. A computer system comprising:
one or more processors; and
a memory coupled to the one or more processors, the memory for storing instructions which, when executed by the one or more processors, cause the one or more processors to perform a method for assessing an effectiveness of one or more marketing campaigns using RFM matrix in real-time, the method comprising:
receiving, at a marketing campaign evaluation system, a first set of data associated with a plurality of users, wherein the plurality of users is associated with one or more communication devices, wherein the first set of data is received in real time;
fetching, at the marketing campaign evaluation system, a second set of data associated with a plurality of past events of the plurality of users on one or more online platforms;
obtaining, at the marketing campaign evaluation system, a third set of data associated with a plurality of live events of the plurality of users on the one or more online platforms through the one or more communication devices, wherein the third set of data is obtained in real-time;
analyzing, at the marketing campaign evaluation system, the first set of data, the second set of data and the third set of data using one or more machine learning algorithms, wherein the analysis is performed based on training of a machine learning model, wherein the analysis is performed to identify one or more patterns, wherein the analysis is performed in real-time;
enabling, at the marketing campaign evaluation system, segmentation of the plurality of users in one or more segments based on a customer value using a plurality of RFM filters, wherein the plurality of RFM filters is based on one or more parameters, wherein the segmentation of the plurality of users is enabled in real-time;
initiating, at the marketing campaign evaluation system, the one or more marketing campaigns through a RFM grid for each of the one or more segments to achieve one or more segment goals, wherein the one or more marketing campaigns are initiated based on the one or more patterns of the one or more segments using the plurality of RFM filters, wherein the one or more marketing campaigns are initiated in the real-time;
creating, at the marketing campaign evaluation system, a transition representation for each of the one or more segments through the one or more marketing campaigns based on a Recency-Frequency-Monetary value matrix model, wherein the transition representation signifies transition of each of the plurality of users within the one or more segments, wherein the transition representation for each of the one or more segments is created in real-time; and
evaluating, at the marketing campaign evaluation system, the effectiveness of each of the one or more marketing campaigns initiated for the one or more segments using the Recency-Frequency-Monetary value matrix model, wherein the effectiveness of each of the one or more marketing campaigns is evaluated in real-time.

12. The computer system as recited in claim 11, wherein the first set of data corresponds to personal information of the plurality of users, wherein the first set of data comprises name data, age data, e-mail identity data, contact number data, gender data, geographic location data, angiographic data, demographic data, payment cards data, banking partners data, and relationship status data, wherein the first set of data is received from one or more online platform database, one or more communication device database, and third party database.

13. The computer system as recited in claim 11, wherein the second set of data corresponds the plurality of past events of the plurality of users on the one or more online platforms, wherein the plurality of past events comprises past uniform resource locater visits, past number of visits, past number of pages accessed, past webpage visited, past application installed, past number of times application installed, past application launched, past number of times application launched, past application uninstalled, past accessed content, past started content, past paused content, past resumed content, past searched content, past notification clicks, past notification views, past products surfed, past products added to cart, past reviews for products, past favourite product category, past inactivity for products, past accounts opened, past credit card requests, past credit cards issued, past loan requests, past net-banking requests, past multimedia content surfed, past multimedia content watched, past texts exchanged, past business blogs, past live media streamed, past audio-video callings, past medicines searched, past medicines bought, past medical test kit bought, past medical tests scheduled, past bill payments, past doctor consultation scheduled, past hospital visit planned, past dietary plan requested, past personal trainer hired, past fitness center searched, past educational video searched, past educational video watched, past projects submitted, past mock tests subscribed, past educational counselling requested, past problem solving session requested, past international masters interests, past properties searched, past properties watched, past properties bought, past rented properties searched, past maintenance services requested, past hotel searched, past hotels added to watch-list, past hotel bookings, past holiday plans searched, past holiday plans booked, past stock exchange investments, past money donated, past inactivity for product category, past account created, past products bought, past repeated products, past subscriptions, past subscription renewals, past subscription skipped, past initiated transactions, past failed transactions, past content added to cart, past completed transactions, past most visited category, past content details watched, past video on demand accessed, past video on demand initiated, and past video on demand searched, wherein the one or more online platforms comprise an over-the top media platform, an e-commerce platform, a fintech platform, a social media platform, a health platform, an educational platform, a real estate and housing platform, and a travel platform.

14. The computer system as recited in claim 11, wherein the third set of data corresponds the plurality of live events of the plurality of users, wherein the plurality of live events comprises real-time uniform resource locater visits, real-time number of webpage visits, real-time number of webpages accessed, real-time webpage visit, real-time application installed, real-time application launch, real-time application uninstalled, real-time accessed content, real-time started content, real-time paused content, real-time resumed content, real-time searched content, real-time notification clicks, real-time notification views, real-time products surfed, real-time products added to cart, real-time reviews for products, real-time favorite product category, real-time inactivity for products, real-time accounts opened, real-time credit card requests, real-time credit cards issued, real-time loan requests, real-time net-banking requests, real-time multimedia content surfed, real-time multimedia content watched, real-time texts exchanged, real-time business blogs, real-time live media streamed, real-time audio-video callings, real-time medicines searched, real-time medicines bought, real-time medical test kit bought, real-time medical tests scheduled, real-time bill payments, real-time doctor consultation scheduled, real-time hospital visit planned, real-time dietary plan requested, real-time personal trainer hired, real-time fitness center searched, real-time educational video searched, real-time educational video watched, real-time projects submitted, real-time mock tests subscribed, real-time educational counselling requested, real-time problem solving session requested, real-time international masters interests, real-time properties searched, real-time properties watched, real-time properties bought, real-time rented properties searched, real-time maintenance services requested, real-time hotel searched, real-time hotels added to watch-list, real-time hotel bookings, real-time holiday plans searched, real-time holiday plans booked, real-time stock exchange investments, real-time money donated, real-time inactivity for product category, real-time account created, real-time products bought, real-time repeated products, real-time subscriptions, real-time subscription renewals, real-time subscription skipped, real-time initiated transactions, real-time failed transactions, real-time content added to cart, real-time completed transactions, real-time most visited category, real-time content details watched, real-time video on demand accessed, real-time video on demand initiated, and real-time video on demand searched.

15. The computer system as recited in claim 11, further comprising creating, at the marketing campaign evaluation system, the machine learning model to perform analysis of the first set of data, the second set of data, and the third set of data, wherein the machine learning model is trained to identify the one or more patterns of the first set of data, the second set of data, and the third set of data for one or more categories, wherein the one or more categories comprise a past behavior category and a live behavior category, wherein the past behavior category allows the segmentation of the plurality of users based on the plurality of past events, wherein the live behavior category allows the segmentation of the plurality of users based on the plurality of live events, wherein the one or more categories are pre-defined by an administrator.

16. The computer system as recited in claim 11, further comprising assigning, at the marketing campaign evaluation system, the customer value for each of the plurality of users based on the analysis of the first set of data, the second set of data, and the third set of data, wherein the customer value of each of the plurality of users is based on the Recency-Frequency-Monetary value matrix model, wherein the customer value is assigned for the segmentation of the plurality of users, wherein the customer value is assigned in real-time.

17. The computer system as recited in claim 11, further comprising generating, at the marketing campaign evaluation system, the RFM grid for the one or more segments of the plurality of users, wherein the RFM grid highlights reachability and average monetary value for each of the plurality of users of the one or more segments, wherein the RFM grid is generated in real-time.

18. The computer system as recited in claim 11, wherein the one or more segment goals comprise maximizing uniform resource locater visits, maximizing number of visits, maximizing number of pages accessed, maximizing webpage visits, maximizing application installations, maximizing application launches, minimizing application uninstallations, maximizing accessed content, maximizing started content, minimizing paused content, maximizing searched content, maximizing notification clicks, maximizing notification views, maximizing products surfed, maximizing products added to cart, maximizing reviews for products, minimizing inactivity for products, maximizing accounts opening, maximizing credit card requests, maximizing credit cards issued, maximizing loan requests, maximizing net-banking requests, maximizing multimedia content surfed, maximizing multimedia content watched, maximizing texts exchange, maximizing live media streaming, maximizing audio-video callings, maximizing medicines searched, maximizing medicines bought, maximizing medical test kit bought, maximizing dietary plan requests, maximizing personal trainer hiring, maximizing fitness center searches, maximizing educational video searches, maximizing educational video watched, maximizing projects submission, maximizing mock tests subscription, maximizing properties searches, maximizing properties watched, maximizing rented properties searches, maximizing maintenance services requests, maximizing hotel searches, maximizing hotel bookings, maximizing holiday plans searches, maximizing holiday plans bookings, maximizing stock exchange investments, maximizing money donations, maximizing account creations, maximizing subscription renewals, minimizing subscription skipped, maximizing initiated transactions, minimizing failed transactions, maximizing completed transactions, and minimizing transaction cancellations.

19. The computer system as recited in claim 11, further comprising displaying, at the marketing campaign evaluation system, one or more advertisements associated with the one or more marketing campaigns for the one or more segments, wherein the one or more advertisements are displayed to each of the plurality of users on the one or more communication devices based on the one or more patterns, wherein the one or more advertisements are displayed in the real-time on the one or more communication devices.

20. A non-transitory computer-readable storage medium encoding computer executable instructions that, when executed by at least one processor, performs a method for assessing an effectiveness of one or more marketing campaigns using RFM matrix in real-time, the method comprising:
receiving, at a computing device, a first set of data associated with a plurality of users, wherein the plurality of users is associated with one or more communication devices, wherein the first set of data is received in real time;
fetching, at the computing device, a second set of data associated with a plurality of past events of the plurality of users on one or more online platforms;
obtaining, at the computing device, a third set of data associated with a plurality of live events of the plurality of users on the one or more online platforms through the one or more communication devices, wherein the third set of data is obtained in real-time;
analyzing, at the computing device, the first set of data, the second set of data and the third set of data using one or more machine learning algorithms, wherein the analysis is performed based on training of a machine learning model, wherein the analysis is performed to identify one or more patterns, wherein the analysis is performed in real-time;
enabling, at the computing device, segmentation of the plurality of users in one or more segments based on a customer value using a plurality of RFM filters, wherein the plurality of RFM filters is based on one or more parameters, wherein the segmentation of the plurality of users is enabled in real-time;
initiating, at the computing device, the one or more marketing campaigns through a RFM grid for each of the one or more segments to achieve one or more segment goals, wherein the one or more marketing campaigns are initiated based on the one or more patterns of the one or more segments using the plurality of RFM filters, wherein the one or more marketing campaigns are initiated in the real-time;
creating, at the computing device, a transition representation for each of the one or more segments through the one or more marketing campaigns based on a Recency-Frequency-Monetary value matrix model, wherein the transition representation signifies transition of each of the plurality of users within the one or more segments, wherein the transition representation for each of the one or more segments is created in real-time; and
evaluating, at the computing device, the effectiveness of each of the one or more marketing campaigns initiated for the one or more segments using the Recency-Frequency-Monetary value matrix model, wherein the effectiveness of each of the one or more marketing campaigns is evaluated in real-time.
